(19) United States
(12) Patent Application Publication
(10) Pub. No.: US 2025/0392941 A1
(43) Pub. Date: Dec. 25, 2025

(54) METHOD AND APPARATUS FOR RADIO RESOURCE MANAGEMENT IN MOBILE WIRELESS COMMUNICATION SYSTEM

(71) Applicants: Soenghun Kim, Hanam-si (KR); BLACKPIN INC., Seoul (KR)

(72) Inventor: Soenghun Kim, Hanam-si (KR)

(21) Appl. No.: 19/230,627

(22) Filed: Jun. 6, 2025

(30) Foreign Application Priority Data
Jun. 20, 2024 (KR) 10-2024-0080158

(51) Int. Cl. H04W 24/10; H04B 17/318; H04B 17/373

(52) U.S. Cl. CPC H04W 24/10; H04B 17/328; H04B 17/373

(57) ABSTRACT

A method and apparatus to support efficient radio resource management is provided. The method includes receiving from a base station an RRReconfiguration message that comprises various parameters for AIML based prediction, performing measurement and AIML based prediction according to measurement window and prediction window and initiating measurement reporting procedure based on AIML based prediction.

### CROSS-REFERENCE TO RELATED APPLICATION

This application claims priority to and the benefit of Korean Patent Application No. 10-2024-0080158, filed on Jun. 20, 2024, the disclosure of which is incorporated herein by reference in its entirety.

### BACKGROUND

### Technical Field

The present disclosure relates to radio resource management based on artificial intelligence in wireless mobile communication system.

### Related Art

In recent years, the integration of Artificial Intelligence (AI) and Machine Learning (ML) technologies into New Radio (NR) systems has garnered significant attention. These advancements aim to enhance the performance, efficiency, and adaptability of wireless communication networks. AI/ML techniques are employed in various aspects of NR, including such as Network Optimization, Interference Management, Beamforming and Beam Management, Fault Detection and Self-Healing, and User Experience Enhancement.

The integration of AI/ML in NR systems represents a significant leap forward in the evolution of wireless communication, offering unprecedented levels of efficiency, reliability, and adaptability.

### SUMMARY

A method and apparatus to support efficient radio resource management is provided. The method includes receiving from a base station an RRReconfiguration message that comprises various parameters for AIML based prediction, performing measurement and AIML based prediction according to measurement window and prediction window and initiating measurement reporting procedure based on AIML based prediction.

### BRIEF DESCRIPTION OF THE DRAWINGS

FIG. 1 is a diagram illustrating the architecture of 5G system and NG-RAN.

FIG. 2 is a diagram illustrating wireless protocol architecture in 5G system.

FIG. 3 is a diagram illustrating a Functional framework for AI/ML for NR air interface.

FIG. 4 illustrates overall operation of the UE and network.

FIG. 5 illustrates measurement window and prediction window.

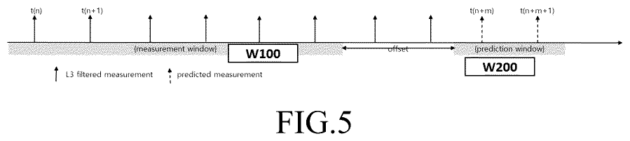

FIG. 6 is a flow diagram illustrating an operation of a terminal.

FIG. 7 is a block diagram illustrating the internal structure of a UE to which the disclosure is applied.

FIG. 8 is a block diagram illustrating the configuration of a base station according to the disclosure.

### DETAILED DESCRIPTION

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, followings are used interchangeably:
Terminal and UE and wireless device;
Information Element (IE) and set of parameters;
Parameter and field and IE;
Base station and GNB;
UAI and UEAssistanceInformation and UE assistance information message.

The integration of Artificial Intelligence (AI) and Machine Learning (ML) in New Radio (NR) systems necessitates efficient and effective data collection methods. These methods are crucial for training AI/ML models to optimize network performance, manage resources, and enhance user experiences. The following outlines various data collection techniques for NR systems:
>: Network Monitoring: Continuous monitoring of network parameters, such as signal strength, interference levels, and user mobility patterns, provides a rich dataset for AI/ML algorithms. This data is collected through network elements, including base stations and user equipment.
>: User Equipment Feedback: Data is gathered directly from user devices, including information on signal quality, data throughput, and application usage. This feedback helps in understanding user behavior and network performance from the end-user perspective.
>: Simulation and Emulation: Synthetic data is generated through network simulations and emulations, replicating various network conditions and user behaviors. This method allows for controlled data collection, enabling the training of AI/ML models under specific scenarios.
>: Environmental Sensing: Sensors deployed within the network environment collect data on physical conditions, such as temperature, humidity, and geographical features. This environmental data is used to understand its impact on network performance and optimize AI/ML models accordingly.
>: Historical Data Analysis: Historical network data is analyzed to identify patterns and trends. This retrospective analysis provides valuable insights for training AI/ML models, enabling predictive analytics and proactive network management.

The effective collection and utilization of data are fundamental to the successful implementation of AI/ML in NR systems. These methods ensure that AI/ML models are trained on comprehensive and representative datasets, leading to improved network performance and user satisfaction.

To enable efficient data collection, it is essential that UE starts and stops data transfer with sufficient controllability and self-estimation.

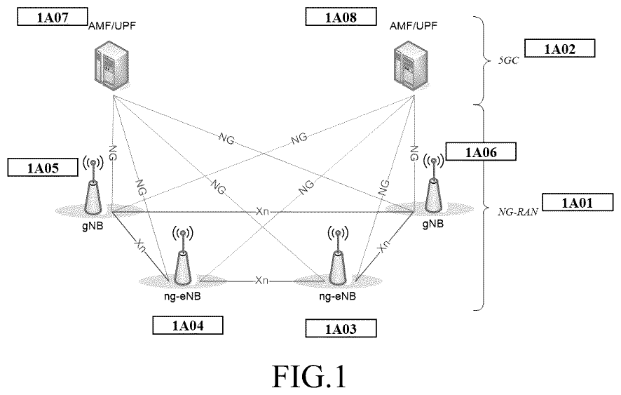

FIG. 1 is a diagram illustrating the architecture of an 5G system and a NG-RAN to which the disclosure may be applied.

5G system consists of NG-RAN 1A01 and 5GC 1A02. An NG-RAN node is either:
>1: a gNB, providing NR user plane and control plane protocol terminations towards the UE; or
>1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.

>1: Functions for Radio Resource Management such as Radio Bearer Control, Radio Admission Control, Connection Mobility Control, Dynamic allocation of resources to UEs in uplink, downlink and sidelink (scheduling); and
>1: IP and Ethernet header compression, uplink data decompression and encryption of user data stream; and
>1: Selection of an AMF at UE attachment when no routing to an MME can be determined from the information provided by the UE; and
>1: Routing of User Plane data towards UPF; and
>1: Scheduling and transmission of paging messages; and
>1: Scheduling and transmission of broadcast information (originated from the AMF or O&M); and
>1: Measurement and measurement reporting configuration for mobility and scheduling; and
>1: Session Management; and
>1: QoS Flow management and mapping to data radio bearers; and
>1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

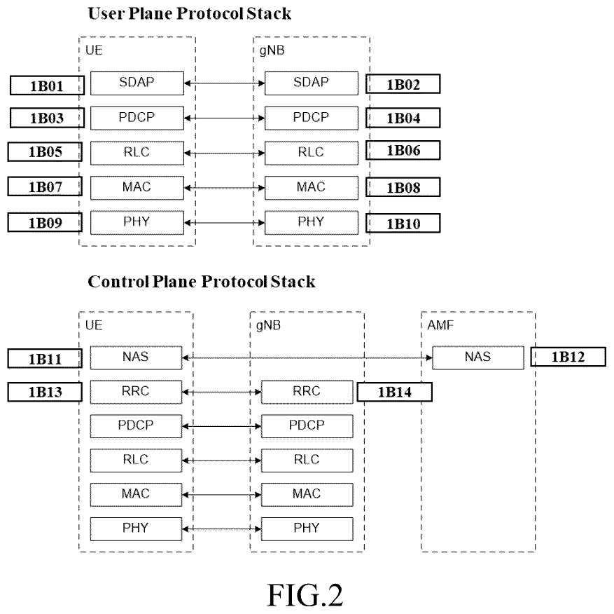

FIG. 2 is a diagram illustrating an wireless protocol architecture in a 5G system to which the disclosure may be applied.

User plane protocol stack consists of SDAP 1B01 or 1B02, PDCP 1B03 or 1B04, RLC 1B05 or 1B06, MAC 1B07 or 1B08 and PHY 1B09 or 1B10. Control plane protocol stack consists of NAS 1B11 or 1B12, RRC 1B13 or 1B14, PDCP, RLC, MAC and PHY.

Each protocol sublayer performs functions related to the operations listed below.
NAS: authentication, mobility management, security control etc.
RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.
SDAP: Mapping between a QoS flow and a data radio bearer, Marking QoS flow ID (QFI) in both DL and UL packets.
PDCP: Transfer of data, Header compression and decompression, Ciphering and deciphering, Integrity protection and integrity verification, Duplication, Reordering and in-order delivery, Out-of-order delivery etc.
RLC: Transfer of upper layer PDUs, Error Correction through ARQ, Segmentation and re-segmentation of RLC SDUs, Reassembly of SDU, RLC re-establishment etc.
MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.
PHY: Channel coding, Physical-layer hybrid-ARQ processing, Rate matching, Scrambling, Modulation, Layer mapping, Downlink Control Information, Uplink Control Information etc.

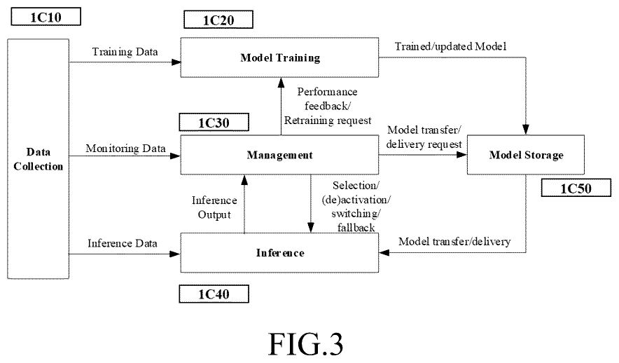

FIG. 3 illustrates functional framework of AI/ML for NR.

Data Collection 1C10 is a function that provides input data to the Model Training, Management, and Inference functions.
>: Training Data: Data needed as input for the AI/ML Model Training function.
>: Monitoring Data: Data needed as input for the Management of AI/ML Models or AI/ML functionalities.
>: Inference Data: Data needed as input for the AI/ML Inference function.

Model Training 1C20 is a function that performs AI/ML model training, validation, and testing which may generate model performance metrics which can be used as part of the model testing procedure. The Model Training function is also responsible for data preparation (e.g., data pre-processing and cleaning, formatting, and transformation) based on Training Data delivered by a Data Collection function, if required.
>: Trained/Updated Model: In case of having a Model Storage function, this is used to deliver trained, validated, and tested AI/ML models to the Model Storage function, or to deliver an updated version of a model to the Model Storage function.

Management 1C30 is a function that oversees the operation (e.g., selection/(de) activation/switching/fallback) and monitoring of AI/ML models or AI/ML functionalities. This function is also responsible for making decisions to ensure the proper inference operation based on data received from the Data Collection function and the Inference function.
>: Selection/(de) activation/switching/fallback: Information needed as input to manage the Inference function. Concerning information may include selection/(de) activation/switching of AI/ML models or AI/ML-based functionalities, fallback to non-AI/ML operation (i.e., not relying on inference process), etc. . . . .
>: Model Transfer/Delivery Request: Used to request model(s) to the Model Storage function.
>: Performance feedback/Retraining request: Information needed as input for the Model Training function, e.g., for model (re) training or updating purposes.

1C40 Inference is a function that provides outputs from the process of applying AI/ML models or AI/ML functionalities to new data (i.e., Inference Data). The Inference function is also responsible for data preparation (e.g., data pre-processing and cleaning, formatting, and transformation) based on Inference Data delivered by a Data Collection function, if required.
>: Inference Output: Data used by the Management function to monitor the performance of AI/ML models or AI/ML functionalities.

Model Storage 1C50 is a function responsible for storing trained/updated models that can be used to perform the inference process.
>: Model Transfer/Delivery: Used to deliver an AI/ML model to the Inference function.

RRM is the system-level management of co-channel interference, radio resources, and other radio transmission characteristics in wireless communication systems. Its main objective is to utilize the limited RF spectrum resources and radio network infrastructure as efficiently as possible. RRM includes various operations such as serving cell measurement, neighbouring cell measurement, layer3 handover, RRC connection release etc. To perform RRM properly, UE is required to perform various measurement and report the results of the measurements.

For conventional L3 handover mechanism, handover is triggered and executed based on reported measurement result and/or measurement event(s) that reflects the historical channel status. It may work well in the scenario where low mobility terminals are deployed in macro cells.

With diverse types of terminals and cells and services come to the market, conventional L3 handover may not work well which results in undesirable events such as handover failure or service interruption.

To enhance the mobility performance, assistance from AI/ML algorithms developed for mobility could be considered. One way to improve mobility performance based on AI/ML is to provide to base station additional information produced from AI/ML along with the conventional measured result. Then based on this additional information, base station may be able to make more appropriate decision on mobility.

In this disclosure, the following are disclosed:
>: UE capability reporting for supported prediction window
>: Report configuration for AI/ML based operation
>: Periodical reporting and event triggered reporting can be configured with AI/ML operation
>: Evaluation for periodical reporting and event triggered reporting and conditional reconfiguration can be configured with AI/ML operation.
>: CGI reporting, SFTD reporting, Periodical RxTx reporting and CLI reporting are not subject to (can not be configured with) AI/ML operation.
>: New parameters for report configuration to enable AI/ML operation
>: AI/ML operation is applied to part of applicable cells depending on eventId
>: Measurement window and prediction window
>: measurement reporting procedure triggering for AI/ML based reporting
>: New parameters in MeasReport
>: UE performs AI/ML inference based prediction during configured/activated measurement gap based on measurement results collected outside configured/activated measurement gap.
>: UE performs AI/ML inference based prediction in case that PCell measurement result is lower than s-Measure
>: UE does not perform AI/ML inference based prediction in case that PCell measurement result is higher than s-Measure
>: UE determines whether to perform AI/ML inference based prediction based on actual measurement result (not based on predicted measurement result).

AIML functionality refers to either AI/ML functionality or AI/ML model or alike. AIML inference refers to prediction on measurement result by AI/ML functionality. AIML ID refers to AI/ML functionality ID or model ID or functionality id or an id that is collectively associated with a AI/ML functionality and model ID and applicable conditions etc. AIML operation refers to AI/ML inference or AI/ML monitoring or any other LCM operation depending on the given context. Non-serving cell refers to neighboring cell. Prediction window is a time duration in a specific future. Configuration may refer to report configuration (ReportConfigToAddMod) or measurement configuration (MeasConfig) or measurement identity configuration (measIdToAddMod) or event configuration (EventTriggerConfig) depending on the given context. IE is a set of parameters/fields that are grouped together to form meaningful information regarding configuration or other purposes.

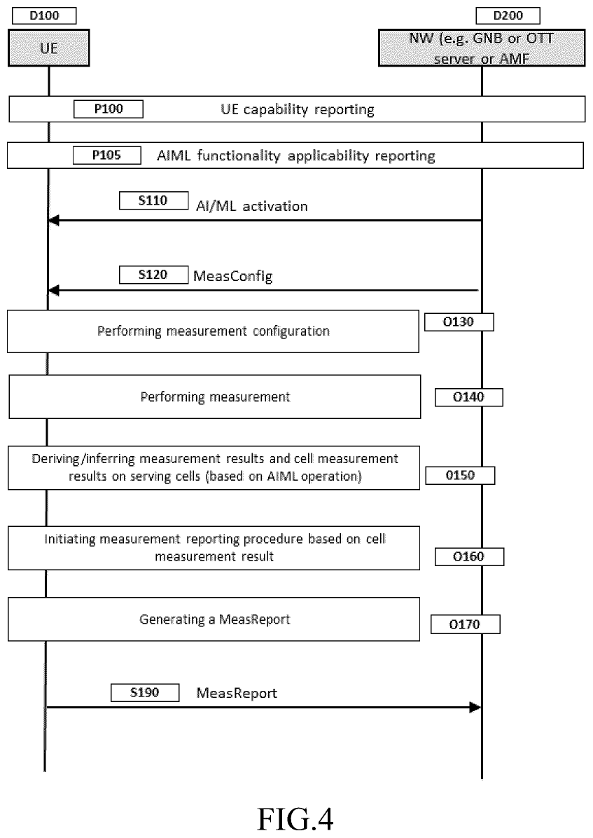

FIG. 4 illustrates operations of UE and network entity for RRM.

GNB (D200) enquiries about UE (D100) capability and UE reports to network that UE is capable of performing AI/ML based mobility (P100). UECapabiltyEnquiry and UECapabilityInformation are exchanged between UE and GNB. GNB includes an indication in the UECapabilityEnquiry that AI/ML related capability is requested for reporting. UE includes capability information on AI/ML based mobility. The information may include:
>: List of AI/ML functionalities (or meta data for the AI/ML functionalities) supported by the terminal;
>: List of AI/ML IDs supported by the terminal;
>: For each AI/ML ID, length of supported prediction window (if applicable) and measurement window.

At P105, UE and GNB perform AI/ML functionality applicability reporting procedure. GNB transmits UE a RRCReconfiguration that includes an IE related to AI/ML availability reporting. The IE may include a list of AI/ML IDs that UE is allowed to report when the corresponding AI/ML functionality is available for activation.

UE transmits a UEAssistanceInformation in case that the AI/ML functionality is being available. The UEAssistanceInformation includes the list of AI/ML ID that are available for activation.

At some point of time, GNB may decide to activate the AI/ML based mobility operation. At S110, GNB transmits to UE a AI/ML activation IE. The AI/ML activation IE includes one or more AI/ML IDs for AI/ML functionalities to be activated.

At some point of time, GNB may decide to configure measurement for the UE. At S120, GNB transmits to the UE MeasConfig 1E.

The AI/ML activation IE and the MeasConfig IE may be included in a same RRC message or in different RRC messages.

At O130, UE performs measurement configuration based on the MeasConfig 1E and AI/ML activation IE.

The MeasConfig 1E includes configuration parameters for:
>: One or more measurement objects (one or more MeasOjectToAddModList);
>: One or more report configurations (one or more ReportConfigToAddModList); and
>: One or more measurement identity configurations (one or more MeasIdToAddMod).

Report configuration (ReportConfigToAddMod) is either type 1 report configuration (measurement-based report configuration) or type 2 report configuration (AI/ML based-report configuration).

ReportConfigToAddModList includes one or more ReportConfigToAddMod. ReportConfigToAddMod includes a ReportConfigId IE and ReportConfigNR IE.

For ReportConfigNR IE for type 1 report configuration, one or following IEs is included in the reportType field.
>: periodicalReportConfig that includes configuration parameters for periodical measurement reporting;
>: EventTriggerConfig that includes configuration parameters for event triggered measurement reporting;
>: ReportCGI that includes configuration parameters for CGI reporting;
>: ReportSFTD-NR that includes configuration parameters for SFTD reporting;
>: CondTriggerConfig that includes configuration parameters for conditional reconfiguration execution/evaluation based on measurement;
>: CLI-PeriodicalReportConfig that includes configuration parameters for periodical reporting for CLI;
>: CLI-EventTriggerConfig that includes configuration parameters for event triggered reporting for CLI; or
>: RxTxPeriodical that includes configuration parameters for periodical reporting on UE Rx-Tx time difference.

For ReportConfigNR IE for type 2 report configuration, one of the following IEs is included in the reportType field.
>: periodicalReportConfig that includes configuration parameters for periodical measurement/AIML prediction reporting;
>: EventTriggerConfig that includes configuration parameters for event triggered measurement/AIML prediction reporting; or
>: CondTriggerConfig that includes configuration parameters for conditional reconfiguration execution/evaluation based on measurement and AIML prediction.

ReportCGI and reportSFTD-NR are not configured for AIML operation because they are one shot reporting for specific information that is hard to be predicted by AIML operation. CLI-PeriodicalReportConfig and CLI-EventTriggerConfig are not configured for AIML operation because they are measurement for neighbouring UEs whose deployment/location are dynamically changing. RxTxPeriodical is not configured for AIML operation because the difference measurement is performed within terminal itself. There are little motivation to enhance the performance with aid of AIML operation.

EventTriggerConfig, both for type 1 report configuration and for type 2 report configuration, may include the following fields:
>: One or more fields for offset values to be used in measurement report triggering condition;
>: One or more fields for threshold values to be used in measurement report triggering condition;
>: eventId field that includes a Choice of NR event triggered reporting criteria;
>: maxNrofRS-IndexesToReport field that indicates maximum number of RS indexes to include in the measurement report;
>: maxReportCells field that indicates maximum number of non-serving cells to include in the measurement report;
>: reportAddNeighMeas field that indicates that the UE shall include the best neighbour cells per serving frequency;
>: reportOnLeave field that indicates whether or not the UE shall initiate the measurement reporting procedure when the leaving condition is met for a cell in cellsTriggeredList;
>: reportQuantityCell field that indicates the cell measurement quantities to be included in the measurement report;
>: reportQuantityRS-Indexes field that indicates which measurement information per RS index the UE shall include in the measurement report;
>: timeToTrigger field that indicates time during which specific criteria for the event needs to be met in order to trigger a measurement report.

EventTriggerConfig for type 2 report configuration may include following fields in addition:
>: AimlEnabled that indicates:
>>: AIML operation is enabled for this ReportConfig/EventTriggerConfig (e.g. the indication that the EventTriggerConfig is for type 2 report configuration). If absent, the EventTriggerConfig is for type 1 report configuration. It may include the AIML ID indicating AIML functionality for this configuration (measurement configuration);
>>: whether or not the UE shall initiate the measurement reporting procedure when entering condition is predicted to be met during a specific prediction window (or when predicted cell measurement result that is made at sometime during the prediction window is met);
>: AimlEnabledNeigh that indicates AIML operation is enabled for neighbouring applicable cells;
>>: AIML operation is enabled for serving cell by default in case that the concerned event is related to the serving cell.
>: AIML operation is enabled for neighbouring cell only if AimlEnabledNeigh is present in the configuration information.
>: reportOnLeaveAIML field indicates:
>>: whether or not the UE shall initiate the measurement reporting procedure when the leaving condition is predicted to be met during a specific time period (prediction period) for a cell in cellsTriggeredList in case that AimlEnabled field is included in the EventTriggerConfig 1E (if it is type 2 report configuration; or if AIML operation is enabled for the configuration; or a relevant IE is included in the configuration).
>: Prediction Window field that indicates the time duration to initiate measurement reporting procedure. This field includes a parameter indicating a time offset and a parameter indicating a time duration.
>>: The prediction window starts after offset from the end of the associated measurement window. Offset is configured by the offset parameter. If offset parameter is absent, a default/preset value (e.g. x ms; x can be 0) is applied/used. Alternatively, offset can be determined based on other parameter such as TimeToTrigger of the associated ReportConfig.
>>: The length of the prediction window is configured by the time duration parameter. If time duration parameter is absent, either a default/preset value (e.g. y ms, y is greater than 0 ms) or the value reported as supported in UE capability information is applied/used.
>: ReportAverageDifference field that includes one or more parameters for reporting average difference between predicted measurement and actual measurement. This field may include:
>>: a parameter indicating whether average difference between measurement and prediction in cell level or in beam level is requested to be reported;
>>: a parameter indicating a time window for which the difference to be averaged;
>: PredictWindwToInitiate field that indicates prediction window for initiating measurement result reporting procedure. This field includes a parameter indicating the time domain distance between the current time (e.g.) and the (either starting time point/lower edge or ending time point/upper edge) of the prediction window.

For a type 2 report configuration:
>: If reportOnLeave is present and reportOnLeaveAIML is absent,
>>: UE triggers measurement result reporting procedure when predicted results during a prediction window (that ends after the current time) fulfills the entering condition; and
>>: UE triggers measurement result reporting procedure when measurement results (based on actual measurement) during a timeToTrigger window (that ends before the current time) fulfills the leaving condition;
>: If reportOnLeave is absent and reportOnLeaveAIML is present,
>>: UE triggers measurement result reporting procedure when predicted results during a prediction window (that ends after the current time) fulfills the entering condition; and
>>: UE triggers measurement result reporting procedure when predicted results during the prediction window (that ends after the current time) fulfills the leaving condition;

If at least one MeasId is valid, UE performs measurement on serving cells for RRM purpose.

For each MeasId, UE performs measurement on one or more applicable cells that are determined from the associated configurations.

TABLE 1

| | | | AI/ML operation is performed to |
|---|---|---|---|
| | | | following cells (second applicable |
| eventId | Event description | applicable cells | cells) |
| eventA1 | Serving becomes better than | Serving cell of the associated | applicable serving cell (serving cell of |
| | absolute threshold | MO (hereinafter, associated | associated MO) if AIML operation is |
| | | MO refers to MO associated | enabled for this configuration |
| | | with the concerned MeasId) | |
| eventA2 | Serving becomes worse than | Same as eventA1 | Same as eventA1 |
| | absolute threshold | | |
| eventA3 | Neighbour becomes amount of | All serving cells (regarded as | PCell (or PSCell) if AIML operation is |
| | offset better than PCell/PSCell | neighbouring cell) and non- | enabled for this configuration; |
| | | serving cells detected based on | Applicable serving cells if AIML |
| | | parameters in the associated | operation is enabled for this |
| | | MO. | configuration; |
| | | More specifically, | Applicable neighbouring cells if |
| | | PCell in case MeasConfig is | AIML operation is enabled for |
| | | associated with MN; PSCell in | neighbouring cell for this |
| | | case MeasConfig is associated | configuration. |
| | | with SN; | |
| | | applicable serving cells (e.g. | |
| | | serving cells regarded as | |
| | | neighbouring cell); | |
| | | applicable neighbouring cells | |
| | | (e.g. neighbouring cells | |
| | | detected based on associated | |
| | | MO). | |
| eventA4 | Neighbour becomes better than | non-serving cells detected | applicable cell (neighbouring cell |
| | absolute threshold | based on parameters in the | detected based on associated MO) if |
| | | associated MO | AIML operation is enabled for |
| | | | neighbouring cells for this |
| | | | configuration. |
| eventA5 | PCell/PSCell becomes worse | Same as eventA3 | Same as eventA3 |
| | than absolute threshold1 AND | | |
| | Neighbour/SCell becomes | | |
| | better than another absolute | | |
| | threshold2 | | |
| eventA6 | Neighbour becomes amount of | non-serving cells detected | Serving cell associated with the |
| | offset better than Scell | based on parameters in the | configuration (e.g. associated MO) if |
| | | associated MO | AIML operation is enabled for this |
| | | | configuration; |
| | | | Applicable neighbouring cells if |
| | | | AIML operation is enabled for |
| | | | neighbouring cell for this |
| | | | configuration. |

In case of type 1 report configuration, the decision for measurement reporting initiation is made based on actual measurement results (during a specific past time window) of applicable cells.

In case of type 2 report configuration, the decision for measurement reporting initiation is made based on predicted measurement results (during a specific future time window) of second applicable cells.

In case of events where only one specific cell is involved (e.g. eventA1 or eventA2), AIML operation is performed for the specific cell.

In case of events where only a specific serving cell is involved (e.g. eventA1 or eventA2), AIML operation is performed for the specific serving cell.

In case of events where only neighboring cells are involved (e.g. event A4), AIML operation is performed for the neighboring cells (that are applicable).

In case of events where both a specific serving cell and neighbouring cells are involved (e.g. eventA6), AIML operation is performed for:
>: the specific serving cell; and
>: if configured, the neighboring cells (that are applicable).

In case of events where both more than one serving cells and neighbouring cells are involved (e.g. eventA3 or eventA5), AIML operation is performed for:
>: the one or more serving cells; and
>: if configured, the neighboring cells (that are applicable).

At O140, UE performs, based on the configuration, measurements on serving cell and applicable cells to derive cell measurement results and beam measurement results.

At O150, UE derives beam measurement results and cell measurement results on specific serving cells (for which servingCellMO is configured) in case that the UE has a measConfig.

If the UE has a measConfig, UE performs RSRP and RSRQ measurements for each serving cell for which servingCellMO is configured.

If the reportConfig associated with at least one measId included in the measIdList within VarMeasConfig contains an rsType set to ssb and ssb-ConfigMobility is configured in the measObject indicated by the servingCellMO; and

If the reportConfig associated with at least one measId included in the measIdList within VarMeasConfig contains a reportQuantityRS-Indexes and maxNrofRS-IndexesToReport and contains an rsType set to ssb,
>: UE derives layer 3 filtered RSRP and RSRQ per beam for the serving cell based on SS/PBCH block.
>: At the end of each measurement window (e.g. after specific number of L3 filtered measurement results based on actual measurement are derived), UE infers one or more predicted RSRPs and RSRQs per beam for the serving cell based on L3 filtered RSRPs and RSRQs per beam of the measurement window.

If the reportConfig associated with at least one measId included in the measIdList within VarMeasConfig contains an rsType set to ssb and ssb-ConfigMobility is configured in the measObject indicated by the servingCellMO,
>: UE derives cell measurement results for the corresponding serving cell based on SS/PBCH block.
>: At the end of each measurement window, UE infers one or more predicted cell measurement results for the corresponding serving cell based on cell measurement results derived during the measurement window.

For UE to derives the (serving) cell measurement result based on SS/PBCH block, for each cell measurement quantity to be derived based on SS/PBCH block:
>: UE derives each cell measurement quantity based on SS/PBCH block as the highest beam measurement quantity value in case that:
>>: nrofSS-BlocksToAverage is not configured in the associated measObject; or
>>: absThreshSS-BlocksConsolidation is not configured in the associated measObject; or
>>: the highest beam measurement quantity value is below or equal to absThreshSS-BlocksConsolidation.
>: UE derives each cell measurement quantity based on SS/PBCH block as the linear power scale average of the highest beam measurement quantity values above absThreshSS-BlocksConsolidation where the total number of averaged beams shall not exceed nrofSS-BlocksToAverage in case that:
>>: nrofSS-BlocksToAverage is configured in the associated measObject; and
>>: absThreshSS-BlocksConsolidation is configured in the associated measObject; and
>>: the highest beam measurement quantity value is above absThreshSS-BlocksConsolidation.

UE derives the cell measurement results of a cell based on nrofSS-BlocksToAverage and absThreshSS-BlocksConsolidation in a specific measObject. The specific measObject is associated with the cell. A cell and a measObject is associated with each other if the cell is detected based on parameters in the measObject.

UE derives the predicted cell measurement results of a cell based on nrofSS-BlocksToAverage and absThreshSS-BlocksConsolidation in a specific measObject. The specific measObject is associated with the cell and associated with a type 2 report configuration.

For UE to derives layer 3 filtered RSRP and RSRQ per beam for the (serving) cell based on SS/PBCH block, for each layer 3 beam filtered measurement quantity to be derived based on SS/PBCH block:
>: UE derives each configured beam measurement quantity based on SS/PBCH block; and
>: UE applies layer 3 beam filtering.

At O160, UE derives beam measurement results and cell measurement results on applicable cells for the MeasId (that are determined based on eventId associated with the MeasId).

For each deriving-measurement-result-measId included in the measIdList within VarMeasConfig (if reportType for the associated reportConfig is periodical, eventTriggered or condTriggerConfig, the corresponding measId is deriving-measurement-result-measId):

If the measObject is associated to NR and the rsType is set to ssb; and

If reportQuantityRS-Indexes and maxNrofRS-IndexesToReport for the associated reportConfig are configured:
>: UE derives layer 3 beam measurements only based on SS/PBCH block for each measurement quantity indicated in reportQuantityRS-Indexes.

If the measObject is associated to NR and the rsType is set to ssb,
>: UE derives cell measurement results based on SS/PBCH block for the trigger quantity and each measurement quantity indicated in reportQuantityCell using parameters from the associated measObject.

For UE to derives the cell measurement result for the measId based on SS/PBCH block, for each cell measurement quantity to be derived based on SS/PBCH block:
>: UE derives each cell measurement quantity based on SS/PBCH block as the highest beam measurement quantity value in case that:
>>: nrofSS-BlocksToAverage is not configured in the associated measObject; or
>>: absThreshSS-BlocksConsolidation is not configured in the associated measObject; or
>>: the highest beam measurement quantity value is below or equal to absThreshSS-BlocksConsolidation.
>: UE derives each cell measurement quantity based on SS/PBCH block as the linear power scale average of the highest beam measurement quantity values above absThreshSS-BlocksConsolidation where the total number of averaged beams shall not exceed nrofSS-BlocksToAverage in case that:
>>: nrofSS-BlocksToAverage is configured in the associated measObject; and
>>: absThreshSS-BlocksConsolidation is configured in the associated measObject; and
>>: the highest beam measurement quantity value is above absThreshSS-BlocksConsolidation.

For UE to derives layer 3 beam measurements based on SS/PBCH block, for each layer 3 beam filtered measurement quantity to be derived based on SS/PBCH block:
>: UE derives each configured beam measurement quantity based on SS/PBCH block; and
>: UE applies layer 3 beam filtering.

At O150, UE infers measurement results of a prediction window based on derived measurement results during a measurement window (W100) associated with the prediction window (W200).

The length of prediction window and the length of the measurement window are different from each other. Both windows are moving window (e.g. the window advances when new L3 measurement sample/result becomes available).

UE performs measurements on CSI-RSs or SSBs periodically. The periodicity may change depending on UE DRX operation (e.g. once per DRX cycle). UE performs L1 filtering (e.g. averaging n L1 measurement results) on the L1 measurement results. The filtered L1 measurement result (e.g. measurement sample) is put into L3 filtering algorithm every sampling rate. Since DRX cycle may change dynamically (e.g. in case of change from/to short DRX to/from long DRX), sampling rate may change as well. However, input rate to L3 filtering is constant to produces L3 filtered measurement results in constant rate (e.g. output rate of L3 filtering is constant).

The measurement window may contain p L3 filtered measurement results. p is either configured explicitly by a specific parameter or implicitly based on preset/default value (if not explicitly configured).

If the output rate of L3 filtering is constant, the length of the measurement window can be defined by the number of L3 filtered measurement results. Alternatively, the length of the measurement window can be defined by a specific time unit (e.g. ms) which is equivalent to a specific number of L3 filtered measurement results.

q predicted measurement results (q is an integer >0) in the prediction window are inferred by AIML operation based on p L3 filtered measurement results in the associated measurement window (inference of q predicted measurement results are performed at a specific time point which is after the end of the associated measurement window). Each of q predicted measurement results is associated with a specific time point. For example, the first predicted measurement result is associated with t (n+m), which means that the first predicted measurement result is a predicted measurement result at t (n+m).

The specific prediction window that is used by UE to determine whether to initiate measurement reporting procedure at current time t (x):
>: starts and ends at t (x+n1); or
>: starts at t (x−n2) and ends at t (x+n3).

GNB may configure UE in reportConfig which prediction window in time domain is used.

At O160, UE initiates measurement reporting procedure based on derived cell measurement result or predicted/inferred measurement result.

For each event, UE initiates measurement reporting procedure if entering condition or leaving condition is fulfilled during a specific time duration. The specific time duration is timeToTrigger (indicated in the corresponding reportConfig) in case that the measId is associated with type 1 report configuration. The specific time duration is 0 ms (e.g. measurement reporting procedure is triggered if entering condition or leaving condition is fulfilled for a first time for a cell) in case that the measId is associated with type 2 report configuration.

TABLE 2

| eventId | Event description | Type 1 report configuration | Type 2 report configuration |
|---|---|---|---|
| eventA1 | Serving becomes better | Inequality A1-1 (Entering | Inequality A1-1 (Entering |
| | than absolute threshold | condition) | condition) |
| | | Ms − Hys > Thresh | Ps − Hys > Thresh |
| | | Inequality A1-2 (Leaving | Inequality A1-2 (Leaving |
| | | condition) | condition) |
| | | Ms + Hys < Thresh | Ps/Ms + Hys < Thresh |
| eventA2 | Serving becomes worse | Inequality A2-1 (Entering | Inequality A2-1 (Entering |
| | than absolute threshold | condition) | condition) |
| | | Ms + Hys < Thresh | Ps + Hys < Thresh |
| | | Inequality A2-2 (Leaving | Inequality A2-2 (Leaving |
| | | condition) | condition) |
| | | Ms − Hys > Thresh | Ps/Ms − Hys > Thresh |
| eventA3 | Neighbour becomes | Inequality A3-1 (Entering | Inequality A3-1 (Entering |
| | amount of offset better | condition) | condition) |
| | than PCell/PSCell | Mn + Ofn + Ocn − Hys > Mp + | Mn + Ofn + Ocn − Hys > Pp + Ofp + |
| | | Ofp + Ocp + Off | Ocp + Off; or |
| | | Inequality A3-2 (Leaving | Pn + Ofn + Ocn − Hys > Pp + Ofp + |
| | | condition) | Ocp + Off; |
| | | Mn + Ofn + Ocn + Hys < Mp + | Inequality A3-2 (Leaving |
| | | Ofp + Ocp + Off | condition) |
| | | | Mn + Ofn + Ocn + Hys < Mp + |
| | | | Ofp + Ocp + Off; or |
| | | | Pn + Ofn + Ocn + Hys < Mp + |
| | | | Ofp + Ocp + Off; or |
| | | | Mn + Ofn + Ocn + Hys < Pp + |
| | | | Ofp + Ocp + Off; or |
| | | | Pn + Ofn + Ocn + Hys < Pp + |
| | | | Ofp + Ocp + Off; or |
| eventA4 | Neighbour becomes | Inequality A4-1 (Entering | Inequality A4-1 (Entering |
| | better than absolute | condition) | condition) |
| | threshold | Mn + Ofn + Ocn − Hys > Thresh | Pn + Ofn + Ocn − Hys > Thresh |
| | | Inequality A4-2 (Leaving | Inequality A4-2 (Leaving |
| | | condition) | condition) |
| | | Mn + Ofn + Ocn + Hys < Thresh | Pn + Ofn + Ocn + Hys < Thresh |
| eventA5 | PCell/PSCell becomes | Inequality A5-1 (Entering | Inequality A5-1 (Entering |
| | worse than absolute | condition 1) | condition 1) |
| | threshold1 AND | Mp + Hys < Thresh1 | Pp/Mp + Hys < Thresh1 |
| | Neighbour/SCell | Inequality A5-2 (Entering | Inequality A5-2 (Entering |
| | becomes better than | condition 2) | condition 2) |
| | another absolute | Mn + Ofn + Ocn − Hys > | Mn/Pn + Ofn + Ocn − Hys > |
| | threshold2 | Thresh2 | Thresh2 |
| | | Inequality A5-3 (Leaving | Inequality A5-3 (Leaving |
| | | condition 1) | condition 1) |
| | | Mp − Hys > Thresh1 | Pp/Mp − Hys > Thresh1 |
| | | Inequality A5-4 (Leaving | Inequality A5-4 (Leaving |
| | | condition 2) | condition 2) |
| | | Mn + Ofn + Ocn + Hys < | Mn/Pn + Ofn + Ocn + Hys < |
| | | Thresh2 | Thresh2 |
| eventA6 | Neighbour becomes | Mn + Ocn − Hys > Ms + Ocs + | Mn/Pn + Ocn − Hys > Ps/Ms + |
| | amount of offset better | Off | Ocs + Off |
| | than Scell | Inequality A6-2 (Leaving | Inequality A6-2 (Leaving |
| | | condition) | condition) |
| | | Mn + Ocn + Hys < Ms + Ocs + | Mn/Pn + Ocn + Hys < Ps/Ms + |
| | | Off | Ocs + Off |

Ms is the measurement result of the serving cell, not taking into account any offsets.
Ps is the predicted/inferred measurement result of the serving cell.
Hys is the hysteresis parameter for this event (i.e. hysteresis as defined within reportConfigNR for this event).
Thresh is the threshold parameter for this event (e.g. aN-Threshold as defined within reportConfigNR for this event).
Ms is expressed in dBm in case of RSRP, or in dB in case of RSRQ and RS-SINR.
Hys is expressed in dB.
Thresh is expressed in the same unit as Ms.
Mn is the measurement result of the neighbouring cell, not taking into account any offsets.
Pn is the predicted measurement result of the neighbouring cell.
Ofn is the measurement object specific offset of the reference signal of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the frequency of the neighbour cell, or cellIndividualOffset as defined within reportConfigNR), and set to zero if not configured for the neighbour cell.
Mp is the measurement result of the SpCell, not taking into account any offsets.
Pp is the predicted measurement result of the SpCell.
Ofp is the measurement object specific offset of the SpCell (i.e. offsetMO as defined within measObjectNR corresponding to the SpCell).
Ocp is the cell specific offset of the SpCell (i.e. cellIndividualOffset as defined within measObjectNR corresponding to the SpCell), and is set to zero if not configured for the SpCell.

It is possible to compare Measurement result of neighboring cell and predicted result of serving cell or vice versa (e.g. Mn vs Ps or Pn vs Ms or Mn vs Pp or Pn vs Mp). In such cases, measurement results and predicted results are associated with different time point (e.g. Mn is L3 filtered measurement results derived at t1 while Ps is predicted measurement results inferred at t2; t2>t1), which means that results of past and results of future are compared with each other.

At O170, UE generates a MeasurementReport for the measurement reporting procedure. The MeasurementReport includes a MeasResults IE.

The MeasResults IE includes following fields/IEs:
>: measId field that indicates the MeasId that triggers the measurement reporting procedure;
>: measResultServingMOList fields that include one or more MeasResultServMO IEs. Each MeasResultServMO includes cell measurement results and beam measurement results of each serving cell for which ServingCellMO is configured;
>: measResultNeighCells fields that include one or more MeasResultNR IEs. Each MeasResultNR includes cell measurement results and beam measurement results of a specific neighbouring cell.

MeasResultServMO IE includes following fields/IEs:
>: servCellId field that includes a ServCellIndex IE for the the serving cell;
>: measResultServingCell field that includes MeasResultNR IE for the serving cell;
>: measResultBestNeighCell field that includes MeasResultNR IE for the best neigbouring cell of the serving frequency;
>: if the measurement reporting procedure is triggered for type 2 measId, predictedResultServingCell field that includes PredictedResultNR IE for the serving cell;
>: if the measurement reporting procedure is triggered for type 2 measId, predictedResultBestNeighCell field that includes PredictedResultNR IE for the best neigbouring cell of the serving frequency.

MeasResultNR IE includes following fields/IEs:
>: physCellId field that indicates PCI of the concerned cell (or neighbouring cell);
>: resultsSSB-Cell field that includes MeasQuantityResults IE and that indicates SSB based cell measurement result of the concerned cell;
>: resultsSSB-Indexes field that includes ResultsPerSSB-IndexList IE and that indicates SSB based beam measurement result of the concerned cell.

PredictedResultNR IE includes following fields/IEs:
>: physCellId field that indicates PCI of the concerned cell (or neighbouring cell);
>: predictedResultsSSB-Cell field that includes PredictedQuantityResults IE and that indicates SSB based predicted cell measurement result of the concerned cell;
>: AverageDifferenceSSB-Cell field that includes QuantityResults IE and that indicates the average difference between SSB based cell measurement result and SSB based predicted cell measurement result in the same time domain (e.g. difference between the prediction made at t (n) for t (n+m) and the actual measured result taken at t (n+m+x) for t (n+m))>
>: PredictedResultsSSB-Indexes field that includes PredictedResultsPerSSB-IndexList IE and that indicates SSB based predicted beam measurement result of the concerned cell.

ResultsPerSSB-IndexList IE includes one or more ResultsPerSSB-Index IE. A ResultsPerSSB-Index IE includes a SSB-Index IE and a MeasQuantityResults IE.

PredictedResultsPerSSB-IndexList IE includes one or more PredictedResultsPerSSB-Index IE. A PredictedResultsPerSSB-Index IE includes a SSB-Index IE and a PredictedMeasQuantityResults IE.

resultsSSB-Cell field indicates cell level measurement results based on SS/PBCH related measurements.

PredictedResultsSSB-Cell field indicates predicted cell level measurement results based on SS/PBCH related measurements.

resultsSSB-Indexes field indicates beam level measurement results based on SS/PBCH related measurements.

PredictedResultsSSB-Indexes field indicates predicted beam level measurement results based on SS/PBCH related measurements.

MeasQuantityResults IE comprises a RSRP-Range IE and a RSRQ-Range IE.

PredictedMeasQuantityResults IE comprises a RSRP-Range IE and a RSRQ-Range IE.

The RSRP-Range IE indicates an integer of which minimum value is 0 and of which maximum value is 127. Each integer corresponds to a specific range of RSRP that is specified in the specification and stored in non-volatile memory of the UE.

The RSRQ-Range IE indicates an integer of which minimum value is 0 and of which maximum value is 127. Each integer corresponds to a specific range of RSRQ that is specified in the specification and stored in non-volatile memory of the UE.

At S190, UE transmits MeasReport to the GNB.

The network may configure an RRC_CONNECTED UE to perform measurements. The network may configure the UE to report them in accordance with the measurement configuration or perform conditional reconfiguration evaluation in accordance with the conditional reconfiguration. The measurement configuration is provided by means of dedicated signalling i.e. using the RRCReconfiguration or RRCResume.

The network may configure the UE to report the following measurement information based on SS/PBCH block(s):
>: Measurement results per SS/PBCH block;
>: Measurement results per cell based on SS/PBCH block(s);
>: SS/PBCH block(s) indexes.

The network may configure the UE to report the following measurement information based on CSI-RS resources:
>: Measurement results per CSI-RS resource;
>: Measurement results per cell based on CSI-RS resource(s);
>: CSI-RS resource measurement identifiers.

The network may configure the UE to perform the following types of measurements for NR sidelink and V2X sidelink:
>: CBR measurements.

The network may configure the UE to report the following CLI measurement information based on SRS resources:
>: Measurement results per SRS resource;
>: SRS resource(s) indexes.

The network may configure the UE to report the following CLI measurement information based on CLI-RSSI resources:
>: Measurement results per CLI-RSSI resource;
>: CLI-RSSI resource(s) indexes.

The network may configure the UE to report the following Rx-Tx time difference measurement information based on CSI-RS for tracking or PRS:
>: UE Rx-Tx time difference measurement result.

The measurement configuration includes the following parameters:

Measurement objects: A list of objects on which the UE shall perform the measurements.
>: For intra-frequency and inter-frequency measurements a measurement object indicates the frequency/time location and subcarrier spacing of reference signals to be measured. Associated with this measurement object, the network may configure a list of cell specific offsets, a list of ‘exclude-listed’ cells and a list of ‘allow-listed’ cells. Exclude-listed cells are not applicable in event evaluation or measurement reporting. Allow-listed cells are the only ones applicable in event evaluation or measurement reporting.
>: The measObjectId of the MO which corresponds to each serving cell is indicated by servingCellMO within the serving cell configuration.
>: For inter-RAT E-UTRA measurements a measurement object is a single E-UTRA carrier frequency. Associated with this E-UTRA carrier frequency, the network can configure a list of cell specific offsets and a list of ‘exclude-listed’ cells. Exclude-listed cells are not applicable in event evaluation or measurement reporting.
>: For inter-RAT UTRA-FDD measurements a measurement object is a set of cells on a single UTRA-FDD carrier frequency.
>: For NR sidelink measurements of L2 U2N Relay UEs, a measurement object is a single NR sidelink frequency to be measured.
>: For CBR measurement of NR sidelink communication, a measurement object is a set of transmission resource pool(s) on a single carrier frequency for NR sidelink communication.
>: For CBR measurement of NR sidelink discovery, a measurement object is a set of discovery dedicated resource pool(s) or transmission resource pool(s) also used for NR sidelink discovery on a single carrier frequency for NR sidelink discovery.
>: For CBR measurement of NR sidelink positioning, a measurement object is a set of positioning dedicated resource pool(s) or transmission resource pool(s) also used for NR sidelink positioning on a single carrier frequency for NR sidelink positioning.
>: For CLI measurements a measurement object indicates the frequency/time location of SRS resources and/or CLI-RSSI resources, and subcarrier spacing of SRS resources to be measured.

Reporting configurations: A list of reporting configurations where there can be one or multiple reporting configurations per measurement object. Each measurement reporting configuration consists of the following:
>: Reporting criterion: The criterion that triggers the UE to send a measurement report. This can either be periodical or a single event description.
>: RS type: The RS that the UE uses for beam and cell measurement results (SS/PBCH block or CSI-RS).
>: Reporting format: The quantities per cell and per beam that the UE includes in the measurement report (e.g. RSRP) and other associated information such as the maximum number of cells and the maximum number beams per cell to report.

In case of conditional reconfiguration, each configuration consists of the following:
>: Execution criteria: The criteria the UE uses for conditional reconfiguration execution.
>: RS type: The RS that the UE uses for obtaining beam and cell measurement results (SS/PBCH block-based or CSI-RS-based), used for evaluating conditional reconfiguration execution condition.

Measurement identities: For measurement reporting, a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration. And up to 2 measurement identities can be linked to one conditional reconfiguration execution condition.

Quantity configurations: The quantity configuration defines the measurement filtering configuration used for all event evaluation and related reporting, and for periodical reporting of that measurement. For NR measurements, the network may configure up to 2 quantity configurations with a reference in the NR measurement object to the configuration that is to be used. In each configuration, different filter coefficients can be configured for different measurement quantities, for different RS types, and for measurements per cell and per beam.

Measurement gaps: Periods that the UE may use to perform measurements.

Effective measurement window: Periods that the UE may use to perform inter RAT measurements.

A UE in RRC_CONNECTED maintains a measurement object list, a reporting configuration list, and a measurement identities list according to signalling and procedures in this specification. The measurement object list possibly includes NR measurement object(s), CLI measurement object(s), inter-RAT objects, and L2 U2N Relay objects. Similarly, the reporting configuration list includes NR, inter-RAT, and L2 U2N Relay reporting configurations. Any measurement object can be linked to any reporting configuration of the same RAT type. Some reporting configurations may not be linked to a measurement object. Likewise, some measurement objects may not be linked to a reporting configuration.

The measurement procedures distinguish the following types of cells:
>: The NR serving cell(s)—these are the SpCell and one or more SCells.
>: Listed cells—these are cells listed within the measurement object(s).
>: Detected cells—these are cells that are not listed within the measurement object(s) but are detected by the UE on the SSB frequency(ies) and subcarrier spacing(s) indicated by the measurement object(s).

For NR measurement object(s), the UE measures and reports on the serving cell(s)/serving Relay UE (for L2 U2N Remote UE), listed cells and/or detected cells. For inter-RAT measurements object(s) of E-UTRA, the UE measures and reports on listed cells and detected cells and, for RSSI and channel occupancy measurements, the UE measures and reports on the configured resources on the indicated frequency. For inter-RAT measurements object(s) of UTRA-FDD, the UE measures and reports on listed cells. For CLI measurement object(s), the UE measures and reports on configured measurement resources (i.e. SRS resources and/or CLI-RSSI resources). For L2 U2N Relay object(s), the UE measures and reports on the serving NR cell(s), as well as the discovered L2 U2N Relay UEs.

For measurement configuration, The UE shall:
>: for each measId included in the received measIdToAddModList:
>>: if an entry with the matching measId exists in the measIdList within the VarMeasConfig:
>>>: replace the entry with the value received for this measId;
>>: else:
>>>: add a new entry for this measId to the measIdList within the VarMeasConfig;
>>: remove the measurement reporting entry for this measId from the VarMeasReportList, if included;
>>: stop the periodical reporting timer or timer T321 or timer T322, whichever one is running, and reset the associated information (e.g. timeToTrigger) for this measId;
>>: if the reportType is set to reportCGI in the reportConfig associated with this measId:
>>>: if the measObject associated with this measId concerns E-UTRA:
>>>>: if the useAutonomousGaps is included in the reportConfig associated with this measId:
>>>>>: start timer T321 with the timer value set to 200 ms for this measId;
>>>>: else:
>>>>>: start timer T321 with the timer value set to 1 second for this measId;
>>: if the reportType is set to reportSFTD in the reportConfigNR associated with this measId and the drx-SFTD-NeighMeas is included:
>>>: if the measObject associated with this measId concerns FR1:
>>>>: start timer T322 with the timer value set to 3 seconds for this measId;
>>>: if the measObject associated with this measId concerns FR2:
>>>>: start timer T322 with the timer value set to 24 seconds for this measId.
>>: if the reportType is set to reportOnActivation in the reportConfig associated with this measId:
>>>: indicate to lower layer to enable the measurement reporting for fast unknown SCell activation.

For Measurement gap configuration, The UE shall:
>: if gapFR1 is set to setup:
>>: if an FR1 measurement gap configuration configured by gapFR1 is already setup, release the FR1 measurement gap configuration;
>>: setup the FR1 measurement gap configuration indicated by the gapFR1 in accordance with the received gapOffset, i.e., the first subframe of each gap occurs at an SFN and subframe meeting the following condition:

$$SFN mod T = FLOOR ( gapOffset / 10 ) ;$$

$$subframe = gapOffset mod 10 ;$$

$$with T = MGRP / 10 ;$$

>>: apply the specified timing advance mgta to the gap occurrences calculated above (i.e. the UE starts the measurement mgta ms before the gap subframe occurrences);
>: else if gapFR1 is set to release:
>>: release the FR1 measurement gap configuration configured by gapFR1;
>: if gapFR2 is set to setup:
>>: if an FR2 measurement gap configuration configured by gapFR2 is already setup, release the FR2 measurement gap configuration;
>>: setup the FR2 measurement gap configuration indicated by the gapFR2 in accordance with the received gapOffset, i.e., the first subframe of each gap occurs at an SFN and subframe meeting the following condition:

$$SFN mod T = FLOOR ( gapOffset / 10 ) ;$$

$$subframe = gapOffset mod 10 ;$$

$$with T = MGRP / 10 ;$$

>>: apply the specified timing advance mgta to the gap occurrences calculated above (i.e. the UE starts the measurement mgta ms before the gap subframe occurrences);
>: else if gapFR2 is set to release:
>>: release the FR2 measurement gap configuration configured by gapFR2;
>: if gapUE is set to setup:
>>: if a per UE measurement gap configuration configured by gapUE is already setup, release the per UE measurement gap configuration;
>>: setup the per UE measurement gap configuration indicated by the gapUE in accordance with the received gapOffset, i.e., the first subframe of each gap occurs at an SFN and subframe meeting the following condition:

$$SFN mod T = FLOOR ( gapOffset / 10 ) ;$$

$$subframe = gapOffset mod 10 ;$$

$$with T = MGRP / 10 ;$$

>>: apply the specified timing advance mgta to the gap occurrences calculated above (i.e. the UE starts the measurement mgta ms before the gap subframe occurrences);
>: else if gapUE is set to release:
>>: release the per UE measurement gap configuration configured by gapUE.
>: for each measGapId included in the received gapToReleaseList:
>>: release the measurement gap configuration associated with the measGapId;
>: for each measPosPreConfigGapId included in the received posMeasGapPreConfigToReleaseList:
>>: release the measurement gap configuration associated with the measPosPreConfigGapId;
>: for each GapConfig received in gapToAddModList:
>>: setup measurement gap configuration indicated by the GapConfig in accordance with the received gapOffset, i.e., the first subframe of each gap occurs at an SFN and subframe meeting the following condition:

$$SFN mod T = FLOOR ( gapOffset / 10 ) ;$$

$$subframe = gapOffset mod 10 ;$$

$$with T = MGRP / 10 ;$$

>>: apply the specified timing advance mgta to the gap occurrences calculated above (i.e. the UE starts the measurement mgta ms before the gap subframe occurrences);
>>: apply the measurement gap as per UE measurement gap, FR1 measurement gap, or FR2 measurement gap according to the gapType indicated by the GapConfig;
>>: associate the measurement gap with the measGapId indicated by the GapConfig;
>>: if gapSharing in the GapConfig is present:
>>>: setup the gap sharing configuration for the measurement gap in accordance with the received gapSharing;
>>: else:
>>>: release the gap sharing configuration (if configured) for the measurement gap;
>: for each PosGapConfig received in PosMeasGapPreConfigToAddModList:
>>: if a measurement gap configuration associated with the measPosPreConfigGapId indicated by the PosGapConfig is already setup:
>>>: release the measurement gap configuration;
>>: setup measurement gap configuration indicated by the PosGapConfig in accordance with the received gapOffset, i.e., the first subframe of each gap occurs at an SFN and subframe meeting the following condition:

$$SFN mod T = FLOOR ( gapOffset / 10 ) ;$$

$$subframe = gapOffset mod 10 ;$$

$$with T = MGRP / 10 ;$$

>>: apply the specified timing advance mgta to the gap occurrences calculated above (i.e. the UE starts the measurement mgta ms before the gap subframe occurrences);
>>: configure the measurement gap as indicated by gapType;
>: for each FR1, FR2, and per UE measurement gap that is setup:
>>: if the measurement gap is configured by GapConfig and preConfigInd-r17 in the corresponding GapConfig is present:
>>>: determine whether the measurement gap is activated or not according to TS 38.133 [14];
>>: else if the measurement gap is configured by PosGapConfig:
>>>: consider the measurement gap to be deactivated;
>>: else:
>>>: consider the measurement gap to be activated.

For FR2 gap configuration with synchronous CA, for the UE in NE-DC or NR-DC, the SFN and subframe of the serving cell indicated by the refServCellIndicator is used in the gap calculation. Otherwise, the SFN and subframe of a serving cell on FR2 frequency is used in the gap calculation

For FR1 gap or per UE gap configuration, for the UE in NE-DC or NR-DC, the SEN and subframe of the serving cell indicated by the refServCellIndicator in is used in the gap calculation. Otherwise, the SFN and subframe of the PCell is used in the gap calculation.

For FR2 gap configuration with asynchronous CA, for the UE in NE-DC or NR-DC, the SFN and subframe of the serving cell indicated by the refServCellIndicator and refFR2ServCellAsyncCA is used in the gap calculation. Otherwise, the SFN and subframe of a serving cell on FR2 frequency indicated by the refFR2ServCellAsyncCA is used in the gap calculation

The UE shall setup the first SS/PBCH block measurement timing configuration (SMTC) in accordance with the received periodicityAndOffset parameter (providing Periodicity and Offset value for the following condition) in the smtc1 configuration. The first subframe of each SMTC occasion occurs at an SFN and subframe of the NR SpCell meeting the following condition:

$$SFN mod T = ( FLOOR ( Offset / 10 ) ) ;$$

if the Periodicity is larger than sf5:

$$subframe = Offset mod 10 ;$$

$$else :$$

$$subframe = Offset or ( Offset + 5 ) ;$$

$$with T = CEIL ( Periodicity / 10 ) .$$

If smtc2 is present, for cells indicated in the pci-List parameter in smtc2 in the same MeasObjectNR, the UE shall setup an additional SS/PBCH block measurement timing configuration (SMTC) in accordance with the received periodicity parameter in the smtc2 configuration and use the Offset (derived from parameter periodicity AndOffset) and duration parameter from the smtc1 configuration. The first subframe of each SMTC occasion occurs at an SFN and subframe of the NR SpCell meeting the above condition.

If smtc2-LP is present, for cells indicated in the pci-List parameter in smtc2-LP in the same frequency (for intra frequency cell reselection) or different frequency (for inter frequency cell reselection), the UE shall setup an additional SS/PBCH block measurement timing configuration (SMTC) in accordance with the received periodicity parameter in the smtc2-LP configuration and use the Offset (derived from parameter periodicityAndOffset) and duration parameter from the smtc configuration for that frequency. The first subframe of each SMTC occasion occurs at an SFN and subframe of the NR SpCell or serving cell (for cell reselection) meeting the above condition.

If smtc3list is present, for cells indicated in the pci-List parameter in each SSB-MTC3 element of the list in the same MeasObjectNR, the IAB-MT shall setup an additional SS block measurement timing configuration in accordance with the received periodicity AndOffset parameter (using same condition as smtc1 to identify the SFN and the subframe for SMTC occasion) in each SSB-MTC3 configuration and use the duration and ssb-ToMeasure parameters from each SSB-MTC3 configuration.

If smtc4list is present, for cells indicated in the pci-List parameter in each SSB-MTC4 element of the list in the same MeasObjectNR, the UE shall setup an additional SS/PBCH block measurement timing configuration (SMTC) in accordance with the received offset parameter in each SSB-MTC4 configuration and use the duration parameter and periodicity (derived from parameter periodicityAndOffset) from the smtc1 configuration. The first subframe of each SMTC occasion occurs at an SFN and subframe of the NR SpCell meeting the above condition.

On the indicated ssbFrequency, the UE shall not consider SS/PBCH block transmission in subframes outside the SMTC occasion for RRM measurements based on SS/PBCH blocks and for RRM measurements based on CSI-RS except for SFTD measurement (see TS 38.133 [14], clause 9.3.8).

An RRC_CONNECTED UE shall derive cell measurement results by measuring one or multiple beams associated per cell as configured by the network. For all cell measurement results, except for RSSI, and CLI measurement results in RRC_CONNECTED, the UE applies the layer 3 filtering, before using the measured results for evaluation of reporting criteria, measurement reporting or the criteria to trigger conditional reconfiguration execution. For cell measurements, the network can configure RSRP, RSRQ, SINR, RSCP or EcN0 as trigger quantity. For CLI measurements, the network can configure SRS-RSRP or CLI-RSSI as trigger quantity. For cell and beam measurements, reporting quantities can be any combination of quantities (i.e. only RSRP; only RSRQ; only SINR; RSRP and RSRQ; RSRP and SINR; RSRQ and SINR; RSRP, RSRQ and SINR; only RSCP; only EcN0; RSCP and EcN0), irrespective of the trigger quantity, and for CLI measurements, reporting quantities can be either SRS-RSRP or CLI-RSSI. For conditional reconfiguration execution, the network can configure up to 2 quantities, both using same RS type. The UE does not apply the layer 3 filtering to derive the CBR measurements. The UE does not apply the layer 3 filtering to derive the Rx-Tx time difference measurements. The UE does not apply the layer 3 filtering to derive the altitude measurements.

The network may also configure the UE to report measurement information per beam (which can either be measurement results per beam with respective beam identifier(s) or only beam identifier(s)), deriveda. If beam measurement information is configured to be included in measurement reports, the UE applies the layer 3 beam filtering. On the other hand, the exact L1 filtering of beam measurements used to derive cell measurement results is implementation dependent.

The UE shall:
>: whenever the UE has a measConfig, perform RSRP and RSRQ measurements for each serving cell for which servingCellMO is configured as follows:
>>: if the reportConfig associated with at least one measId included in the measIdList within VarMeasConfig contains an rsType set to ssb and ssb-ConfigMobility is configured in the measObject indicated by the servingCellMO:
>>>: if the reportConfig associated with at least one measId included in the measIdList within VarMeasConfig contains a reportQuantityRS-Indexes and maxNrofRS-IndexesToReport and contains an rsType set to ssb:
>>>>: derive layer 3 filtered RSRP and RSRQ per beam for the serving cell based on SS/PBCH block,a;
>>>: derive serving cell measurement results based on SS/PBCH block;
>>: if the reportConfig associated with at least one measId included in the measIdList within VarMeasConfig contains an rsType set to csi-rs and CSI-RS-ResourceConfigMobility is configured in the measObject indicated by the servingCellMO:
>>>: if the reportConfig associated with at least one measId included in the measIdList within VarMeasConfig contains a reportQuantityRS-Indexes and maxNrofRS-IndexesToReport and contains an rsType set to csi-rs:
>>>>: derive layer 3 filtered RSRP and RSRQ per beam for the serving cell based on CSI-RS,a;
>>>: derive serving cell measurement results based on CSI-RS;
>: for each serving cell for which servingCellMO is configured, if the reportConfig associated with at least one measId included in the measIdList within VarMeasConfig contains SINR as trigger quantity and/or reporting quantity:
>>: if the reportConfig contains rsType set to ssb and ssb-ConfigMobility is configured in the servingCellMO:
>>>: if the reportConfigcontains a reportQuantityRS-Indexes and maxNrofRS-IndexesToReport:
>>>>: derive layer 3 filtered SINR per beam for the serving cell based on SS/PBCH block,a;
>>>: derive serving cell SINR based on SS/PBCH block;
>>: if the reportConfig contains rsType set to csi-rs and CSI-RS-ResourceConfigMobility is configured in the servingCellMO:
>>>: if the reportConfigcontains a reportQuantityRS-Indexes and maxNrofRS-IndexesToReport:
>>>>: derive layer 3 filtered SINR per beam for the serving cell based on CSI-RS,a;
>>>: derive serving cell SINR based on CSI-RS;
>: for each measId included in the measIdList within VarMeasConfig:
>>: if the reportType for the associated reportConfig is set to reportCGI and timer T321 is running:
>>>: if useAutonomousGaps is configured for the associated reportConfig:
>>>>: perform the corresponding measurements on the frequency and RAT indicated in the associated measObject using autonomous gaps as necessary;
>>>: else:
>>>>: perform the corresponding measurements on the frequency and RAT indicated in the associated measObject using available idle periods;
>>>: if the cell indicated by reportCGI field for the associated measObject is an NR cell and that indicated cell is broadcasting SIB1:
>>>>: try to acquire SIB1 in the concerned cell;
>>>: if the cell indicated by reportCGI field is an E-UTRA cell:
>>>>: try to acquire SystemInformationBlockType1 in the concerned cell;
>>: if the ul-DelayValueConfig is configured for the associated reportConfig:
>>>: ignore the measObject;
>>>: for each of the configured DRBs, configure the PDCP layer to perform corresponding average UL PDCP packet delay measurement per DRB;
>>: if the ul-ExcessDelayConfig is configured for the associated reportConfig:
>>>: ignore the measObject;
>>>: for each of the configured DRBs, configure the PDCP layer to perform corresponding UL PDCP Excess Packet Delay delay measurement according to the configured threshold per DRB;
>>: if the reportType for the associated reportConfig is periodical, eventTriggered:
>>>: if a measurement gap configuration is setup, or
>>>: if the UE does not require measurement gaps to perform the concerned measurements:
>>>>: if s-MeasureConfig is not configured, or
>>>>: if s-MeasureConfig is set to ssb-RSRP and the NR SpCell RSRP based on SS/PBCH block, after layer 3 filtering, is lower than ssb-RSRP, or
>>>>: if s-MeasureConfig is set to csi-RSRP and the NR SpCell RSRP based on CSI-RS, after layer 3 filtering, is lower than csi-RSRP:
>>>>>: perform prediction on cell measurement results based on previously derived layer 3 filtered cell measurement results;
>>>>>: if the measObject is associated to NR and the rsType is set to csi-rs:
>>>>>>: if reportQuantityRS-Indexes and maxNrofRS-IndexesToReport for the associated reportConfig are configured:
>>>>>>>: derive layer 3 filtered beam measurements only based on CSI-RS for each measurement quantity indicated in reportQuantityRS-Indexes,a;
>>>>>>: derive cell measurement results based on CSI-RS for the trigger quantity and each measurement quantity indicated in reportQuantityCell using parameters from the associated measObject;
>>>>>: if the measObject is associated to NR and the rsType is set to ssb:
>>>>>>: if reportQuantityRS-Indexes and maxNrofRS-IndexesToReport for the associated reportConfig are configured:
>>>>>>>: derive layer 3 beam measurements only based on SS/PBCH block for each measurement quantity indicated in reportQuantityRS-Indexes,a;
>>>>>>: derive cell measurement results based on SS/PBCH block for the trigger quantity and each measurement quantity indicated in reportQuantityCell using parameters from the associated measObject;
>>>>>: if the measObject is associated to E-UTRA:
>>>>>>: perform the corresponding measurements associated to neighbouring cells on the frequencies indicated in the concerned measObject;
>>>>>: if the measObject is associated to UTRA-FDD:
>>>>>>: perform the corresponding measurements associated to neighbouring cells on the frequencies indicated in the concerned measObject;
>>>>>: if the measObject is associated to L2 U2N Relay UE:
>>>>>>: perform the corresponding measurements associated to candidate Relay UEs on the frequencies indicated in the concerned measObject, as described in 5.5.3.4;
>>>>: if the measRSSI-ReportConfig is configured in the associated reportConfig: >>>>>: perform the RSSI and channel occupancy measurements on the frequency configured by rmtc-Frequency in the associated measObject;
>>: if the reportType for the associated reportConfig is set to reportSFTD and the numberOfReportsSent as defined within the VarMeasReportList for this measId is less than one:
>>>: if the reportSFTD-Meas is set to true:
>>>>: if the measObject is associated to E-UTRA:
>>>>>: perform SFTD measurements between the PCell and the E-UTRA PSCell;
>>>>>: if the reportRSRP is set to true;
>>>>>>: perform RSRP measurements for the E-UTRA PSCell;
>>>>: else if the measObject is associated to NR:
>>>>>: perform SFTD measurements between the PCell and the NR PSCell;
>>>>>: if the reportRSRP is set to true;
>>>>>>: perform RSRP measurements for the NR PSCell based on SSB;
>>>: else if the reportSFTD-NeighMeas is included:
>>>>: if the measObject is associated to NR:
>>>>>: if the drx-SFTD-NeighMeas is included:
>>>>>>: perform SFTD measurements between the PCell and the NR neighbouring cell(s) detected based on parameters in the associated measObject using available idle periods;
>>>>>: else:
>>>>>>: perform SFTD measurements between the PCell and the NR neighbouring cell(s) detected based on parameters in the associated measObject;
>>>>>: if the reportRSRP is set to true:
>>>>>>: perform RSRP measurements based on SSB for the NR neighbouring cell(s) detected based on parameters in the associated measObject;
>>: if the reportType for the associated reportConfig is cli-Periodical or cli-EventTriggered:
>>>: perform the corresponding measurements associated to CLI measurement resources indicated in the concerned measObjectCLI;
>>: perform the evaluation of reporting criteria as specified in 5.5.4, except if reportConfig is condTriggerConfig.

The UE capable of Rx-Tx time difference measurement when configured with measObjectRxTxDiff shall:
>: perform the corresponding Rx-Tx time difference measurements associated with downlink reference signals indicated in the concerned measObjectRxTxDiff.

For Layer 3 filtering, The UE shall:
>: for each cell measurement quantity and each beam measurement quantity:
>>: filter the measured result, before using for evaluation of reporting criteria, for measurement reporting, for U2N/U2U Relay (re) selection evaluation or for evaluating the SyncRef UE, by the following formula:

$${F}_{n} = ( 1 - a ) * {F}_{n - 1} + a * {M}_{n}$$

where
Mₙ is the latest received measurement result from the physical layer;
Fₙ is the updated filtered measurement result, that is used for evaluation of reporting criteria, for measurement reporting, for U2N/U2U Relay (re) selection evaluation or for evaluating the SyncRef UE;
Fₙ₋₁ is the old filtered measurement result, where F₀ is set to Mi when the first measurement result from the physical layer is received; and for MeasObjectNR, a=½^{(ki/4)}, where kᵢ is the filterCoefficient for the corresponding measurement quantity of the i:th QuantityConfigNR in quantityConfigNR-List, and i is indicated by quantityConfigIndex in MeasObjectNR;
>>: adapt the filter such that the time characteristics of the filter are preserved at different input rates, observing that the filterCoefficient k assumes a sample rate equal to X ms; The value of X is equivalent to one intra-frequency L1 measurement period assuming non-DRX operation, and depends on frequency range.

If k is set to 0, no layer 3 filtering is applicable.

The filtering is performed in the same domain as used for evaluation of reporting criteria, for measurement reporting, for U2N Relay (re) selection evaluation or for evaluating the SyncRef UE, i.e., logarithmic filtering for logarithmic measurements.

### <Derivation of Cell Measurement Results>

The network may configure the UE in RRC_CONNECTED to derive RSRP, RSRQ and SINR measurement results per cell associated to NR measurement objects based on parameters configured in the measObject (e.g. maximum number of beams to be averaged and beam consolidation thresholds) and in the reportConfig (rsType to be measured, SS/PBCH block or CSI-RS).

The network may configure the UE in RRC_IDLE or in RRC_INACTIVE to derive RSRP and RSRQ measurement results per cell associated to NR carriers based on parameters configured in measIdleCarrierListNR within VarMeasIdleConfig for measurements performed according to 5.7.8.2a.

The UE shall:
>: for each cell measurement quantity to be derived based on SS/PBCH block:
>>: if nrofSS-BlocksToAverage is not configured in the associated measObject in RRC_CONNECTED or in the associated entry in measIdleCarrierListNR within VarMeasIdleConfig in RRC_IDLE/RRC_INACTIVE; or
>>: if absThreshSS-BlocksConsolidation is not configured in the associated measObject in RRC_CONNECTED or in the associated entry in measIdleCarrierListNR within VarMeasIdleConfig in RRC_IDLE/RRC_INACTIVE; or
>>: if the highest beam measurement quantity value is below or equal to absThreshSS-BlocksConsolidation:
>>>: derive each cell measurement quantity based on SS/PBCH block as the highest beam measurement quantity value;
>>: else:
>>>: derive each cell measurement quantity based on SS/PBCH block as the linear power scale average of the highest beam measurement quantity values above absThreshSS-BlocksConsolidation where the total number of averaged beams shall not exceed nrofSS-BlocksToAverage;
>>: if in RRC_CONNECTED, apply layer 3 cell filtering;
>: for each cell measurement quantity to be derived based on CSI-RS:
>>: consider a CSI-RS resource to be applicable for deriving cell measurements when the concerned CSI-RS resource is included in the csi-rs-CellMobility including the physCellId of the cell in the CSI-RS-ResourceConfigMobility in the associated measObject;
>>: if nrofCSI-RS-ResourcesToAverage in the associated measObject is not configured; or
>>: if absThreshCSI-RS-Consolidation in the associated measObject is not configured; or
>>: if the highest beam measurement quantity value is below or equal to absThreshCSI-RS-Consolidation:
>>>: derive each cell measurement quantity based on applicable CSI-RS resources for the cell as the highest beam measurement quantity value;
>>: else:
>>>: derive each cell measurement quantity based on CSI-RS as the linear power scale average of the highest beam measurement quantity values above absThreshCSI-RS-Consolidation where the total number of averaged beams shall not exceed nrofCSI-RS-ResourcesToAverage;
>>: apply layer 3 cell filtering.

For derivation of layer 3 beam filtered measurement, the UE shall:
>: for each layer 3 beam filtered measurement quantity to be derived based on SS/PBCH block;
>>: derive each configured beam measurement quantity based on SS/PBCH block, and apply layer 3 beam filtering;
>: for each layer 3 beam filtered measurement quantity to be derived based on CSI-RS;
>>: derive each configured beam measurement quantity based on CSI-RS as described in TS 38.215 [9], and apply layer 3 beam filtering.

For Measurement report triggering

If AS security has been activated successfully, the UE shall:
>: for each measId included in the measIdList within VarMeasConfig:
>>: if the corresponding reportConfig includes a reportType set to eventTriggered or periodical:
>>>: if the corresponding measObject concerns NR:
>>>>: if the corresponding reportConfig includes measRSSI-ReportConfig:
>>>>>: consider the resource indicated by the rmtc-Config on the associated frequency to be applicable;
>>>>: if the eventA1 or eventA2 is configured in the corresponding reportConfig: >>>>>: consider only the serving cell to be applicable;
>>>>: if the eventA3 or eventA5 or eventA3H1 or eventA3H2 or eventA5H1 or eventA5H2 is configured in the corresponding reportConfig:
>>>>>: if a serving cell is associated with a measObjectNR and neighbours are associated with another measObjectNR, consider any serving cell associated with the other measObjectNR to be a neighbouring cell as well;
>>>>: if the eventX2 is configured in the corresponding reportConfig:
>>>>>: consider only the serving L2 U2N Relay UE to be applicable;
>>>>: if corresponding reportConfig includes reportType set to periodical; or
>>>>: for measurement events other than eventA1, eventA2, eventD1, eventD2, eventX2, eventH1 or eventH2:
>>>>>: if useAllowedCellList is set to true:
>>>>>>: consider any neighbouring cell detected based on parameters in the associated measObjectNR to be applicable when the concerned cell is included in the allowedCellsToAddModList defined within the VarMeasConfig for this measId;
>>>>>: else:
>>>>>>: consider any neighbouring cell detected based on parameters in the associated measObjectNR to be applicable when the concerned cell is not included in the excludedCellsToAddModList defined within the VarMeasConfig for this measId;
>>>>: if the eventH1 or eventH2 is configured in the corresponding reportConfig:
>>>>>: for all the events with the same eventID for which simulMultiTriggerSingleMeasReport is set to true and the entry condition applicable for the event has been satisfied:
>>>>>>: consider only the event for which the difference between the corresponding altitude threshold and the altitude of the UE is the smallest to be applicable;
>>>>: else if the eventA3H1 or eventA3H2 or eventA4H1 or eventA4H2 or eventA5H1 or eventA5H2 is configured in the corresponding reportConfig:
>>>>>: for all the events with the same eventID associated with the same measObjectNR for which simulMultiTriggerSingleMeasReport is set to true and the entry conditions applicable for the event has been satisfied:
>>>>>>: consider only the event for which the difference between the corresponding altitude threshold and the altitude of the UE is the smallest to be applicable;
>>>: else if the corresponding measObject concerns E-UTRA:
>>>>: if eventB1 or eventB2 is configured in the corresponding reportConfig:
>>>>>: consider a serving cell, if any, on the associated E-UTRA frequency as neighbour cell;
>>>>: consider any neighbouring cell detected on the associated frequency to be applicable when the concerned cell is not included in the excludedCellsToAddModListEUTRAN defined within the VarMeasConfig for this measId;
>>>: else if the corresponding measObject concerns UTRA-FDD:
>>>>: if eventB1-UTRA-FDD or eventB2-UTRA-FDD is configured in the corresponding reportConfig; or
>>>>: if corresponding reportConfig includes reportType set to periodical:
>>>>>: consider a neighbouring cell on the associated frequency to be applicable when the concerned cell is included in the cellsToAddModList defined within the VarMeasConfig for this measId;
>>>: else if the corresponding measObject concerns L2 U2N Relay UE:
>>>>: if eventY1-Relay or eventY2-Relay or eventZ1-Relay is configured in the corresponding reportConfig; or
>>>>: if corresponding reportConfig includes reportType set to periodical:
>>>>>: consider any L2 U2N Relay UE fulfilling upper layer criteria detected on the associated frequency to be applicable for this measId;
>>: else if the corresponding reportConfig includes a reportType set to reportCGI:
>>>: consider the cell detected on the associated measObject which has a physical cell identity matching the value of the cellForWhichToReportCGI included in the corresponding reportConfig within the VarMeasConfig to be applicable;
>>: else if the corresponding reportConfig includes a reportType set to reportSFTD:
>>>: if the corresponding measObject concerns NR:
>>>>: if the reportSFTD-Meas is set to true:
>>>>>: consider the NR PSCell to be applicable;
>>>>: else if the reportSFTD-NeighMeas is included:
>>>>>: if cellsForWhichToReportSFTD is configured in the corresponding reportConfig:
>>>>>>: consider any NR neighbouring cell detected on the associated measObjectNR which has a physical cell identity that is included in the cellsForWhichToReportSFTD to be applicable;
>>>>>: else:
>>>>>>: consider up to 3 strongest NR neighbouring cells detected based on parameters in the associated measObjectNR to be applicable when the concerned cells are not included in the excludedCellsToAddModList defined within the VarMeasConfig for this measId;
>>>: else if the corresponding measObject concerns E-UTRA:
>>>>: if the reportSFTD-Meas is set to true:
>>>>>: consider the E-UTRA PSCell to be applicable;
>>: else if the corresponding reportConfig includes a reportType set to cli-Periodical or cli-EventTriggered:
>>>: consider all CLI measurement resources included in the corresponding measObject to be applicable;
>>: else if the corresponding reportConfig includes a reportType set to rxTxPeriodical:
>>>: consider all Rx-Tx time difference measurement resources included in the corresponding measObject to be applicable;
>>: if the corresponding reportConfig concerns the reporting for NR sidelink communication/discovery (i.e. reportConfigNR-SL):
>>>: consider the transmission resource pools indicated by the tx-PoolMeasToAddModList defined within the VarMeasConfig for this measId to be applicable;
>>: if the reportType is set to eventTriggered, and if the corresponding reportConfig does not include numberOfTriggeringCells, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig, while the VarMeasReportList does not include a measurement reporting entry for this measId (a first cell triggers the event):
>>>: include a measurement reporting entry within the VarMeasReportList for this measId;
>>>: set the numberOfReportsSent defined within the VarMeasReportList for this measId to 0;
>>>: include the concerned cell(s) in the cellsTriggeredList defined within the VarMeasReportList for this measId;
>>>: if use T312 is set to true in reportConfig for this event:
>>>>: if T310 for the corresponding SpCell is running; and
>>>>: if T312 is not running for corresponding SpCell:
>>>>>: start timer T312 for the corresponding SpCell with the value of T312 configured in the corresponding measObjectNR;
>>>: initiate the measurement reporting procedure;
>>: else if the reportType is set to eventTriggered, and if the corresponding reportConfig does not include numberOfTriggeringCells, and if the entry condition applicable for this event, i.e. the event corresponding with the eventId of the corresponding reportConfig within VarMeasConfig, is fulfilled for one or more applicable cells not included in the cellsTriggeredList for all measurements after layer 3 filtering taken during timeToTrigger defined for this event within the VarMeasConfig (a subsequent cell triggers the event):
>>>: set the numberOfReportsSent defined within the VarMeasReportList for this measId to 0;
>>>: include the concerned cell(s) in the cellsTriggeredList defined within the VarMeasReportList for this measId;
>>>: if use T312 is set to true in reportConfig for this event:
>>>>: if T310 for the corresponding SpCell is running; and
>>>>: if T312 is not running for corresponding SpCell:
>>>>>: start timer T312 for the corresponding SpCell with the value of T312 configured in the corresponding measObjectNR;
>>>: initiate the measurement reporting procedure;
>>: if the reportType is set to eventTriggered, and if the corresponding reportConfig includes numberOfTriggeringCells, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig:
>>>: if the VarMeasReportList does not include a measurement reporting entry for this measId (a first cell triggers the event):
>>>>: include a measurement reporting entry within the VarMeasReportList for this measId;
>>>: if the number of cell(s) in the cellsTriggeredList is larger than or equal to numberOfTriggeringCells:
>>>>: include the concerned cell(s) in the cellsTriggeredList defined within the VarMeasReportList for this measId;
>>>: else:
>>>>: include the concerned cell(s) in the cellsTriggeredList defined within the VarMeasReportList for this measId;
>>>>: if the number of cell(s) in the cellsTriggeredList is larger than or equal to numberOfTriggeringCells:
>>>>>: set the numberOfReportsSent defined within the VarMeasReportList for this measId to 0;
>>>>>: initiate the measurement reporting procedure;
>>: if the reportType is set to eventTriggered and if the leaving condition applicable for this event is fulfilled for one or more of the cells included in the cellsTriggeredList defined within the VarMeasReportList for this measId for all measurements after layer 3 filtering taken during timeToTrigger defined within the VarMeasConfig for this event:
>>>: remove the concerned cell(s) in the cellsTriggeredList defined within the VarMeasReportList for this measId;
>>>: if reportOnLeave is set to true for the corresponding reporting configuration:
>>>>: if the corresponding reportConfig does not include numberOfTriggeringCells; or
>>>>: if the corresponding reportConfig includes numberOfTriggeringCells and a measurement report was previously sent to the network for at least one of the concerned cell(s):
>>>>>: initiate the measurement reporting procedure;
>>>: if the cellsTriggeredList defined within the VarMeasReportList for this measId is empty:
>>>>: remove the measurement reporting entry within the VarMeasReportList for this measId;
>>>>: stop the periodical reporting timer for this measId, if running;
>>: if the reportType is set to eventTriggered and if the entry condition applicable for this event, i.e. the event corresponding with the eventId of the corresponding reportConfig within VarMeasConfig, is fulfilled for one or more applicable L2 U2N Relay UEs for all measurements after layer 3 filtering taken during timeToTrigger defined for this event within the VarMeasConfig, while the VarMeasReportList does not include a measurement reporting entry for this measId (a first L2 U2N Relay UE triggers the event):
>>>: include a measurement reporting entry within the VarMeasReportList for this measId;
>>>: set the numberOfReportsSent defined within the VarMeasReportList for this measId to 0;
>>>: include the concerned L2 U2N Relay UE(s) in the relaysTriggeredList defined within the VarMeasReportList for this measId;
>>>: initiate the measurement reporting procedure;
>>: else if the reportType is set to eventTriggered and if the entry condition applicable for this event, i.e. the event corresponding with the eventId of the corresponding reportConfig within VarMeasConfig, is fulfilled for one or more applicable L2 U2N Relay UEs not included in the relaysTriggeredList for all measurements after layer 3 filtering taken during timeToTrigger defined for this event within the VarMeasConfig (a subsequent L2 U2N Relay UE triggers the event):
>>>: set the numberOfReportsSent defined within the VarMeasReportList for this measId to 0;
>>>: include the concerned L2 U2N Relay UE(s) in the relaysTriggeredList defined within the VarMeasReportList for this measId;
>>>: initiate the measurement reporting procedure;
>>: else if the reportType is set to eventTriggered and if the leaving condition applicable for this event is fulfilled for one or more of the L2 U2N Relay UEs included in the relaysTriggeredList defined within the VarMeasReportList for this measId for all measurements after layer 3 filtering taken during timeToTrigger defined within the VarMeasConfig for this event:
>>>: remove the concerned L2 U2N Relay UE(s) in the relaysTriggeredList defined within the VarMeasReportList for this measId;
>>>: if reportOnLeave is set to true for the corresponding reporting configuration:
>>>>: initiate the measurement reporting procedure;
>>>: if the relaysTriggeredList defined within the VarMeasReportList for this measId is empty:
>>>>: remove the measurement reporting entry within the VarMeasReportList for this measId;
>>>>: stop the periodical reporting timer for this measId, if running;
>>: else if the reportType is set to eventTriggered and if the entry condition applicable for this event, i.e. the event corresponding with the eventId of the corresponding reportConfig within VarMeasConfig, is fulfilled for one or more applicable transmission resource pools for all measurements taken during timeToTrigger defined for this event within the VarMeasConfig, while the VarMeasReportList does not include an measurement reporting entry for this measId (a first transmission resource pool triggers the event):
>>>: include a measurement reporting entry within the VarMeasReportList for this measId;
>>>: set the numberOfReportsSent defined within the VarMeasReportList for this measId to 0;
>>>: include the concerned transmission resource pool(s) in the poolsTriggeredList defined within the VarMeasReportList for this measId;
>>>: initiate the measurement reporting procedure;
>>: else if the reportType is set to eventTriggered and if the entry condition applicable for this event, i.e. the event corresponding with the eventId of the corresponding reportConfig within VarMeasConfig, is fulfilled for one or more applicable transmission resource pools not included in the poolsTriggeredList for all measurements taken during timeToTrigger defined for this event within the VarMeasConfig (a subsequent transmission resource pool triggers the event):
>>>: set the numberOfReportsSent defined within the VarMeasReportList for this measId to 0;
>>>: include the concerned transmission resource pool(s) in the poolsTriggeredList defined within the VarMeasReportList for this measId;
>>>: initiate the measurement reporting procedure;
>>: if the reportType is set to eventTriggered and if the leaving condition applicable for this event is fulfilled for one or more applicable transmission resource pools included in the poolsTriggeredList defined within the VarMeasReportList for this measId for all measurements taken during timeToTrigger defined within the VarMeasConfig for this event:
>>>: remove the concerned transmission resource pool(s) in the poolsTriggeredList defined within the VarMeasReportList for this measId;
>>>: if the poolsTriggeredList defined within the VarMeasReportList for this measId is empty:
>>>>: remove the measurement reporting entry within the VarMeasReportList for this measId;
>>>>: stop the periodical reporting timer for this measId, if running
>>: else if the reportType is set to eventTriggered and if the eventId is set to eventD1 or eventD2 or eventH1 or eventH2 and if the entering condition applicable for this event, i.e. the event corresponding with the eventId of the corresponding reportConfig within VarMeasConfig, is fulfilled during timeToTrigger defined for this event within the VarMeasConfig, while the VarMeasReportList does not include a measurement reporting entry for this measId:
>>>: include a measurement reporting entry within the VarMeasReportList for this measId;
>>>: set the numberOfReportsSent defined within the VarMeasReportList for this measId to 0;
>>>: initiate the measurement reporting procedure;
>>: else if the reportType is set to eventTriggered and if the eventId is set to eventD1 or eventD2 or eventH1 or eventH2 and if the leaving condition applicable for this event is fulfilled for the associated VarMeasReport within the VarMeasReportList for this measId during timeToTrigger defined within the VarMeasConfig for this event:
>>>: if reportOnLeave is set to true for the corresponding reporting configuration:
>>>>: initiate the measurement reporting procedure;
>>>: remove the measurement reporting entry within the VarMeasReportList for this measId;
>>>: stop the periodical reporting timer for this measId, if running;
>>: if reportType is set to periodical and if a (first) measurement result is available:
>>>: include a measurement reporting entry within the VarMeasReportList for this measId;
>>>: set the numberOfReportsSent defined within the VarMeasReportList for this measId to 0;
>>>: if the corresponding reportConfig includes measRSSI-ReportConfig:
>>>>: initiate the measurement reporting procedure immediately when RSSI sample values are reported by the physical layer after the first L1 measurement duration;
>>>: else if the corresponding reportConfig includes the ul-Delay ValueConfig:
>>>>: initiate the measurement reporting procedure immediately after a first measurement result is provided from lower layers of the associated DRB identity;
>>>: else if the corresponding reportConfig includes the ul-ExcessDelayConfig:
>>>>: initiate the measurement reporting procedure immediately after a first measurement result is provided from lower layers of the associated DRB identity(ies) according to the configured threshold per DRB identity(ies);
>>>: else if the reportAmount exceeds 1:
>>>>: initiate the measurement reporting procedure immediately after the quantity to be reported becomes available for the NR SpCell or for the serving L2 U2N Relay UE (if the UE is a L2 U2N Remote UE);
>>>: else (i.e. the reportAmount is equal to 1):
>>>>: initiate the measurement reporting procedure immediately after the quantity to be reported becomes available for the NR SpCell and for the strongest cell among the applicable cells, or for the NR SpCell and for the strongest L2 U2N Relay UEs among the applicable L2 U2N Relay UEs; or initiate the measurement reporting procedure immediately after the quantity to be reported becomes available for the serving L2 U2N Relay UE and for the strongest cell among the applicable cells, or for the serving L2 U2N Relay UE and for the strongest L2 U2N Relay UEs among the applicable L2 U2N Relay UEs (if the UE is a L2 U2N Remote UE);
>>: if, in case the corresponding reportConfig concerns the reporting for NR sidelink communication/discovery, reportType is set to periodical and if a (first) measurement result is available:
>>>: include a measurement reporting entry within the VarMeasReportList for this measId;
>>>: set the numberOfReportsSent defined within the VarMeasReportList for this measId to 0;
>>>: initiate the measurement reporting procedure immediately after the quantity to be reported becomes available for the NR SpCell and CBR measurement results become available;
>>: if the reportType is set to cli-EventTriggered and if the entry condition applicable for this event, i.e. the event corresponding with the eventId of the corresponding reportConfig within VarMeasConfig, is fulfilled for one or more applicable CLI measurement resources for all measurements after layer 3 filtering taken during timeToTrigger defined for this event within the VarMeasConfig, while the VarMeasReportList does not include a measurement reporting entry for this measId (a first CLI measurement resource triggers the event):
>>>: include a measurement reporting entry within the VarMeasReportList for this measId;
>>>: set the numberOfReportsSent defined within the VarMeasReportList for this measId to 0;
>>>: include the concerned CLI measurement resource(s) in the cli-TriggeredList defined within the VarMeasReportList for this measId;
>>>: initiate the measurement reporting procedure;
>>: else if the reportType is set to cli-EventTriggered and if the entry condition applicable for this event, i.e. the event corresponding with the eventId of the corresponding reportConfig within VarMeasConfig, is fulfilled for one or more CLI measurement resources not included in the cli-TriggeredList for all measurements after layer 3 filtering taken during timeToTrigger defined for this event within the VarMeasConfig (a subsequent CLI measurement resource triggers the event):
>>>: set the numberOfReportsSent defined within the VarMeasReportList for this measId to 0;
>>>: include the concerned CLI measurement resource(s) in the cli-TriggeredList defined within the VarMeasReportList for this measId;
>>>: initiate the measurement reporting procedure;
>>: if the reportType is set to cli-EventTriggered and if the leaving condition applicable for this event is fulfilled for one or more of the CLI measurement resources included in the cli-TriggeredList defined within the VarMeasReportList for this measId for all measurements after layer 3 filtering taken during timeToTrigger defined within the VarMeasConfig for this event:
>>>: remove the concerned CLI measurement resource(s) in the cli-TriggeredList defined within the VarMeasReportList for this measId;
>>>: if reportOnLeave is set to true for the corresponding reporting configuration:
>>>>: initiate the measurement reporting procedure;
>>>: if the cli-TriggeredList defined within the VarMeasReportList for this measId is empty:
>>>>: remove the measurement reporting entry within the VarMeasReportList for this measId;
>>>>: stop the periodical reporting timer for this measId, if running;
>>: if reportType is set to cli-Periodical and if a (first) measurement result is available:
>>>: include a measurement reporting entry within the VarMeasReportList for this measId;
>>>: set the numberOfReportsSent defined within the VarMeasReportList for this measId to 0;
>>>: initiate the measurement reporting procedure immediately after the quantity to be reported becomes available for at least one CLI measurement resource;
>>: if reportType is set to rxTxPeriodical and if a (first) measurement result is available:
>>>: include a measurement reporting entry within the VarMeasReportList for this measId;
>>>: set the numberOfReportsSent defined within the VarMeasReportList for this measId to 0;
>>>: initiate the measurement reporting procedure;
>>: upon expiry of the periodical reporting timer for this measId:
>>>: initiate the measurement reporting procedure.
>>: if the corresponding reportConfig includes a reportType is set to reportSFTD:
>>>: if the corresponding measObject concerns NR:
>>>>: if the drx-SFTD-NeighMeas is included:
>>>>>: if the quantity to be reported becomes available for each requested pair of PCell and NR cell:
>>>>>>: stop timer T322;
>>>>>>: initiate the measurement reporting procedure;
>>>>: else
>>>>>: initiate the measurement reporting procedure immediately after the quantity to be reported becomes available for each requested pair of PCell and NR cell or the maximal measurement reporting delay;
>>>: else if the corresponding measObject concerns E-UTRA:
>>>>: initiate the measurement reporting procedure immediately after the quantity to be reported becomes available for the pair of PCell and E-UTRA PSCell or the maximal measurement reporting delay;
>>: if reportType is set to reportCGI:
>>>: if the UE acquired the SIB1 or SystemInformationBlockType1 for the requested cell; or
>>>: if the UE detects that the requested NR cell is not transmitting SIB1:
>>>>: stop timer T321;
>>>>: include a measurement reporting entry within the VarMeasReportList for this measId;
>>>>: set the numberOfReportsSent defined within the VarMeasReportList for this measId to 0;
>>>>: initiate the measurement reporting procedure;
>>: upon the expiry of T321 for this measId:
>>>: include a measurement reporting entry within the VarMeasReportList for this measId;
>>>: set the numberOfReportsSent defined within the VarMeasReportList for this measId to 0;
>>>: initiate the measurement reporting procedure.
>>: upon the expiry of T322 for this measId:
>>>: initiate the measurement reporting procedure.

If AS security has been activated successfully and if SCell activation(s) indication is received from lower layer, the UE shall:
>: if reportType is set to reportOnActivation for any measId included in the measIdList within VarMeasConfig:
>>: if the activated SCell(s) fulfills the measurement requirement:
>>>: include a measurement reporting entry within the VarMeasReportList for this measId:
>>>: set the numberOfReportsSent defined within the VarMeasReportList for this measId to 0;
>>>>: initiate the measurement reporting procedure.
   <Event B1 (Inter RAT Neighbour Becomes Better than Threshold)>

The UE shall:
>: consider the entering condition for this event to be satisfied when condition B1-1, as specified below, is fulfilled;
>: consider the leaving condition for this event to be satisfied when condition B1-2, as specified below, is fulfilled.

$$\begin{matrix}( Entering condition ) & \\ Mn + Ofn + Ocn - Hys > Thresh & Inequality B1 - 1\end{matrix}$$

$$\begin{matrix}( Leaving condition ) & \\ Mn + Ofn + Ocn + Hys < Thresh & Inequality B1 - 2\end{matrix}$$

The variables in the formula are defined as follows:
Mn is the measurement result of the inter-RAT neighbour cell, not taking into account any offsets.
Ofn is the measurement object specific offset of the frequency of the inter-RAT neighbour cell (i.e. eutra-Q-OffsetRange as defined within the measObjectEUTRA corresponding to the frequency of the neighbour inter-RAT cell, utra-FDD-Q-OffsetRange as defined within the measObjectUTRA-FDD corresponding to the frequency of the neighbour inter-RAT cell).
Ocn is the cell specific offset of the inter-RAT neighbour cell (i.e. cellIndividualOffset as defined within the measObjectEUTRA corresponding to the neighbour inter-RAT cell, or cellIndividualOffset as defined within reportConfigInterRAT), and set to zero if not configured for the neighbour cell.
Hys is the hysteresis parameter for this event (i.e. hysteresis as defined within reportConfigInterRAT for this event).
Thresh is the threshold parameter for this event (i.e. b1-ThresholdEUTRA as defined within reportConfigInterRAT for this event, b1-ThresholdUTRA-FDD as defined for UTRA-FDD within reportConfigInterRAT for this event).
Mn is expressed in dBm or in dB, depending on the measurement quantity of the inter-RAT neighbour cell.
Ofn, Ocn, Hys are expressed in dB.
Thresh is expressed in the same unit as Mn.
   <Event B2 (PCell Becomes Worse than Threshold1 and Inter RAT Neighbour Becomes Better than Threshold2)>

The UE shall:
>: consider the entering condition for this event to be satisfied when both condition B2-1 and condition B2-2, as specified below, are fulfilled;
>: consider the leaving condition for this event to be satisfied when condition B2-3 or condition B2-4, i.e. at least one of the two, as specified below, is fulfilled;

$$\begin{matrix}( Entering condition 1 ) & \\ Mp + Hys < Thresh 1 & Inequality B2 - 1\end{matrix}$$

$$\begin{matrix}( Entering condition 2 ) & \\ Mn + Ofn + Ocn - Hys > Thresh 2 & Inequality B2 - 2\end{matrix}$$

$$\begin{matrix}( Leaving condition 1 ) & \\ Mp - Hys > Thresh 1 & Inequality B2 - 3\end{matrix}$$

$$\begin{matrix}( Leaving condition 2 ) & \\ Mn + Ofn + Ocn + Hys < Thresh 2 & Inequality B2 - 4\end{matrix}$$

The variables in the formula are defined as follows:
Mp is the measurement result of the PCell, not taking into account any offsets.
Mn is the measurement result of the inter-RAT neighbour cell, not taking into account any offsets.
Ofn is the measurement object specific offset of the frequency of the inter-RAT neighbour cell (i.e. eutra-Q-OffsetRange as defined within the measObjectEUTRA corresponding to the frequency of the inter-RAT neighbour cell, utra-FDD-Q-OffsetRange as defined within the measObjectUTRA-FDD corresponding to the frequency of the neighbour inter-RAT cell).
Ocn is the cell specific offset of the inter-RAT neighbour cell (i.e. cellIndividualOffset as defined within the measObjectEUTRA corresponding to the neighbour inter-RAT cell, or cellIndividualOffset as defined within reportConfigInterRAT), and set to zero if not configured for the neighbour cell.
Hys is the hysteresis parameter for this event (i.e. hysteresis as defined within reportConfigInterRAT for this event).
Thresh1 is the threshold parameter for this event (i.e. b2-Threshold1 as defined within reportConfigInterRAT for this event).
Thresh2 is the threshold parameter for this event (i.e. b2-Threshold2EUTRA as defined within reportConfigInterRAT for this event, b2-Threshold2UTRA-FDD as defined for UTRA-FDD within reportConfigInterRAT for this event).
Mp is expressed in dBm in case of RSRP, or in dB in case of RSRQ and SINR.
Mn is expressed in dBm or dB, depending on the measurement quantity of the inter-RAT neighbour cell.
Ofn, Ocn, Hys are expressed in dB.
Thresh1 is expressed in the same unit as Mp.
Thresh2 is expressed in the same unit as Mn.
   <Event I1 (Interference Becomes Higher than Threshold)>

The UE shall:
>: consider the entering condition for this event to be satisfied when condition I1-1, as specified below, is fulfilled;
>: consider the leaving condition for this event to be satisfied when condition I1-2, as specified below, is fulfilled.

$$\begin{matrix}( Entering condition ) & \\ Mi - Hys > Thresh & Inequality I1 - 1\end{matrix}$$

$$\begin{matrix}( Leaving condition ) & \\ Mi + Hys < Thresh & Inequality I1 - 2\end{matrix}$$

The variables in the formula are defined as follows:
Mi is the measurement result of the interference, not taking into account any offsets.
Hys is the hysteresis parameter for this event (i.e. hysteresis as defined within reportConfigNR for this event).
Thresh is the threshold parameter for this event (i.e. il-Threshold as defined within reportConfigNR for this event).
Mi, Thresh are expressed in dBm.
Hys is expressed in dB.

### <Event C1 (the NR Sidelink Channel Busy Ratio is Above a Threshold)>

The UE shall:
>: consider the entering condition for this event to be satisfied when condition C1-1, as specified below, is fulfilled;
>: consider the leaving condition for this event to be satisfied when condition C1-2, as specified below, is fulfilled;

$$\begin{matrix}( Entering condition ) & \\ Ms - Hys > Thres & Inequality C1 - 1\end{matrix}$$

$$\begin{matrix}( Leaving condition ) & \\ Ms - Hys < Thres & Inequality C1 - 2\end{matrix}$$

The variables in the formula are defined as follows:
Ms is the measurement result of channel busy ratio of the transmission resource pool, not taking into account any offsets.
Hys is the hysteresis parameter for this event (i.e. hysteresis as defined within reportConfigNR-SL for this event).
Thresh is the threshold parameter for this event (i.e. c1-Threshold as defined within reportConfigNR-SL for this event).
Ms is expressed in decimal from 0 to 1 in steps of 0.01.
Hys is expressed is in the same unit as Ms.
Thresh is expressed in the same unit as Ms.

### <Event C2 (the NR Sidelink Channel Busy Ratio is Below a Threshold)>

The UE shall:
>: consider the entering condition for this event to be satisfied when condition C2-1, as specified below, is fulfilled;
>: consider the leaving condition for this event to be satisfied when condition C2-2, as specified below, is fulfilled;

$$\begin{matrix}( Entering condition ) & \\ Ms - Hys < Thres & Inequality C2 - 1\end{matrix}$$

$$\begin{matrix}( Leaving condition ) & \\ Ms - Hys > Thres & Inequality C2 - 2\end{matrix}$$

The variables in the formula are defined as follows:
Ms is the measurement result of channel busy ratio of the transmission resource pool, not taking into account any offsets.
Hys is the hysteresis parameter for this event (i.e. hysteresis as defined within reportConfigNR-SL for this event).
Thresh is the threshold parameter for this event (i.e. c2-Threshold as defined within reportConfigNR-SL for this event).
Ms is expressed in decimal from 0 to 1 in steps of 0.01.
Hys is expressed is in the same unit as Ms.
Thresh is expressed in the same unit as Ms.
   <Event D1 (Distance Between UE and referenceLocation1 is Above Threshold1 and Distance Between UE and referenceLocation2 is Below Threshold2)>

The UE shall:
>: consider the entering condition for this event to be satisfied when both condition D1-1 and condition D1-2, as specified below, are fulfilled;
>: consider the leaving condition for this event to be satisfied when condition D1-3 or condition D1-4, i.e. at least one of the two, as specified below, are fulfilled;

$$\begin{matrix}( Entering condition 1 ) & \\ Ml 1 - Hys > Thresh 1 & Inequality D1 - 1\end{matrix}$$

$$\begin{matrix}( Entering condition 2 ) & \\ Ml 2 + Hys < Thresh 2 & Inequality D1 - 2\end{matrix}$$

$$\begin{matrix}( Leaving condition 1 ) & \\ Ml 1 + Hys < Thresh 1 & Inequality D1 - 3\end{matrix}$$

$$\begin{matrix}( Leaving condition 2 ) & \\ Ml 2 - Hys > Thresh 2 & Inequality D1 - 4\end{matrix}$$

The variables in the formula are defined as follows:
Ml1 is the distance between UE and a reference location for this event (i.e. referenceLocation1 as defined within reportConfigNR for this event), not taking into account any offsets.
Ml2 is the distance between UE and a reference location for this event (i.e. referenceLocation2 as defined within reportConfigNR for this event), not taking into account any offsets.
Hys is the hysteresis parameter for this event (i.e. hysteresisLocation as defined within reportConfigNR for this event).
Thresh1 is the threshold for this event defined as a distance, configured with parameter distanceThreshFromReference1, from a reference location configured with parameter referenceLocation1 within reportConfigNR for this event.
Thresh2 is the threshold for this event defined as a distance, configured with parameter distanceThreshFromReference2, from a reference location configured with parameter referenceLocation2 within reportConfigNR for this event.
Ml1 is expressed in meters.
Ml2 is expressed in the same unit as Ml1.
Hys is expressed in the same unit as Ml1.
Thresh1 is expressed in the same unit as Ml1.
Thresh2 is expressed in the same unit as Ml1.

The definition of Event D1 also applies to CondEvent D1.

### <Event D2 (Distance Between UE and Serving Cell Moving Reference Location is Above Threshold1 and Distance Between UE and a Moving Reference Location is Below Threshold2)>

The UE shall:
>: consider the entering condition for this event to be satisfied when both condition D2-1 and condition D2-2, as specified below, are fulfilled;
>: consider the leaving condition for this event to be satisfied when condition D2-3 or condition D2-4, i.e. at least one of the two, as specified below, are fulfilled;

$$\begin{matrix}( Entering condition 1 ) & \\ Ml 1 - Hys > Thresh 1 & Inequality D2 - 1\end{matrix}$$

$$\begin{matrix}( Entering condition 2 ) & \\ Ml 2 + Hys < Thresh 2 & Inequality D2 - 2\end{matrix}$$

$$\begin{matrix}( Leaving condition 1 ) & \\ Ml 1 + Hys < Thresh 1 & Inequality D2 - 3\end{matrix}$$

$$\begin{matrix}( Leaving condition 2 ) & \\ Ml 2 - Hys > Thresh 2 & Inequality D2 - 4\end{matrix}$$

The variables in the formula are defined as follows:
Ml1 is the distance between UE and a moving reference location for this event, not taking into account any offsets. The moving reference location is determined based on movingReferenceLocation and the corresponding epoch time and satellite ephemeris for the serving cell broadcast in SIB19.
Ml2 is the distance between UE and a moving reference location for this event, not taking into account any offsets. The moving reference location is determined based on referenceLocation2 as defined within reportConfigNR for this event and the corresponding epoch time and satellite ephemeris for the candidate cell.
Hys is the hysteresis parameter for this event (i.e. hysteresisLocation as defined within reportConfigNR for this event).
Thresh1 is the threshold for this event defined as a distance, configured with parameter distance ThreshFromReference1 in reportConfigNR for this event, from a moving reference location derived based on the parameter movingReferenceLocation within SIB19.
Thresh2 is the threshold for this event defined as a distance, configured with parameter distanceThreshFromReference2, from a moving reference location derived based on the parameter referenceLocation2 within reportConfigNR for this event.
Ml1 is expressed in meters.
Ml2 is expressed in the same unit as Ml1.
Hys is expressed in the same unit as Ml1.
Thresh1 is expressed in the same unit as Ml1.
Thresh2 is expressed in the same unit as Ml1.

The definition of Event D2 also applies to CondEvent D2.

<CondEvent T1 (Time Measured at UE is within a Duration from Threshold)>

The UE shall:
>: consider the entering condition for this event to be satisfied when condition T1-1, as specified below, is fulfilled;
>: consider the leaving condition for this event to be satisfied when condition T1-2, as specified below, is fulfilled;

Inequality T1-1 (Entering condition)

Inequality T1-2 (Leaving condition)

The variables in the formula are defined as follows:
Mt is the time measured at UE.
Thresh1 is the threshold parameter for this event (i.e. t1-Threshold as defined within reportConfigNR for this event).
Duration is the duration parameter for this event (i.e. duration as defined within reportConfigNR for this event).
Mt is expressed in ms.
Thresh1 is expressed in the same unit as Mt.

Duration is expressed in the same unit as Mt.

<Event H1 (the Aerial UE Altitude Becomes Higher than a Threshold)>

The UE shall:
>: consider the entering condition for this event to be satisfied when condition H1-1, as specified below, is fulfilled;
>: consider the leaving condition for this event to be satisfied when condition H1-2, as specified below, is fulfilled;

$$\begin{matrix}( Entering condition ) & \\ Ms - Hys > Thresh & Inequality H1 - 1\end{matrix}$$

$$\begin{matrix}( Leaving condition ) & \\ Ms + Hys < Thresh & Inequality H1 - 2\end{matrix}$$

The variables in the formula are defined as follows:
Ms is the Aerial UE altitude relative to the sea level.
Hys is the hysteresis parameter for this event (i.e. h1-Hysteresis as defined within reportConfigNR for this event).
Thresh is the threshold parameter for this event (i.e. h1-Threshold as defined within reportConfigNR for this event).
Ms, Hys, Thresh are expressed in meters.
   <Event H2 (the Aerial UE Altitude Becomes Lower than a Threshold)>

The UE shall:
>: consider the entering condition for this event to be satisfied when condition H2-1, as specified below, is fulfilled;
>: consider the leaving condition for this event to be satisfied when condition H2-2, as specified below, is fulfilled;

$$\begin{matrix}( Entering condition ) & \\ Ms + Hys < Thresh & Inequality H2 - 1\end{matrix}$$

$$\begin{matrix}( Leaving condition ) & \\ Ms - Hys > Thresh & Inequality H2 - 2\end{matrix}$$

The variables in the formula are defined as follows:
Ms is the Aerial UE altitude relative to the sea level.
Hys is the hysteresis parameter for this event (i.e. h2-Hysteresis as defined within reportConfigNR for this event).
Thresh is the threshold parameter for this event (i.e. h2-Threshold as defined within reportConfigNR for this event).
Ms, Hys, Thresh are expressed in meters.
   <Event A3H1 (Neighbour Becomes Offset Better than SpCell and the Aerial UE Altitude Becomes Higher than a Threshold)>

The UE shall:
>: consider the entering condition for this event to be satisfied when both condition A3H1-1 and condition A3H1-2, as specified below, are fulfilled;
>: consider the leaving condition for this event to be satisfied when condition A3H1-3 or condition A3H1-4, i.e. at least one of the two, as specified below, is fulfilled;
>: use the SpCell for Mp, Ofp and Ocp.

The cell(s) that triggers the event has reference signals indicated in the measObjectNR associated to this event which may be different from the NR SpCell measObjectNR.

$$\begin{matrix}( Entering condition 1 ) & \\ Mn + Ofn + Ocn - Hys 1 > Mp + Ofp + Ocp + Off & Inequality A3H1 - 1\end{matrix}$$

$$\begin{matrix}( Entering condition 2 ) & \\ Ms - Hys 2 > Thresh & Inequality A3H1 - 2\end{matrix}$$

$$\begin{matrix}( Leaving condition 1 ) & \\ Mn + Ofn + Ocn + Hys 1 < Mp + Ofp + Ocp + Off & Inequality A3H1 - 3\end{matrix}$$

$$\begin{matrix}( Leaving condition 2 ) & \\ Ms + Hys 2 < Thresh & Inequality A3H1 - 4\end{matrix}$$

The variables in the formula are defined as follows:
Mn is the measurement result of the neighbouring cell, not taking into account any offsets.
Ofn is the measurement object specific offset of the reference signal of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the frequency of the neighbour cell, or cellIndividualOffset as defined within reportConfigNR), and set to zero if not configured for the neighbour cell.
Mp is the measurement result of the SpCell, not taking into account any offsets.
Ofp is the measurement object specific offset of the SpCell (i.e. offsetMO as defined within measObjectNR corresponding to the SpCell).
Ocp is the cell specific offset of the SpCell (i.e. cellIndividualOffset as defined within measObjectNR corresponding to the SpCell), and is set to zero if not configured for the SpCell.
Hys1 is the hysteresis parameter for this event (i.e. a3-Hysteresis as defined within reportConfigNR for this event).
Off is the offset parameter for this event (i.e. a3-Offset as defined within reportConfigNR for this event).
Ms is the Aerial UE altitude relative to the sea level.
Hys2 is the hysteresis parameter for this event (i.e. h1-Hysteresis as defined within reportConfigNR for this event).
Thresh is the threshold parameter for this event (i.e. h1-Threshold as defined within reportConfigNR for this event).
Mn, Mp are expressed in dBm in case of RSRP, or in dB in case of RSRQ and RS-SINR.
Ofn, Ocn, Hys1, Ofp, Ocp, Off are expressed in dB.
Ms, Hys2, Thresh are expressed in meters.

### <Measurement Reporting>

The purpose of measurement reporting procedure is to transfer measurement results from the UE to the network. The UE shall initiate this procedure only after successful AS security activation.

For the measId for which the measurement reporting procedure was triggered, the UE shall set the measResults within the MeasurementReport message as follows:
>: set the measId to the measurement identity that triggered the measurement reporting;
>: for each serving cell configured with servingCellMO:
>>: if the reportConfig associated with the measId that triggered the measurement reporting includes rsType:
>>>: if the serving cell measurements based on the rsType included in the reportConfig that triggered the measurement report are available:
>>>>: set the measResultServingCell within measResultServingMOList to include RSRP, RSRQ and the available SINR of the serving cell, derived based on the rsType included in the reportConfig that triggered the measurement report;
>>: else:
>>>: if SSB based serving cell measurements are available:
>>>>: set the measResultServingCell within measResultServingMOList to include RSRP, RSRQ and the available SINR of the serving cell, derived based on SSB;
>>>: else if CSI-RS based serving cell measurements are available:
>>>>: set the measResultServingCell within measResultServingMOList to include RSRP, RSRQ and the available SINR of the serving cell, derived based on CSI-RS;
>: set the servCellId within measResultServingMOList to include each NR serving cell that is configured with servingCellMO, if any;
>: if the reportConfig associated with the measId that triggered the measurement reporting includes reportQuantityRS-Indexes and maxNrofRS-IndexesToReport:
>>: for each serving cell configured with servingCellMO, include beam measurement information according to the associated reportConfig2;
>: if the reportConfig associated with the measId that triggered the measurement reporting includes reportAddNeighMeas:
>>: for each measObjectId referenced in the measIdList which is also referenced with servingCellMO, other than the measObjectId corresponding with the measId that triggered the measurement reporting:
>>>: if the measObjectNR indicated by the servingCellMO includes the RS resource configuration corresponding to the rsType indicated in the reportConfig:
>>>>: set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
>>>>: if the reportConfig associated with the measId that triggered the measurement reporting includes reportQuantityRS-Indexes and maxNrofRS-IndexesToReport:
>>>>>: for each best non-serving cell included in the measurement report:
>>>>>>: include beam measurement information according to the associated reportConfig2;
>: if the reportConfig associated with the measId that triggered the measurement reporting is set to eventTriggered and eventID is set to eventA3, or eventA4, or eventA5, or eventB1, or eventB2, or eventA3H1, or eventA3H2, or eventA4H1, or eventA4H2, or eventA5H1, or eventA5H2:
>>: if the UE is in NE-DC and the measurement configuration that triggered this measurement report is associated with the MCG:
>>>: set the measResultServFreqListEUTRA-SCG to include an entry for each E-UTRA SCG serving frequency with the following:
>>>>: include carrierFreq of the E-UTRA serving frequency;
>>>>: set the measResultServingCell to include the available measurement quantities that the UE is configured to measure by the measurement configuration associated with the SCG;
>>>>: if reportConfig associated with the measId that triggered the measurement reporting includes reportAddNeighMeas:
>>>>>: set the measResultServFreqListEUTRA-SCG to include within measResultBestNeighCell the quantities of the best non-serving cell, based on RSRP, on the concerned serving frequency;
>: if reportConfig associated with the measId that triggered the measurement reporting is set to eventTriggered and eventID is set to eventA3, or eventA4, or eventA5, or eventA3H1, or eventA3H2, or eventA4H1, or eventA4H2, or eventA5H1, or eventA5H2:
>>: if the UE is in NR-DC and the measurement configuration that triggered this measurement report is associated with the MCG:
>>>: set the measResultServFreqListNR-SCG to include for each NR SCG serving cell that is configured with servingCellMO, if any, the following:
>>>>: if the reportConfig associated with the measId that triggered the measurement reporting includes rsType:
>>>>>: if the serving cell measurements based on the rsType included in the reportConfig that triggered the measurement report are available according to the measurement configuration associated with the SCG:
>>>>>>: set the measResultServingCell within measResultServFreqListNR-SCG to include RSRP, RSRQ and the available SINR of the serving cell, derived based on the rsType included in the reportConfig that triggered the measurement report;
>>>>: else:
>>>>>: if SSB based serving cell measurements are available according to the measurement configuration associated with the SCG:
>>>>>>: set the measResultServingCell within measResultServFreqListNR-SCG to include RSRP, RSRQ and the available SINR of the serving cell, derived based on SSB;
>>>>>: else if CSI-RS based serving cell measurements are available according to the measurement configuration associated with the SCG:
>>>>>>: set the measResultServingCell within measResultServFreqListNR-SCG to include RSRP, RSRQ and the available SINR of the serving cell, derived based on CSI-RS;
>>>>: if results for the serving cell derived based on SSB are included:
>>>>>: include the ssbFrequency to the value indicated by ssbFrequency as included in the MeasObjectNR of the serving cell;
>>>>: if results for the serving cell derived based on CSI-RS are included:
>>>>>: include the refFreqCSI-RS to the value indicated by refFreqCSI-RS as included in the MeasObjectNR of the serving cell;
>>>>: if the reportConfig associated with the measId that triggered the measurement reporting includes report QuantityRS-Indexes and maxNrofRS-IndexesToReport:
>>>>>: for each serving cell configured with servingCellMO, include beam measurement information according to the associated reportConfig2, where availability is considered according to the measurement configuration associated with the SCG;
>>>>: if reportConfig associated with the measId that triggered the measurement reporting includes reportAddNeighMeas:
>>>>>: if the measObjectNR indicated by the servingCellMO includes the RS resource configuration corresponding to the rsType indicated in the reportConfig:
>>>>>>: set the measResultNeighCellListNR within measResultServFreqListNR-SCG to include one entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
>>>>>>>: if the reportConfig associated with the measId that triggered the measurement reporting includes reportQuantityRS-Indexes and maxNrofRS-IndexesToReport:
>>>>>>>>: for each best non-serving cell included in the measurement report:
>>>: include beam measurement information according to the associated reportConfig2, where availability is considered according to the measurement configuration associated with the SCG;
>: if the measRSSI-ReportConfig is configured within the corresponding reportConfig for this measId:
>>: set the rssi-Result to the linear average of sample value(s) provided by lower layers in the reportInterval;
>>: set the channelOccupancy to the rounded percentage of sample values which are beyond the channelOccupancyThreshold within all the sample values in the reportInterval;
>: if the UE is acting as L2 U2N Remote UE:
>>: set the sl-MeasResultServingRelay in accordance with the following:
>>>: set the cellIdentity to include the cellAccessRelatedInfo contained in the discovery message received from the serving L2 U2N Relay UE;
>>>: set the sl-RelayUE-Identity to include the Source L2 ID of the serving L2 U2N Relay;
>>>: if the measurement of serving L2 U2N Relay UE is based on SL-RSRP:
>>>>: set the sl-MeasResult to include the SL-RSRP of the serving L2 U2N Relay UE;
>>>>: set the sl-MeasQuantity to sl-rsrp, if supported by the UE;
>>>: else:
>>>>: set the sl-MeasResult to include the SD-RSRP of the serving L2 U2N Relay UE;
>>>>: set the sl-MeasQuantity to sd-rsrp, if supported by the UE;

In case of no data transmission from L2 U2N Relay UE to L2 U2N Remote UE, it is left to UE implementation whether to use SL-RSRP or SD-RSRP when setting the sl-MeasResultServingRelay of the serving L2 U2N Relay UE.
>: if there is at least one applicable neighbouring cell or candidate L2 U2N Relay UE to report:
>>: if the reportType is set to eventTriggered or periodical:
>>>: if the measurement report concerns the candidate L2 U2N Relay UE:
>>>>: set the sl-MeasResultsCandRelay in measResultNeighCells to include the best candidate L2 U2N Relay UEs up to maxNrofRelayMeas in accordance with the following:
>>>>>: if the reportType is set to eventTriggered:
>>>>>>: include the L2 U2N Relay UEs included in the relaysTriggeredList as defined within the VarMeasReportList for this measId;
>>>>>: else:
>>>>>>: include the applicable L2 U2N Relay UEs for which the new measurement results became available since the last periodical reporting or since the measurement was initiated or reset;
>>>>>: for each L2 U2N Relay UE that is included in the sl-MeasResultsCandRelay:
>>>>>>: set the cellIdentity to include the cellAccessRelatedInfo contained in the discovery message received from the concerned L2 U2N Relay UE;
>>>>>>: set the sl-RelayUE-Identity to include the Source L2 ID of the concerned L2 U2N Relay UE;
>>>>>>: set the sl-MeasResult to include the SD-RSRP of the concerned L2 U2N

Relay UE;
>>>>>: for each included L2 U2N Relay UE, include the layer 3 filtered measured results in accordance with the reportConfig for this measId, ordered as follows:
>>>>>>: set the sl-MeasResult to include the quantity(ies) indicated in the reportQuantityRelay within the concerned reportConfigRelay in decreasing order of the sorting quantity, determined 0.3, i.e. the best L2 U2N Relay UE is included first;
>>>>>>: if the UE supports multipathRemoteUE-PC5L2 and idle/inactive relay UE reporting, and if the sl-RelayIndicationMP is contained in the discovery message received from the concerned L2 U2N Relay UE:
>>>>>>>: set the sl-RelayIndicationMP in the sl-MeasResultsCandRelay;
>>>: else:
>>>>: set the measResultNeighCells to include the best neighbouring cells up to maxReportCells in accordance with the following:
>>>>>: if the reportType is set to eventTriggered and eventId is not set to eventD1 or eventD2 or eventH1 or eventH2:
>>>>>>: include the cells included in the cellsTriggeredList as defined within the VarMeasReportList for this measId;
>>>>>: else:
>>>>>>: include the applicable cells for which the new measurement results became available since the last periodical reporting or since the measurement was initiated or reset;
>>>>>: for each cell that is included in the measResultNeighCells, include the physCellId;
>>>>>: if the reportType is set to eventTriggered or periodical:
>>>>>>: for each included cell, include the layer 3 filtered measured results in accordance with the reportConfig for this measId, ordered as follows:
>>>>>>>: if the measObject associated with this measId concerns NR:
>>>>>>>>: if rsType in the associated reportConfig is set to ssb:
>>>>>>: set resultsSSB-Cell within the measResult to include the SS/PBCH block based quantity(ies) indicated in the reportQuantityCell within the concerned reportConfig, in decreasing order of the sorting quantity, determined 0.3, i.e. the best cell is included first;
>>>>>>: if reportQuantityRS-Indexes and maxNrofRS-IndexesToReport are configured, include beam measurement information2; >>>>>>>>: else if rsType in the associated reportConfig is set to csi-rs:
>>>: set resultsCSI-RS-Cell within the measResult to include the CSI-RS based quantity(ies) indicated in the reportQuantityCell within the concerned reportConfig, in decreasing order of the sorting quantity, determined 0.3, i.e. the best cell is included first;
>>>>>>>>>: if reportQuantityRS-Indexes and maxNrofRS-IndexesToReport are configured, include beam measurement information2;
>>>>>>>: if the measObject associated with this measId concerns E-UTRA:
>>>>>>>>: set the measResult to include the quantity(ies) indicated in the reportQuantity within the concerned reportConfigInterRAT in decreasing order of the sorting quantity, determined 0.3, i.e. the best cell is included first;
>>>>>>>>: if the measObject associated with this measId concerns UTRA-FDD and if ReportConfigInterRAT includes the reportQuantityUTRA-FDD:
>>>>: set the measResult to include the quantity(ies) indicated in the reportQuantityUTRA-FDD within the concerned reportConfigInterRAT in decreasing order of the sorting quantity, determined 0.3, i.e. the best cell is included first;
>>: else:
>>>: if the cell indicated by cellForWhichToReportCGI is an NR cell:
>>>>: if plmn-IdentityInfoList of the cgi-Info for the concerned cell has been obtained:
>: include the plmn-IdentityInfoList including plmn-IdentityList, trackingAreaCode (if available), trackingAreaList (if available), ranac (if available), cellIdentity and cellReservedForOperatorUse for each entry of the plmn-IdentityInfoList;
>>>>>: include frequencyBandList if available;
>>>>>: for each PLMN-IdentityInfo in plmn-IdentityInfoList:
>>>>>>: if the gNB-ID-Length is broadcast:
>>>>>>>: include gNB-ID-Length;
>>>>: if nr-CGI-Reporting-NPN is supported by the UE and npn-IdentityInfoList of the cgi-Info for the concerned cell has been obtained:
>>>>>: include the npn-IdentityInfoList including npn-IdentityList, trackingAreaCode, ranac (if available), cellIdentity and cellReservedForOperatorUse for each entry of the npn-IdentityInfoList;
>>>>>: for each NPN-IdentityInfo in NPN-IdentityInfoList:
>>>>>>: if the gNB-ID-Length is broadcast:
>>>>>>>: include gNB-ID-Length;
>>>>>: include cellReservedForOtherUse if available;
>>>>: else if MIB indicates the SIB1 is not broadcast:
>>>>>: include the noSIB1 including the ssb-SubcarrierOffset and pdcch-ConfigSIB1 obtained from MIB of the concerned cell;
>>>: if the cell indicated by cellForWhichToReportCGI is an E-UTRA cell:
>>>>: if all mandatory fields of the cgi-Info-EPC for the concerned cell have been obtained:
>>>>>: include in the cgi-Info-EPC the fields broadcasted in E-UTRA SystemInformationBlockType1 associated to EPC;
>>>>: if the UE is E-UTRA/5GC capable and all mandatory fields of the cgi-Info-5GC for the concerned cell have been obtained:
>>>>>: include in the cgi-Info-5GC the fields broadcasted in E-UTRA SystemInformationBlockType1 associated to 5GC;
>>>>: if the mandatory present fields of the cgi-Info for the cell indicated by the cellForWhichToReportCGI in the associated measObject have been obtained:
>>>>>: include the freqBandIndicator;
>>>>>: if the cell broadcasts the multiBandInfoList, include the multiBandInfoList;
>>>>>: if the cell broadcasts the freqBandIndicatorPriority, include the freqBandIndicatorPriority;
>: if the corresponding measObject concerns NR:
>>: if the reportSFTD-Meas is set to true within the corresponding reportConfigNR for this measId:
>>>: set the measResultSFTD-NR in accordance with the following:
>>>>: set sfn-OffsetResult and frameBoundaryOffsetResult to the measurement results provided by lower layers;
>>>>: if the reportRSRP is set to true;
>>>>>: set rsrp-Result to the RSRP of the NR PSCell derived based on SSB;
>>: else if the reportSFTD-NeighMeas is included within the corresponding reportConfigNR for this measId:
>>>: for each applicable cell which measurement results are available, include an entry in the measResultCellListSFTD-NR and set the contents as follows:
>>>>: set physCellId to the physical cell identity of the concerned NR neighbour cell.
>>>>: set sfn-OffsetResult and frameBoundaryOffsetResult to the measurement results provided by lower layers;
>>>>: if the reportRSRP is set to true:
>>>>>: set rsrp-Result to the RSRP of the concerned cell derived based on SSB;
>: else if the corresponding measObject concerns E-UTRA:
>>: if the reportSFTD-Meas is set to true within the corresponding reportConfigInterRAT for this measId:
>>>: set the measResultSFTD-EUTRA in accordance with the following:
>>>>: set sfn-OffsetResult and frameBoundaryOffsetResult to the measurement results provided by lower layers;
>>>>: if the reportRSRP is set to true;
>>>>>: set rsrpResult-EUTRA to the RSRP of the EUTRA PSCell;
>: if average uplink PDCP delay values are available:
>>: set the ul-PDCP-DelayValueResultList to include the corresponding average uplink PDCP delay values;
>: if PDCP excess delay measurements are available:
>>: set the ul-PDCP-ExcessDelayResultList to include the corresponding PDCP excess delay measurements;
>: if the includeCommonLocationInfo is configured in the corresponding reportConfig for this measId and detailed location information that has not been reported is available, set the content of commonLocationInfo of the locationInfo as follows:
>>: include the locationTimestamp;
>>: include the locationCoordinate, if available;
>>: include the velocityEstimate, if available;
>>: include the locationError, if available;
>>: include the locationSource, if available;
>>: if available, include the gnss-TOD-msec,
>: if the coarseLocationRequest is set to true in the corresponding reportConfig for this measId:
>>: include coarseLocationInfo, if available;
>: if the includeWLAN-Meas is configured in the corresponding reportConfig for this measId, set the wlan-LocationInfo of the locationInfo in the measResults as follows:
>>: if available, include the LogMeasResultWLAN, in order of decreasing RSSI for WLAN APs;
>: if the includeBT-Meas is configured in the corresponding reportConfig for this measId, set the BT-LocationInfo of the locationInfo in the measResults as follows:
>>: if available, include the LogMeasResultBT, in order of decreasing RSSI for Bluetooth beacons;
>: if the includeSensor-Meas is configured in the corresponding reportConfig for this measId, set the sensor-LocationInfo of the locationInfo in the measResults as follows:
>>: if available, include the sensor-MeasurementInformation;
>>: if available, include the sensor-MotionInformation;
>: if the includeAltitudeUE is set to true in the corresponding reportConfig for this measId:
>>: set the altitudeUE to include the altitude of the UE;
>: if there is at least one applicable transmission resource pool for NR sidelink communication/discovery (for measResultsSL):
>>: set the measResultsListSL to include the CBR measurement results in accordance with the following:
>>>: if the reportType is set to eventTriggered:
>>>>: include the transmission resource pools included in the poolsTriggeredList as defined within the VarMeasReportList for this measId;
>>>: else:
>>>>: include the applicable transmission resource pools for which the new measurement results became available since the last periodical reporting or since the measurement was initiated or reset;
>>>: if the corresponding measObject concerns NR sidelink communication/discovery, then for each transmission resource pool to be reported:
>>>>: set the sl-poolReportIdentity to the identity of this transmission resource pool;
>>>>: set the sl-CBR-ResultsNR to the CBR measurement results on PSSCH and PSCCH of this transmission resource pool provided by lower layers, if available; Void.
>: if there is at least one applicable CLI measurement resource to report:
>>: if the reportType is set to cli-EventTriggered or cli-Periodical:
>>>: set the measResultCLI to include the most interfering SRS resources or most interfering CLI-RSSI resources up to maxReportCLI in accordance with the following:
>>>>: if the reportType is set to cli-EventTriggered:
>>>>>: if trigger quantity is set to srs-RSRP i.e. il-Threshold is set to srs-RSRP:
>>>>>>: include the SRS resource included in the cli-TriggeredList as defined within the VarMeasReportList for this measId;
>>>>>: if trigger quantity is set to cli-RSSI i.e. il-Threshold is set to cli-RSSI:
>>>>>>: include the CLI-RSSI resource included in the cli-TriggeredList as defined within the VarMeasReportList for this measId;
>>>>: else:
>>>>>: if reportQuantityCLI is set to srs-rsrp:
>>>>>>: include the applicable SRS resources for which the new measurement results became available since the last periodical reporting or since the measurement was initiated or reset;
>>>>>: else:
>>>>>>: include the applicable CLI-RSSI resources for which the new measurement results became available since the last periodical reporting or since the measurement was initiated or reset;
>>>>: for each SRS resource that is included in the measResultCLI:
>>>>>: include the srs-ResourceId;
>>>>>: set srs-RSRP-Result to include the layer 3 filtered measured results in decreasing order, i.e. the most interfering SRS resource is included first;
>>>>: for each CLI-RSSI resource that is included in the measResultCLI:
>>>>>: include the rssi-ResourceId;
>>>>>: set cli-RSSI-Result to include the layer 3 filtered measured results in decreasing order, i.e. the most interfering CLI-RSSI resource is included first;
>: if there is at least one applicable UE Rx-Tx time difference measurement to report:
>>: set measResultRxTxTimeDiff to the latest measurement result;
>: increment the numberOfReportsSent as defined within the VarMeasReportList for this measId by 1;
>: stop the periodical reporting timer, if running;
>: if the numberOfReportsSent as defined within the VarMeasReportList for this measId is less than the reportAmount as defined within the corresponding reportConfig for this measId:
>>: start the periodical reporting timer with the value of reportInterval as defined within the corresponding reportConfig for this measId;
>: else:
>>: if the reportType is set to periodical or cli-Periodical or rxTxPeriodical:
>>>: remove the entry within the VarMeasReportList for this measId;
>>>: remove this measId from the measIdList within VarMeasConfig;
>: if the measurement reporting was configured by a sl-ConfigDedicatedNR received within the RRCConnectionReconfiguration:
>>: submit the MeasurementReport message to lower layers for transmission via SRB1, embedded in E-UTRA RRC message ULInformationTransferIRAT as specified TS 36.331 [10], clause 5.6.28;
>: else if the UE is in (NG) EN-DC:
>>: if SRB3 is configured and the SCG is not deactivated:
>>>: submit the MeasurementReport message via SRB3 to lower layers for transmission, upon which the procedure ends;
>>: else:
>>>: submit the MeasurementReport message via E-UTRA embedded in E-UTRA RRC message ULInformation TransferMRDC.
>: else if the UE is in NR-DC:
>>: if the measurement configuration that triggered this measurement report is associated with the SCG:
>>>: if SRB3 is configured and the SCG is not deactivated:
>>>>: submit the MeasurementReport message via SRB3 to lower layers for transmission, upon which the procedure ends;
>>>: else:
>>>>: submit the MeasurementReport message via SRB1 embedded in NR RRC message ULInformationTransferMRDC;
>>: else:
>>>: submit the MeasurementReport message via SRB1 to lower layers for transmission, upon which the procedure ends;
>: else:
>>: submit the MeasurementReport message to lower layers for transmission, upon which the procedure ends.

### <Beam Measurement Information>

For beam measurement information to be included in a measurement report the UE shall:

>: if reportType is set to eventTriggered or reportOnScellActivation:
>>: consider the trigger quantity as the sorting quantity if available, otherwise RSRP as sorting quantity if available, otherwise RSRQ as sorting quantity if available, otherwise SINR as sorting quantity;
>: if reportType is set to periodical:
>>: if a single reporting quantity is set to true in reportQuantityRS-Indexes;
>>>: consider the configured single quantity as the sorting quantity;
>>: else:
>>>: if rsrp is set to true;
>>>>: consider RSRP as the sorting quantity;
>>>: else:
>>>>: consider RSRQ as the sorting quantity;
>: set rsIndexResults to include up to maxNrofRS-IndexesToReport SS/PBCH block indexes or CSI-RS indexes in order of decreasing sorting quantity as follows:
>>: if the measurement information to be included is based on SS/PBCH block:
>>>: include within resultsSSB-Indexes the index associated to the best beam for that SS/PBCH block sorting quantity and if absThreshSS-BlocksConsolidation is included in the VarMeasConfig for the measObject associated to the cell for which beams are to be reported, the remaining beams whose sorting quantity is above absThreshSS-BlocksConsolidation;
>>>: if includeBeamMeasurements is set to true, include the SS/PBCH based measurement results for the quantities in reportQuantityRS-Indexes for each SS/PBCH block index;
>>: else if the beam measurement information to be included is based on CSI-RS:
>>>: include within resultsCSI-RS-Indexes the index associated to the best beam for that CSI-RS sorting quantity and, if absThreshCSI-RS-Consolidation is included in the VarMeasConfig for the measObject associated to the cell for which beams are to be reported, the remaining beams whose sorting quantity is above absThreshCSI-RS-Consolidation;
>>>: if includeBeamMeasurements is set to true, include the CSI-RS based measurement results for the quantities in reportQuantityRS-Indexes for each CSI-RS index.

### <Cell Measurement Results>

The UE shall determine the sorting quantity according to parameters of the reportConfig associated with the measId that triggered the reporting:
>: if the reportType is set to eventTriggered:
>>: for an NR cell, consider the quantity used in the aN-Threshold (for eventA1, eventA2, eventA4, eventA4H1 and eventA4H2) or in the a5-Threshold2 (for eventA5, eventA5H1 and eventA5H2) or in the aN-Offset (for eventA3, eventA3H1, eventA3H2 and eventA6) or in the x1-Threshold2 (for eventX1) as the sorting quantity;
>>: for an E-UTRA cell, consider the quantity used in the bN-ThresholdEUTRA as the sorting quantity;
>>: for an UTRA-FDD cell, consider the quantity used in the bN-ThresholdUTRA-FDD as the sorting quantity;
>>: for a candidate L2 U2N Relay UE, consider the y1-Threshold2-Relay (for eventY1-Relay) or y2-Threshold-Relay (for eventY2-Relay) or z1-Threshold2-Relay (for eventZ1) as the sorting quantity;
>: if the reportType is set to periodical:
>>: determine the sorting quantity according to reportQuantityCell for an NR cell, and according to reportQuantity for an E-UTRA cell, as below:
>>>: if a single quantity is set to true:
>>>>: consider this quantity as the sorting quantity;
>>>: else:
>>>>: if rsrp is set to true;
>>>>>: consider RSRP as the sorting quantity;
>>>>: else:
>>>>>: consider RSRQ as the sorting quantity;
>>: determine the sorting quantity according to reportQuantityUTRA-FDD for UTRA-FDD cell, as below:
>>>: if a single quantity is set to true:
>>>>: consider this quantity as the sorting quantity;
>>>: else:
>>>>: consider RSCP as the sorting quantity.
>>: for a candidate L2 U2N Relay UE, consider the reportQuantityRelay as the sorting quantity;

Following terms are used in the disclosure.

AI/ML-enabled Feature: refers to a Feature where AI/ML may be used.

AI/ML Model: A data driven algorithm that applies AI/ML techniques to generate a set of outputs based on a set of inputs.

AI/ML model delivery: A generic term referring to delivery of an AI/ML model from one entity to another entity in any manner. Note: An entity could mean a network node/function (e.g., gNB, LMF, etc.), UE, proprietary server, etc.

AI/ML model Inference: A process of using a trained AI/ML model to produce a set of outputs based on a set of inputs.

AI/ML model testing: A subprocess of training, to evaluate the performance of a final AI/ML model using a dataset different from one used for model training and validation. Differently from AI/ML model validation, testing does not assume subsequent tuning of the model.

AI/ML model training: A process to train an AI/ML Model [by learning the input/output relationship] in a data driven manner and obtain the trained AI/ML Model for inference.

AI/ML model transfer: Delivery of an AI/ML model over the air interface in a manner that is not transparent to 3GPP signalling, either parameters of a model structure known at the receiving end or a new model with parameters. Delivery may contain a full model or a partial model.

AI/ML model validation: A subprocess of training, to evaluate the quality of an AI/ML model using a dataset different from one used for model training, that helps selecting model parameters that generalize beyond the dataset used for model training.

Data collection: A process of collecting data by the network nodes, management entity, or UE for the purpose of AI/ML model training, data analytics and inference.

Functionality identification: A process/method of identifying an AI/ML functionality for the common understanding between the NW and the UE. Note: Information regarding the AI/ML functionality may be shared during functionality identification. Where AI/ML functionality resides depends on the specific use cases and sub use cases.

Model activation: enable an AI/ML model for a specific AI/ML-enabled feature.

Model deactivation: disable an AI/ML model for a specific AI/ML-enabled feature.

Model download: Model transfer from the network to UE.

Model identification: A process/method of identifying an AI/ML model for the common understanding between the NW and the UE. Note: The process/method of model identification may or may not be applicable. Note: Information regarding the AI/ML model may be shared during model identification.

Model monitoring: A procedure that monitors the inference performance of the AI/ML model.

Model parameter update: Process of updating the model parameters of a model.

Model selection: The process of selecting an AI/ML model for activation among multiple models for the same AI/ML enabled feature. Note: Model selection may or may not be carried out simultaneously with model activation.

Model switching: Deactivating a currently active AI/ML model and activating a different AI/ML model for a specific AI/ML-enabled feature.

Model update: Process of updating the model parameters and/or model structure of a model.

Model upload: Model transfer from UE to the network.

Network-side (AI/ML) model: An AI/ML Model whose inference is performed entirely at the network.

Offline field data: The data collected from field and used for offline training of the AI/ML model.

Offline training: An AI/ML training process where the model is trained based on collected dataset, and where the trained model is later used or delivered for inference. Note: This definition only serves as a guidance. There may be cases that may not exactly conform to this definition but could still be categorized as offline training by commonly accepted conventions.

Online field data: The data collected from field and used for online training of the AI/ML model.

Online training: An AI/ML training process where the model being used for inference) is (typically continuously) trained in (near) real-time with the arrival of new training samples. Note: the notion of (near) real-time vs. non real-time is context-dependent and is relative to the inference time-scale. Note: This definition only serves as a guidance. There may be cases that may not exactly conform to this definition but could still be categorized as online training by commonly accepted conventions. Note: Fine-tuning/retraining may be done via online or offline training.

Reinforcement Learning (RL): A process of training an AI/ML model from input (a.k.a. state) and a feedback signal (a.k.a. reward) resulting from the model's output (a.k.a. action) in an environment the model is interacting with.

Semi-supervised learning: A process of training a model with a mix of labelled data and unlabelled data.

Supervised learning: A process of training a model from input and its corresponding labels.

Test encoder/decoder for TE: AI/ML model for UE encoder/gNB decoder implemented by TE.

Two-sided (AI/ML) model: A paired AI/ML Model(s) over which joint inference is performed, where joint inference includes AI/ML Inference whose inference is performed jointly across the UE and the network, i.e, the first part of inference is firstly performed by UE and then the remaining part is performed by gNB, or vice versa.

UE-side (AI/ML) model: An AI/ML Model whose inference is performed entirely at the UE.

Unsupervised learning: A process of training a model without labelled data.

The MeasurementReport message is used for the indication of measurement results.

```
  -- ASN1START
  -- TAG-MEASUREMENTREPORT-START
```

| | |
|---|---|
| MeasurementReport ::= | SEQUENCE { |
| criticalExtensions | CHOICE { |
| measurementReport | MeasurementReport-IEs, |
| criticalExtensionsFuture | SEQUENCE { } |

```
    }
  }
```

| | |
|---|---|
| MeasurementReport-IEs ::= | SEQUENCE { |
| measResults | MeasResults, |
| lateNonCriticalExtension | OCTET STRING |

OPTIONAL,

| | |
|---|---|
| nonCriticalExtension | SEQUENCE{ } |

```
OPTIONAL
  }
  -- TAG-MEASUREMENTREPORT-STOP
  -- ASN1STOP
```

The RRCReconfiguration message is the command to modify an RRC connection. It may convey information for measurement configuration, mobility control, radio resource configuration (including RBs, MAC main configuration and physical channel configuration) and AS security configuration.

```
  -- ASN1START
  -- TAG-RRCRECONFIGURATION-START
```

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-IEs, |
| criticalExtensionsFuture | SEQUENCE { } |

```
    }
  }
```

| | |
|---|---|
| RRCReconfiguration-IEs ::= | SEQUENCE { |
| radioBearerConfig | RadioBearerConfig |

OPTIONAL, -- Need M

| | |
|---|---|
| secondaryCellGroup | OCTET STRING (CONTAINING |
| CellGroupConfig) | OPTIONAL, -- Cond SCG |
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530-IEs |

```
OPTIONAL
  }
  ...
  -- TAG-RRCRECONFIGURATION-STOP
  -- ASN1STOP
```

The IE MeasConfig specifies measurements to be performed by the UE, and covers intra-frequency, inter-frequency and inter-RAT mobility as well as configuration of measurement gaps.

```
  -- ASN1START
  -- TAG-MEASCONFIG-START
```

| | |
|---|---|
| MeasConfig ::= | SEQUENCE { |

| | |
|---|---|
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList | MeasIdToRemoveList |

OPTIONAL, -- Need N

| | |
|---|---|
| measIdToAddModList | MeasIdToAddModList |

OPTIONAL, -- Need N

| | |
|---|---|
| s-MeasureConfig | CHOICE { |
| ssb-RSRP | RSRP-Range, |
| csi-RSRP | RSRP-Range |

}
OPTIONAL, -- Need M

| | |
|---|---|
| quantityConfig | QuantityConfig |

OPTIONAL, -- Need M

| | |
|---|---|
| measGapConfig | MeasGapConfig |

OPTIONAL, -- Need M

| | |
|---|---|
| measGapSharingConfig | MeasGapSharingConfig |

```
OPTIONAL, -- Need M
    ...,
    [[
```

| | |
|---|---|
| interFrequencyConfig-NoGap-r16 | ENUMERATED {true} |

```
OPTIONAL -- Need R
    ]],
    [[
```

| | |
|---|---|
| effectiveMeasWindowConfig-r18 | SetupRelease {MeasWindowConfig- |

| | |
|---|---|
| r18} | OPTIONAL -- Need M |

```
    ]]
  }
```

| | |
|---|---|
| MeasObjectToRemoveList ::= | SEQUENCE (SIZE |

(1..maxNrofObjectId)) OF MeasObjectId

| | |
|---|---|
| MeasIdToRemoveList ::= | SEQUENCE (SIZE |

(1..maxNrofMeasId)) OF MeasId

| | |
|---|---|
| ReportConfigToRemoveList ::= | SEQUENCE (SIZE |

```
(1..maxReportConfigId)) OF ReportConfigId
  -- TAG-MEASCONFIG-STOP
  -- ASN1STOP
```

s-MeasureConfig: Threshold for NR SpCell RSRP measurement controlling when the UE is required to perform measurements on non-serving cells. Choice of ssb-RSRP corresponds to cell RSRP based on SS/PBCH block and choice of csi-RSRP corresponds to cell RSRP of CSI-RS.

The IE MeasId is used to identify a measurement configuration, i.e., linking of a measurement object and a reporting configuration.

| -- ASN1START | |
|---|---|
| -- TAG-MEASID-START | |
| MeasId ::= | INTEGER (1..maxNrofMeasId) |

-- TAG-MEASID-STOP
-- ASN1STOP

The IE MeasIdToAddModList concerns a list of measurement identities to add or modify, with for each entry the measId, the associated measObjectId and the associated reportConfigId.

```
  -- ASN1START
  -- TAG-MEASIDTOADDMODLIST-START
```

| | |
|---|---|
| MeasIdToAddModList ::= | SEQUENCE (SIZE (1..maxNrofMeasId)) |

OF MeasIdToAddMod

| | |
|---|---|
| MeasIdToAddMod ::= | SEQUENCE { |
| measId | MeasId, |
| measObjectId | MeasObjectId, |
| reportConfigId | ReportConfigId |

```
  }
  -- TAG-MEASIDTOADDMODLIST-STOP
  -- ASN1STOP
```

The IE MeasObjectId used to identify a measurement object configuration.

| -- ASN1START | |
|---|---|
| -- TAG-MEASOBJECTID-START | |
| MeasObjectId ::= | INTEGER (1..maxNrofObjectId) |

-- TAG-MEASOBJECTID-STOP
-- ASN1STOP

The IE MeasObjectNR specifies information applicable for SS/PBCH block(s) intra/inter-frequency measurements and/or CSI-RS intra/inter-frequency measurements.

```
  -- ASN1START
  -- TAG-MEASOBJECTNR-START
```

| | |
|---|---|
| MeasObjectNR ::= | SEQUENCE { |

| | |
|---|---|
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | ReferenceSignalConfig, |

| | |
|---|---|
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS- |

| | |
|---|---|
| BlocksToAverage) | OPTIONAL, -- Need R |

| | |
|---|---|
| nrofCSI-RS-ResourcesToAverage | INTEGER (2..maxNrofCSI-RS- |

| | |
|---|---|
| ResourcesToAverage) | OPTIONAL, -- Need R |
| quantityConfigIndex | INTEGER (1..maxNrofQuantityConfig), |
| offsetMO | Q-OffsetRangeList, |

| | |
|---|---|
| cellsToRemoveList | PCI-List |

OPTIONAL, -- Need N

| | |
|---|---|
| cellsToAddModList | CellsToAddModList |

OPTIONAL, -- Need N

| | |
|---|---|
| excludedCellsToRemoveList | PCI-RangeIndexList |

OPTIONAL, -- Need N

| | |
|---|---|
| excludedCellsToAddModList | SEQUENCE (SIZE (1..maxNrofPCI- |

Ranges)) OF PCI-RangeElement OPTIONAL, -- Need N

| | |
|---|---|
| allowedCellsToRemoveList | PCI-RangeIndexList |

OPTIONAL, -- Need N

| | |
|---|---|
| allowedCellsToAddModList | SEQUENCE (SIZE (1..maxNrofPCI- |

| | |
|---|---|
| Ranges)) OF PCI-RangeElement | OPTIONAL, -- Need N |

```
    ...,
    [[
```

| | |
|---|---|
| freqBandIndicatorNR | FreqBandIndicatorNR |

OPTIONAL, -- Need R

| | |
|---|---|
| measCycleSCell | ENUMERATED {sf160, sf256, sf320, |

```
sf512, sf640, sf1024, sf1280} OPTIONAL -- Need R
    ]],
    [[
```

| | |
|---|---|
| smtc3list-r16 | SSB-MTC3List-r16 |

OPTIONAL, -- Need R

| | |
|---|---|
| rmtc-Config-r16 | SetupRelease {RMTC-Config-r16} |

OPTIONAL, -- Need M

| | |
|---|---|
| t312-r16 | SetupRelease { T312-r16 } |

```
OPTIONAL -- Need M
    ]],
    [[
```

| | |
|---|---|
| associatedMeasGapSSB-r17 | MeasGapId-r17 |

OPTIONAL, -- Need R

| | |
|---|---|
| associatedMeasGapCSIRS-r17 | MeasGapId-r17 |

OPTIONAL, -- Need R

| | |
|---|---|
| smtc4list-r17 | SSB-MTC4List-r17 |

OPTIONAL, -- Need R

| | |
|---|---|
| measCyclePSCell-r17 | ENUMERATED {ms160, ms256, |

ms320, ms512, ms640, ms1024, ms1280, spare1}
OPTIONAL, -- Cond SCG

| | |
|---|---|
| cellsToAddModListExt-v1710 | CellsToAddModListExt-v1710 |

```
OPTIONAL -- Need N
    ]],
    [[
```

| | |
|---|---|
| associatedMeasGapSSB2-v1720 | MeasGapId-r17 |

OPTIONAL, -- Cond AssociatedGapSSB

| | |
|---|---|
| associatedMeasGapCSIRS2-v1720 | MeasGapId-r17 |

```
OPTIONAL -- Cond AssociatedGapCSIRS
    ]],
    [[
```

| | |
|---|---|
| measSequence-r18 | MeasSequence-r18 |

OPTIONAL, -- Need R

| | |
|---|---|
| cellsToAddModListExt-v1800 | CellsToAddModListExt-v1800 |

```
OPTIONAL -- Cond NeighbourCell
    ]]
  }
```

| | |
|---|---|
| SSB-MTC3List-r16::= | SEQUENCE (SIZE(1..4)) OF SSB-MTC3- |

r16

| | |
|---|---|
| SSB-MTC4List-r17::= | SEQUENCE (SIZE(1..3)) OF SSB-MTC4- |

r17

| | |
|---|---|
| T312-r16 ::= | ENUMERATED { ms0, ms50, ms100, ms200, |

ms300, ms400, ms500, ms1000}

| | |
|---|---|
| ReferenceSignalConfig::= | SEQUENCE { |

| | |
|---|---|
| ssb-ConfigMobility | SSB-ConfigMobility |

OPTIONAL, -- Need M

| | |
|---|---|
| csi-rs-ResourceConfigMobility | SetupRelease { CSI-RS- |

| | |
|---|---|
| ResourceConfigMobility } | OPTIONAL -- Need M |

}

| | |
|---|---|
| SSB-ConfigMobility ::= | SEQUENCE { |

| | |
|---|---|
| ssb-ToMeasure | SetupRelease { SSB-ToMeasure } |

OPTIONAL, -- Need M

| | |
|---|---|
| deriveSSB-IndexFromCell | BOOLEAN, |

| | |
|---|---|
| ss-RSSI-Measurement | SS-RSSI-Measurement |

```
OPTIONAL, -- Need M
    ...,
    [[
```

| | |
|---|---|
| ssb-PositionQCL-Common-r16 | SSB-PositionQCL-Relation-r16 |

OPTIONAL, -- Cond SharedSpectrum

| | |
|---|---|
| ssb-PositionQCL-CellsToAddModList-r16 | SSB-PositionQCL- |

| | |
|---|---|
| CellsToAddModList-r16 | OPTIONAL, -- Need N |

| | |
|---|---|
| ssb-PositionQCL-CellsToRemoveList-r16 | PCI-List |

```
OPTIONAL -- Need N
    ]],
    [[
```

| | |
|---|---|
| deriveSSB-IndexFromCellInter-r17 | ServCellIndex |

OPTIONAL, -- Need R

| | |
|---|---|
| ssb-PositionQCL-Common-r17 | SSB-PositionQCL-Relation-r17 |

OPTIONAL, -- Cond SharedSpectrum2

| | |
|---|---|
| ssb-PositionQCL-Cells-r17 | SetupRelease {SSB-PositionQCL- |

| | |
|---|---|
| CellList-r17} | OPTIONAL -- Need M |

```
    ]],
    [[
```

| | |
|---|---|
| cca-CellsToAddModList-r17 | PCI-List |

OPTIONAL, -- Need N

| | |
|---|---|
| cca-CellsToRemoveList-r17 | PCI-List |

```
OPTIONAL -- Need N
    ]],
    [[
```

| | |
|---|---|
| ssb-ToMeasureAltitudeBasedList-r18 | SetupRelease { SSB- |

| | |
|---|---|
| ToMeasureAltitudeBasedList-r18 } | OPTIONAL -- Need M |

```
    ]]
  }
```

| | |
|---|---|
| Q-OffsetRangeList ::= | SEQUENCE { |

| | |
|---|---|
| rsrpOffsetSSB | Q-OffsetRange |

DEFAULT dB0,

| | |
|---|---|
| rsrqOffsetSSB | Q-OffsetRange |

DEFAULT dB0,

| | |
|---|---|
| sinrOffsetSSB | Q-OffsetRange |

DEFAULT dB0,

| | |
|---|---|
| rsrpOffsetCSI-RS | Q-OffsetRange |

DEFAULT dB0,

| | |
|---|---|
| rsrqOffsetCSI-RS | Q-OffsetRange |

DEFAULT dB0,

| | |
|---|---|
| sinrOffsetCSI-RS | Q-OffsetRange |

DEFAULT dB0
}

| | |
|---|---|
| ThresholdNR ::= | SEQUENCE{ |

| | |
|---|---|
| thresholdRSRP | RSRP-Range |

OPTIONAL, -- Need R

| | |
|---|---|
| thresholdRSRQ | RSRQ-Range |

OPTIONAL, -- Need R

| | |
|---|---|
| thresholdSINR | SINR-Range |

OPTIONAL -- Need R
}

| | |
|---|---|
| CellsToAddModList ::= | SEQUENCE (SIZE (1..maxNrofCellMeas)) |

OF CellsToAddMod

| | |
|---|---|
| CellsToAddModListExt-v1710 ::= | SEQUENCE (SIZE |

(1..maxNrofCellMeas)) OF CellsToAddModExt-v1710

| | |
|---|---|
| CellsToAddModListExt-v1800 ::= | SEQUENCE (SIZE |

(1..maxNrofCellMeas)) OF CellsToAddModExt-v1800

| | |
|---|---|
| CellsToAddMod ::= | SEQUENCE { |
| physCellId | PhysCellId, |
| cellIndividualOffset | Q-OffsetRangeList |

}

| | |
|---|---|
| CellsToAddModExt-v1710 ::= | SEQUENCE { |

| | |
|---|---|
| ntn-PolarizationDL-r17 | ENUMERATED {rhcp,lhcp,linear} |

OPTIONAL, -- Need R

| | |
|---|---|
| ntn-PolarizationUL-r17 | ENUMERATED {rhcp,lhcp,linear} |

OPTIONAL -- Need R
}

| | |
|---|---|
| CellsToAddModExt-v1800 ::= | SEQUENCE { |

| | |
|---|---|
| ntn-NeighbourCellInfo-r18 | NTN-NeighbourCellInfo-r18 |

OPTIONAL -- Need R
}

| | |
|---|---|
| RMTC-Config-r16 ::= | SEQUENCE { |

| | |
|---|---|
| rmtc-Periodicity-r16 | ENUMERATED {ms40, ms80, ms160, |

ms320, ms640},

| | |
|---|---|
| rmtc-SubframeOffset-r16 | INTEGER(0..639) |

OPTIONAL, -- Need M

| | |
|---|---|
| measDurationSymbols-r16 | ENUMERATED {sym1, sym14or12, |

sym28or24, sym42or36, sym70or60},

| | |
|---|---|
| rmtc-Frequency-r16 | ARFCN-ValueNR, |

| | |
|---|---|
| ref-SCS-CP-r16 | ENUMERATED {kHz15, kHz30, |

```
kHz60-NCP, kHz60-ECP},
    ...,
    [[
```

| | |
|---|---|
| rmtc-Bandwidth-r17 | ENUMERATED {mhz100, mhz400, |

| | |
|---|---|
| mhz800, mhz1600, mhz2000} | OPTIONAL, -- Need R |

| | |
|---|---|
| measDurationSymbols-v1700 | ENUMERATED {sym140, sym560, |

| | |
|---|---|
| sym1120} | OPTIONAL, -- Need R |

| | |
|---|---|
| ref-SCS-CP-v1700 | ENUMERATED {kHz120, kHz480, |

| | |
|---|---|
| kHz960} | OPTIONAL, -- Need R |
| tci-StateInfo-r17 | SEQUENCE { |
| tci-StateId-r17 | TCI-StateId, |

| | |
|---|---|
| ref-ServCellId-r17 | ServCellIndex |

```
OPTIONAL -- Need R
    } OPTIONAL -- Need R
    ]],
    [[
```

| | |
|---|---|
| ref-BWPId-r17 | BWP-Id |

```
OPTIONAL -- Need R
    ]]
  }
  SSB-PositionQCL-CellsToAddModList-r16 ::= SEQUENCE (SIZE
(1..maxNrofCellMeas)) OF SSB-PositionQCL-CellsToAddMod-r16
  SSB-PositionQCL-CellsToAddMod-r16 ::= SEQUENCE {
```

| | |
|---|---|
| physCellId-r16 | PhysCellId, |
| ssb-PositionQCL-r16 | SSB-PositionQCL-Relation-r16 |

```
  }
  SSB-PositionQCL-CellList-r17 ::= SEQUENCE (SIZE (1..maxNrofCellMeas)) OF
SSB-PositionQCL-Cell-r17
```

| | |
|---|---|
| SSB-PositionQCL-Cell-r17 | ::= SEQUENCE { |
| physCellId-r17 | PhysCellId, |
| ssb-PositionQCL-r17 | SSB-PositionQCL-Relation-r17 |

```
  }
  SSB-ToMeasureAltitudeBasedList-r18 ::= SEQUENCE (SIZE
(1..maxNrofAltitudeRanges-r18)) OF SSB-ToMeasureAltitudeBased-r18
```

| | |
|---|---|
| SSB-ToMeasureAltitudeBased-r18 ::= | SEQUENCE { |
| altitudeRange-r18 | SEQUENCE { |

| | |
|---|---|
| altitudeMin-r18 | Altitude-r18 |

OPTIONAL, -- Need S

| | |
|---|---|
| altitudeMax-r18 | Altitude-r18 |

OPTIONAL, -- Need S

| | |
|---|---|
| altitudeHyst-r18 | HysteresisAltitude-r18 |

OPTIONAL -- Need R
},

| | |
|---|---|
| ssb-ToMeasure-r18 | SSB-ToMeasure |

OPTIONAL -- Need S
}

| | |
|---|---|
| NTN-NeighbourCellInfo-r18 ::= | SEQUENCE { |
| epochTime-r18 | EpochTime-r17, |
| ephemerisInfo-r18 | EphemerisInfo-r17 |

```
  }
  -- TAG-MEASOBJECTNR-STOP
  -- ASN1STOP
```

cellIndividualOffset: Cell individual offsets applicable to a specific cell.

physCellId: Physical cell identity of a cell in the cell list.

absThreshCSI-RS-Consolidation: Absolute threshold for the consolidation of measurement results per CSI-RS resource(s) from L1 filter(s). The field is used for the derivation of cell measurement results and the reporting of beam measurement information per CSI-RS resource.

absThreshSS-BlocksConsolidation: Absolute threshold for the consolidation of measurement results per SS/PBCH block(s) from L1 filter(s). The field is used for the derivation of cell measurement results and the reporting of beam measurement information per SS/PBCH block index2.

allowedCellsToAddModList: List of cells to add/modify in the allow-list of cells. It applies only to SSB resources.

allowedCellsToRemoveList: List of cells to remove from the allow-list of cells.

associatedMeasGapSSB: Indicates the associated measurement gap for SSB measuring identified by ssb-ConfigMobility in this measurement object. When multiple MeasObjectNR with the same SSB frequency are configured, the network configures the same measurement gap ID in this field for each MeasObjectNR. If this field is absent, the associated measurement gap is the gap configured via gapFR1, gapFR2, or gapUE.

associatedMeasGapCSIRS: Indicates the associated measurement gap for CSI-RS measuring identified by csi-rs-ResourceConfigMobility in this measurement object. If this field is absent, the associated measurement gap is the gap configured via gapFR1, gapFR2, or gapUE.

cellsToAddModList: List of cells to add/modify in the cell list.

cellsToRemoveList: List of cells to remove from the cell list.

excludedCellsToAddModList: List of cells to add/modify in the exclude-list of cells. It applies only to SSB resources.

excludedCellsToRemoveList: List of cells to remove from the exclude-list of cells.

freqBandIndicatorNR: The frequency band in which the SSB and/or CSI-RS indicated in this MeasObjectNR are located and according to which the UE shall perform the RRM measurements. This field is always provided when the network configures measurements with this MeasObjectNR.

measCyclePSCell: The parameter is used only when the PSCell is configured on the frequency indicated by the measObjectNR and the SCG is deactivated. The field may also be configured when the PSCell is not configured on that frequency. The network always configures measCyclePSCell for the measObjectNR associated with the PSCell if bfd-and-RLM is set to true and the SCG is deactivated. Value ms160 corresponds to 160 ms, value ms256 corresponds to 256 ms and so on.

nrofCSInrofCSI-RS-ResourcesToAverage: Indicates the maximum number of measurement results per beam based on CSI-RS resources to be averaged. The same value applies for each detected cell associated with this MeasObjectNR.

nrofSS-BlocksToAverage: Indicates the maximum number of measurement results per beam based on SS/PBCH blocks to be averaged. The same value applies for each detected cell associated with this MeasObject.

offsetMO: Offset values applicable to all measured cells with reference signal(s) indicated in this MeasObjectNR.

quantityConfigIndex: Indicates the n-th element of quantityConfigNR-List provided in MeasConfig.

referenceSignalConfig: RS configuration for SS/PBCH block and CSI-RS.

refFreqCSI-RS: Point A which is used for mapping of CSI-RS to physical resources.

smtc1: Primary measurement timing configuration.

smtc2: Secondary measurement timing configuration for SS corresponding to this MeasObjectNR with PCI listed in pci-List. For these SS, the periodicity is indicated by periodicity in smtc2 and the timing offset is equal to the offset indicated in periodicityAndOffset modulo periodicity. periodicity in smtc2 can only be set to a value strictly shorter than the periodicity indicated by periodicityAndOffset in smtc1 (e.g. if periodicityAndOffset indicates sf10, periodicity can only be set of sf5, if periodicityAndOffset indicates sf5, smtc2 cannot be configured).

smtc3list: Measurement timing configuration list for SS corresponding to IAB-MT. This is used for the IAB-node's discovery of other IAB-nodes and the IAB-Donor-DUs.

smtc4list: Measurement timing configuration list for NTN deployments.

ssbFrequency: Indicates the frequency of the SS associated to this MeasObjectNR. For operation with shared spectrum channel access, this field is a k*30 kHz shift from the sync raster where k=0,1,2, and so on if the reportType within the corresponding ReportConfigNR is set to reportCGI. Frequencies are considered to be on the sync raster if they are also identifiable with a GSCN value.

ssb-PositionQCL-Common: Indicates the QCL relationship between SS/PBCH blocks for all measured cells.

ssbSubcarrierSpacing: Subcarrier spacing of SSB.

t312: The value of timer T312. Value ms0 represents 0 ms, ms50 represents 50 ms and so on.

csi-rs-ResourceConfigMobility: CSI-RS resources to be used for CSI-RS based RRM measurements.

ssb-ConfigMobility: SSB configuration for mobility (nominal SSBs, timing configuration).

measDurationSymbols: Number of consecutive symbols for which the Physical Layer reports samples of RSSI. Value sym1 corresponds to one symbol, sym14or12 corresponds to 14 symbols of the reference numerology for NCP and 12 symbols for ECP, and so on.

ref-BWPId: Indicates the reference BWP for the TCI state indicated in tci-StateInfo. Network includes this field if tci-StateInfo is present. This field is only applicable for operation with shared spectrum channel access in FR2-2 and network does not configure this if the UE does not have any serving cells in FR2-2.

ref-SCS-CP: Indicates a reference subcarrier spacing and cyclic prefix to be used for RSSI measurements. Value kHz15 corresponds to 15 kHz, kHz30 corresponds to 30 kHz, value kHz60-NCP corresponds to 60 kHz using normal cyclic prefix (NCP), and kHz60-ECP corresponds to 60 kHz using extended cyclic prefix (ECP).

ref-ServCellId: Indicates the FR2-2 reference serving cell index for the TCI state. Network includes this field if tci-StateInfo is present. This field is only applicable for operation with shared spectrum channel access in FR2-2 and network does not configure this if the UE does not have any serving cells in FR2-2.

rmtc-Bandwidth: Indicates the bandwidth for the RSSI measurement.

rmtc-Frequency: Indicates the center frequency of the measured bandwidth for a frequency which operates with shared spectrum channel access.

rmtc-Periodicity: Indicates the RSSI measurement timing configuration (RMTC) periodicity.

rmtc-SubframeOffset: Indicates the RSSI measurement timing configuration (RMTC) subframe offset for this frequency. For inter-frequency measurements, this field is optional present and if it is not configured, the UE chooses a random value as rmtc-SubframeOffset for measDurationSymbols which shall be selected to be between 0 and the configured rmtc-Periodicity with equal probability.

tci-StateId: Indicates the TCI state to be used for RSSI measurements. This field is only applicable for shared spectrum channel access in FR2-2. Network does not configure this if the UE does not have any serving cells in FR2-2 and in such a case, it is up to UE implementation how to determine the spatial domain filter for the inter-frequency RSSI measurement in FR2-2.

deriveSSB-IndexFromCell: If this field is set to true, UE assumes SFN and frame boundary alignment across cells on the same. Hence, if the UE is configured with a serving cell for which (absoluteFrequencySSB, subcarrierSpacing) in ServingCellConfigCommon is equal to (ssbFrequency, ssbSubcarrierSpacing) in this MeasObjectNR, this field indicates whether the UE can utilize the timing of this serving cell to derive the index of SS block transmitted by neighbour cell. Otherwise, this field indicates whether the UE may use the timing of any detected cell on that target frequency to derive the SSB index of all neighbour cells on that frequency.

ssb-ToMeasure: The set of SS blocks to be measured within the SMTC measurement duration. The first/leftmost bit corresponds to SS/PBCH block index 0, the second bit corresponds to SS/PBCH block index 1, and so on. Value 0 in the bitmap indicates that the corresponding SS/PBCH block is not to be measured while value 1 indicates that the corresponding SS/PBCH block is to be measured. When the field is not configured the UE measures on all SS blocks. Regardless of the value of this field, SS/PBCH blocks outside of the applicable smtc are not to be measured.

physCellId: Physical cell identity of a cell in the cell list.

ssb-PositionQCL: Indicates the QCL relation between SS/PBCH blocks for a specific cell. If provided, the cell specific value overwrites the value signalled by ssb-PositionQCL-Common.

The IE MeasObjectToAddModList concerns a list of measurement objects to add or modify.

```
  -- ASN1START
  -- TAG-MEASOBJECTTOADDMODLIST-START
```

| | |
|---|---|
| MeasObjectToAddModList ::= | SEQUENCE (SIZE |

(1..maxNrofObjectId)) OF MeasObjectToAddMod

| | |
|---|---|
| MeasObjectToAddMod ::= | SEQUENCE { |
| measObjectId | MeasObjectId, |
| measObject | CHOICE { |
| measObjectNR | MeasObjectNR, |

...,

| | |
|---|---|
| measObjectEUTRA | MeasObjectEUTRA, |
| measObjectUTRA-FDD-r16 | MeasObjectUTRA- |

FDD-r16,

| | |
|---|---|
| measObjectNR-SL-r16 | MeasObjectNR-SL-r16, |
| measObjectCLI-r16 | MeasObjectCLI-r16, |
| measObjectRxTxDiff-r17 | MeasObjectRxTxDiff-r17, |
| measObjectRelay-r17 | SL-MeasObject-r16, |
| measObjectNR-SL-r18 | MeasObjectNR-SL-r18 |

```
    }
  }
  -- TAG-MEASOBJECTTOADDMODLIST-STOP
  -- ASN1STOP
```

The IE MeasResults covers measured results for intra-frequency, inter-frequency, inter-RAT mobility and measured results for NR sidelink communication/discovery.

```
  -- ASN1START
  -- TAG-MEASRESULTS-START
```

| | |
|---|---|
| MeasResults ::= | SEQUENCE { |
| measId | MeasId, |
| measResultServingMOList | MeasResultServMOList |
| measResultNeighCells | CHOICE { |
| measResultListNR | MeasResultListNR, |

...,

| | |
|---|---|
| measResultListEUTRA | MeasResultListEUTRA, |

| | |
|---|---|
| measResultListUTRA-FDD-r16 | MeasResultListUTRA- |

FDD-r16,

| | |
|---|---|
| sl-MeasResultsCandRelay-r17 | OCTET STRING -- |

```
Contains PC5 SL-MeasResultListRelay-r17
    }
OPTIONAL,
    ...,
    [[
    measResultServFreqListEUTRA-SCG
MeasResultServFreqListEUTRA-SCG
OPTIONAL,
```

| | |
|---|---|
| measResultServFreqListNR-SCG | MeasResultServFreqListNR- |

| | |
|---|---|
| SCG | OPTIONAL, |

| | |
|---|---|
| measResultSFTD-EUTRA | MeasResultSFTD-EUTRA |

OPTIONAL,

| | |
|---|---|
| measResultSFTD-NR | MeasResultCellSFTD-NR |

```
OPTIONAL
      ]],
      [[
```

| | |
|---|---|
| measResultCellListSFTD-NR | MeasResultCellListSFTD-NR |

```
OPTIONAL
    ]],
    [[
```

| | |
|---|---|
| measResultForRSSI-r16 | MeasResultForRSSI-r16 |

OPTIONAL,

| | |
|---|---|
| locationInfo-r16 | LocationInfo-r16 |

OPTIONAL,

| | |
|---|---|
| ul-FDCP-DelayValueResultList-r16 | UL-PDCP-DelayValueResultList- |

| | |
|---|---|
| r16 | OPTIONAL, |

| | |
|---|---|
| measResultsSL-r16 | MeasResultsSL-r16 |

OPTIONAL,

| | |
|---|---|
| measResultCLI-r16 | MeasResultCLI-r16 |

```
OPTIONAL
    ]],
    [[
```

| | |
|---|---|
| measResultRxTxTimeDiff-r17 | MeasResultRxTxTimeDiff-r17 |

OPTIONAL,

| | |
|---|---|
| sl-MeasResultServingRelay-r17 | OCTET STRING |

OPTIONAL,
-- Contains PC5 SL-MeasResultRelay-r17

| | |
|---|---|
| ul-PDCP-ExcessDelayResultList-r17 | UL-PDCP- |

| | |
|---|---|
| ExcessDelayResultList-r17 | OPTIONAL, |

| | |
|---|---|
| coarseLocationInfo-r17 | OCTET STRING |

```
OPTIONAL
    ]],
      [[
```

| | |
|---|---|
| altitudeUE-r18 | Altitude-r18 |

```
OPTIONAL
      ]]
  }
```

| | |
|---|---|
| MeasResultServMOList ::= | SEQUENCE (SIZE |

(1..maxNrofServingCells)) OF MeasResultServMO

| | |
|---|---|
| MeasResultServMO ::= | SEQUENCE { |
| servCellId | ServCellIndex, |
| measResultServingCell | MeasResultNR, |

| | |
|---|---|
| measResultBestNeighCell | MeasResultNR |

```
OPTIONAL,
    ...
  }
```

| | |
|---|---|
| MeasResultListNR ::= | SEQUENCE (SIZE (1..maxCellReport)) |

OF MeasResultNR

| | |
|---|---|
| MeasResultNR ::= | SEQUENCE { |

| | |
|---|---|
| physCellID | PhysCellId |

OPTIONAL,

| | |
|---|---|
| measResult | SEQUENCE { |
| cellResults | SEQUENCE{ |

| | |
|---|---|
| resultsSSB-Cell | MeasQuantityResults |

OPTIONAL,

| | |
|---|---|
| resultsCSI-RS-Cell | MeasQuantityResults |

OPTIONAL
},

| | |
|---|---|
| rsIndexResults | SEQUENCE{ |

| | |
|---|---|
| resultsSSB-Indexes | ResultsPerSSB-IndexList |

OPTIONAL,

| | |
|---|---|
| resultsCSI-RS-Indexes | ResultsPerCSI-RS-IndexList |

```
OPTIONAL
        }
OPTIONAL
    },
    ...,
    [[
```

| | |
|---|---|
| cgi-Info | CGI-InfoNR |

```
OPTIONAL
    ]],
    [[
```

| | |
|---|---|
| choCandidate-r17 | ENUMERATED {true} |

OPTIONAL,

| | |
|---|---|
| choConfig-r17 | SEQUENCE (SIZE (1..2)) OF |

| | |
|---|---|
| CondTriggerConfig-r16 | OPTIONAL, |
| triggeredEvent-r17 | SEQUENCE { |

| | |
|---|---|
| timeBetweenEvents-r17 | TimeBetweenEvent-r17 |

OPTIONAL,

| | |
|---|---|
| fistTriggeredEvent-r17 | ENUMERATED |

| | |
|---|---|
| {condFirstEvent, condSecondEvent} | OPTIONAL |

```
        }
OPTIONAL
    ]]
  }
```

| | |
|---|---|
| MeasResultListEUTRA ::= | SEQUENCE (SIZE |

(1..maxCellReport)) OF MeasResultEUTRA

| | |
|---|---|
| MeasResultEUTRA ::= | SEQUENCE { |
| eutra-PhysCellID | PhysCellId, |
| measResult | MeasQuantityResultsEUTRA, |

| | |
|---|---|
| cgi-Info | CGI-InfoEUTRA |

```
OPTIONAL,
    ...
  }
```

| | |
|---|---|
| MultiBandInfoListEUTRA ::= | SEQUENCE (SIZE |

(1..maxMultiBands)) OF FreqBandIndicaorEUTRA

| | |
|---|---|
| MeasQuantityResults ::= | SEQUENCE { |

| | |
|---|---|
| rsrp | RSRP-Range |

OPTIONAL,

| | |
|---|---|
| rsrq | RSRQ-Range |

OPTIONAL,

| | |
|---|---|
| sinr | SINR-Range |

OPTIONAL
}

| | |
|---|---|
| MeasQuantityResultsEUTRA ::= | SEQUENCE { |

| | |
|---|---|
| rsrp | RSRP-RangeEUTRA |

OPTIONAL,

| | |
|---|---|
| rsrq | RSRQ-RangeEUTRA |

OPTIONAL,

| | |
|---|---|
| sinr | SINR-RangeEUTRA |

OPTIONAL
}

| | |
|---|---|
| ResultsPerSSB-IndexList::= | SEQUENCE (SIZE |

(1..maxNrofIndexedToReport2)) OF ResultsPerSSB-Index

| | |
|---|---|
| ResultsPerSSB-Index ::= | SEQUENCE { |
| ssb-Index | SSB-Index, |

| | |
|---|---|
| ssb-Results | MeasQuantityResults |

OPTIONAL
}

| | |
|---|---|
| ResultsPerCSI-RS-IndexList::= | SEQUENCE (SIZE |

(1..maxNrofIndexedToReport2)) OF ResultsPerCSI-RS-Index

| | |
|---|---|
| ResultsPerCSI-RS-Index ::= | SEQUENCE { |
| csi-RS-Index | CSI-RS-Index, |

| | |
|---|---|
| csi-RS-Results | MEASQuantityResults |

```
OPTIONAL
  }
  MeasResultServFreqListEUTRA-SCG ::= SEQUENCE (SIZE
(1..maxNrofServingCellsEUTRA)) OF MeasResult2EUTRA
  MeasResultServFreqListNR-SCG ::= SEQUENCE (SIZE
(1..maxNrofServingCells)) OF MeasResult2NR
```

| | |
|---|---|
| MeasResultListUTRA-FDD-r16 ::= | SEQUENCE (SIZE |

(1..maxCellReport)) OF MeasResultUTRA-FDD-r16

| | |
|---|---|
| MeasResultUTRA-FDD-r16 ::= | SEQUENCE { |
| physCellId-r16 | PhysCellIdUTRA-FDD-r16, |
| measResult-r16 | SEQUENCE { |

| | |
|---|---|
| utra-FDD-RSCP-r16 | INTEGER (−5..91) |

OPTIONAL,

| | |
|---|---|
| utra-FDD-EcN0-r16 | INTEGER (0..49) |

```
OPTIONAL
    }
  }
```

| | |
|---|---|
| MeasResultForRSSI-r16 ::= | SEQUENCE { |
| rssi-Result-r16 | RSSI-Range-r16, |
| channelOccupancy-r16 | INTEGER (0..100) |

}

| MeasResultCLI-r16 ::= | SEQUENCE { | |
|---|---|---|
| measResultListSRS-RSRP-r16 | | MeasResultListSRS-RSRP-r16 |

OPTIONAL,

| | |
|---|---|
| measResultListCLI-RSSI-r16 | MeasResultListCLI-RSSI-r16 |

```
OPTIONAL
  }
  MeasResultListSRS-RSRP-r16 ::= SEQUENCE (SIZE (1.. maxCLI-Report-
r16)) OF MeasResultSRS-RSRP-r16
```

| | |
|---|---|
| MeasResultSRS-RSRP-r16 ::= | SEQUENCE { |
| srs-ResourceId-r16 | SRS-ResourceId, |
| srs-RSRP-Result-r16 | SRS-RSRP-Range-r16 |

```
  }
  MeasResultListCLI-RSSI-r16 ::= SEQUENCE (SIZE (1.. maxCLI-Report-r16))
OF MeasResultCLI-RSSI-r16
```

| | |
|---|---|
| MeasResultCLI-RSSI-r16 ::= | SEQUENCE { |
| rssi-ResourceId-r16 | RSSI-ResourceId-r16, |
| cli-RSSI-Result-r16 | CLI-RSSI-Range-r16 |

```
  }
  UL-PDCP-DelayValueResultList-r16 ::= SEQUENCE (SIZE (1..maxDRB)) OF
UL-PDCP-DelayValueResult-r16
  UL-PDCP-DelayValueResult-r16 ::= SEQUENCE {
```

| | |
|---|---|
| drb-Id-r16 | DRB-Identity, |
| averageDelay-r16 | INTEGER (0..10000), |

```
    ...
  }
  UL-PDCP-ExcessDelayResultList-r17 ::= SEQUENCE (SIZE (1..maxDRB)) OF
UL-PDCP-ExcessDelayResult-r17
  UL-PDCP-ExcessDealyResult-r17 ::= SEQUENCE {
```

| | |
|---|---|
| drb-Id-r17 | DRB-Identity, |
| excessDelay-r17 | INTEGER (0..31), |

```
    ...
  }
  TimeBetweenEvent-r17 ::= INTEGER (0..1023)
  -- TAG-MEASRESULTS-STOP
  -- ASN1STOP
```

averageDelay: Indicates average delay for the packets during the reporting period. Value 0 corresponds to 0 millisecond, value 1 corresponds to 0.1 millisecond, value 2 corresponds to 0.2 millisecond, and so on.

cellResults: Cell level measurement results.

choCandidate: This field indicates whether the associated cell is a candidate target cell for conditional handover or conditional PSCell change or addition. This field may be included only in the SuccessHO-Report or SuccessPSCell-Report within UEInformationResponse message.

choConfig: If the associated cell is a candidate target cell for conditional handover, this field indicates the conditional handover execution condition for each measId within condTriggerConfig associated to the cell. This field may be included only in the rlf-report within UEInformationResponse message.

drb-Id: Indicates DRB value for which uplink PDCP delay ratio or value is provided.

firstTriggeredEvent: This field is set to condFirstEvent if the execution condition associated to the first entry of choConfig was fulfilled first in time. This field is set to condSecondEvent if the execution condition associated to the second entry of choConfig was fulfilled first in time. This field may be included in rlf-report within UEInformationResponse message or in SCGFailureInformation message.

locationInfo: Positioning related information and measurements.

physCellId: The physical cell identity of the NR cell for which the reporting is being performed.

resultsSSB-Cell: Cell level measurement results based on SS/PBCH related measurements.

resultsSSB-Indexes: Beam level measurement results based on SS/PBCH related measurements.

resultsCSI-RS-Cell: Cell level measurement results based on CSI-RS related measurements.

resultsCSI-RS-Indexes: Beam level measurement results based on CSI-RS related measurements.

rsIndexResults: Beam level measurement results.

timeBetweenEvents: Indicates the time elapsed between fulfilling the conditional execution conditions included in choConfig. Value in milliseconds. The maximum value 1023 means 1023 ms or longer. This field may be included in the reports associated to UEInformationResponse message, e.g., rlf-Report or in the SCGFailureInformation message.

coarseLocationInfo: This field indicates the coarse location information reported by the UE. This field is coded as the Ellipsoid-Point. The first/leftmost bit of the first octet contains the most significant bit. The least significant bits of degreesLatitude and degreesLongitude are set to 0 to meet the accuracy requirement corresponds to a granularity of approximately 2 km.

excessDelay: Indicates the ratio of packets in UL per DRB exceeding the configured delay threshold among the UL PDCP SDUs, according to the UL PDCP Excess Packet Delay per DRB mapping table,

measId” Identifies the measurement identity for which the reporting is being performed.

measQuantityResults: The value sinr is not included when it is used for LogMeasReport-r16.

measResultCellListSFTD-NR: SFTD measurement results between the PCell and the NR neighbour cell(s) in NR standalone.

measResultCLI: CLI measurement results.

measResultEUTRA: Measured results of an E-UTRA cell.

measResultForRSSI: Includes measured RSSI result in dBm and channelOccupancy which is the percentage of samples when the RSSI was above the configured channelOccupancyThreshold for the associated reportConfig.

measResultListEUTRA: List of measured results for the maximum number of reported best cells for an E-UTRA measurement identity.

measResultListNR: List of measured results for the maximum number of reported best cells for an NR measurement identity.

measResultListUTRA-FDD: List of measured results for the maximum number of reported best cells for a UTRA-FDD measurement identity.

measResultNR: Measured results of an NR cell.

measResultServFreqListEUTRA-SCG: Measured results of the E-UTRA SCG serving frequencies: the measurement result of PSCell and each SCell, if any, and of the best neighbouring cell on each E-UTRA SCG serving frequency.

measResultServFreqListNR-SCG: Measured results of the NR SCG serving frequencies: the measurement result of PSCell and each SCell, if any, and of the best neighbouring cell on each NR SCG serving frequency.

measResultServingMOList: Measured results of measured cells with reference signals indicated in the serving cell measurement objects including measurement results of SpCell, configured SCell(s) and best neighbouring cell within measured cells with reference signals indicated in on each serving cell measurement object. If the sending of the MeasurementReport message is triggered by a measurement configured by the field sl-ConfigDedicatedForNR received within an E-UTRA RRCConnectionReconfiguration message (i.e. CBR measurements), this field is not applicable and its contents is ignored by the network.

measResultSFTD-EUTRA: SFTD measurement results between the PCell and the E-UTRA PScell in NE-DC.

measResultSFTD-NR: SFTD measurement results between the PCell and the NR PScell in NR-DC.

The IE ReportConfigId is used to identify a measurement reporting configuration.

| -- ASN1START | |
|---|---|
| -- TAG-REPORTCONFIGID-START | |
| ReportConfigId ::= | INTEGER (1..maxReportConfigId) |

-- TAG-REPORTCONFIGID-STOP
-- ASN1STOP

The IE ReportConfigNR specifies criteria for triggering of an NR measurement reporting event or of a CHO, CPA or CPC event or of an L2 U2N relay measurement reporting event. For events labelled AN with N equal to 1, 2 and so on, measurement reporting events and CHO, CPA or CPC events are based on cell measurement results, which can either be derived based on SS/PBCH block or CSI-RS.

Event A1: Serving becomes better than absolute threshold;

Event A2: Serving becomes worse than absolute threshold;

Event A3: Neighbour becomes amount of offset better than PCell/PSCell;

Event A4: Neighbour becomes better than absolute threshold;

Event A5: PCell/PSCell becomes worse than absolute threshold1 AND Neighbour/SCell becomes better than another absolute threshold2;

Event A6: Neighbour becomes amount of offset better than SCell;

Event D1: Distance between UE and a reference location referenceLocation1 becomes larger than configured threshold distanceThreshFromReference1 and distance between UE and a reference location referenceLocation2 becomes shorter than configured threshold distanceThreshFromReference2;

Event D2: Distance between UE and a moving reference location based on movingReferenceLocation and its corresponding satellite ephemeris and epoch time broadcast in SIB19 for the serving cell becomes larger than configured threshold distanceThreshFromReference1 and distance between UE and a moving reference location determined based on referenceLocation2 becomes shorter than configured threshold distanceThreshFromReference2;

CondEvent A3: Conditional reconfiguration candidate becomes amount of offset better than PCell/PSCell;

CondEvent A4: Conditional reconfiguration candidate becomes better than absolute threshold where condEventA4 can also be used for current PSCell (i.e., in case it is configured as candidate PSCell for CondEvent A4 evaluation) for CHO with candidate SCG(s) case;

CondEvent A5: PCell/PSCell becomes worse than absolute threshold1 AND Conditional reconfiguration candidate becomes better than another absolute threshold2;

CondEvent D1: Distance between UE and a reference location referenceLocation1 becomes larger than configured threshold distanceThreshFromReference1 and distance between UE and a reference location referenceLocation2 of conditional reconfiguration candidate becomes shorter than configured threshold distanceThreshFromReference2;

CondEvent D2: Distance between UE and a moving reference location determined based on movingReferenceLocation and its corresponding satellite ephemeris and epoch time broadcast in SIB19 for the serving cell becomes larger than configured threshold distanceThreshFromReference1 and distance between UE and a moving reference location determined based on referenceLocation2 of conditional reconfiguration candidate becomes shorter than configured threshold distanceThreshFromReference2;

CondEvent T1: Time measured at UE becomes more than configured threshold t1-Threshold but is less than t1-Threshold+duration;

Event X1: Serving L2 U2N Relay UE becomes worse than absolute threshold1 AND NR Cell becomes better than another absolute threshold2;

Event X2: Serving L2 U2N Relay UE becomes worse than absolute threshold;

For event I1, measurement reporting event is based on CLI measurement results, which can either be derived based on SRS-RSRP or CLI-RSSI.

Event I1: Interference becomes higher than absolute threshold;

The reporting events concerning Aerial UE altitude are labelled HN with N equal to 1 and 2. Additionally, the reporting events concerning Aerial UE altitude and the neighboring cell measurements simultaneously are labelled AMHN with M equal to 3, 4, 5 and N equal to 1, 2.

Event H1: Aerial UE altitude becomes higher than a threshold;

Event H2: Aerial UE altitude becomes lower than a threshold;

Event A3H1: Neighbour becomes offset better than SpCell and the Aerial UE altitude becomes higher than a threshold;

Event A3H2: Neighbour becomes offset better than SpCell and the Aerial UE altitude becomes lower than a threshold; Event A4H1: Neighbour becomes better than threshold1 and the Aerial UE altitude becomes higher than a threshold2;

Event A4H2: Neighbour becomes better than threshold1 and the Aerial UE altitude becomes lower than a threshold2;

Event A5H1: SpCell becomes worse than threshold1 and neighbour becomes better than threshold2 and the Aerial UE altitude becomes higher than a threshold3;

Event A5H2: SpCell becomes worse than threshold1 and neighbour becomes better than threshold2 and the Aerial UE altitude becomes lower than a threshold3.

ReportConfigNR information element

```
  -- ASN1START
  -- TAG-REPORTCONFIGNR-START
```

| | |
|---|---|
| ReportConfigNR ::= | SEQUENCE { |
| reportType | CHOICE { |
| periodical | PeriodicalReportConfig, |
| eventTriggered | EventTriggerConfig, |

...,

| | |
|---|---|
| reportCGI | ReportCGI, |
| reportSFTD | ReportSFTD-NR, |
| condTriggerConfig-r16 | CondTriggerConfig-r16, |
| cli-Periodical-r16 | CLI-PeriodicalReportConfig- |

r16,

| | |
|---|---|
| cli-EventTriggered-r16 | CLI-EventTriggerConfig- |

r16,

| | |
|---|---|
| rxTxPeriodical-r17 | RxTxPeriodical-r17, |
| reportOnScellActivation-r18 | ReportOnScellActivation- |

```
r18
    }
  }
```

| | |
|---|---|
| ReportCGI ::= | SEQUENCE { |
| cellForWhichToReportCGI | PhysCellId, |

```
      ...,
    [[
```

| | |
|---|---|
| useAutonomousGaps-r16 | ENUMERATED {setup} |

```
OPTIONAL -- Need R
    ]]
  }
```

| | |
|---|---|
| ReportSFTD-NR ::= | SEQUENCE { |
| reportSFTD-Meas | BOOLEAN, |
| reportRSRP | BOOLEAN, |

```
    ...,
    [[
```

| | |
|---|---|
| reportSFTD-NeighMeas | ENUMERATED {true} |

OPTIONAL, -- Need R

| | |
|---|---|
| drx-SFTD-NeighMeas | ENUMERATED {true} |

OPTIONAL, -- Need R

| | |
|---|---|
| cellsForWhichToReportSFTD | SEQUENCE (SIZE (1..maxCellSFTD)) |

```
OF PhysCellId OPTIONAL -- Need R
    ]]
  }
```

| | |
|---|---|
| CondTriggerConfig-r16 ::= | SEQUENCE { |
| condEventId | CHOICE { |
| condEventA3 | SEQUENCE { |
| a3-Offset | MeasTriggerQuantityOffset, |
| hysteresis | Hysteresis, |
| timeToTrigger | TimeToTrigger |

},

| | |
|---|---|
| condEventA5 | SEQUENCE { |
| a5-Threshold1 | MeasTriggerQuantity, |
| a5-Threshold2 | MeasTriggerQuantity, |
| hysteresis | Hysteresis, |
| timeToTrigger | TimeToTrigger |

```
      },
      ...,
```

| | |
|---|---|
| condEventA4-r17 | SEQUENCE { |
| a4-Threshold-r17 | MeasTriggerQuantity, |
| hysteresis-r17 | Hysteresis, |
| timeToTrigger-r17 | TimeToTrigger |

},

| | |
|---|---|
| condEventD1-r17 | SEQUENCE { |
| distanceThreshFromReference1-r17 | INTEGER(0.. 65525), |
| distanceThreshFromReference2-r17 | INTEGER(0.. 65525), |
| referenceLocation1-r17 | ReferenceLocation-r17, |
| referenceLocation2-r17 | ReferenceLocation-r17, |
| hysteresisLocation-r17 | HysteresisLocation-r17, |
| timeToTrigger-r17 | TimeToTrigger |

},

| | |
|---|---|
| condEventT1-r17 | SEQUENCE { |
| t1-Threshold-r17 | INTEGER (0..549755813887), |
| duration-r17 | INTEGER (1..6000) |

},

| | |
|---|---|
| condEventD2-r18 | SEQUENCE { |
| distanceThreshFromReference1-r18 | INTEGER(0.. 65535), |
| distanceThreshFromReference2-r18 | INTEGER(0.. 65535), |
| referenceLocation2-r18 | ReferenceLocation-r17, |
| hysteresisLocation-r18 | HysteresisLocation-r17, |
| timeToTrigger-r18 | TimeToTrigger |

```
      }
    },
```

| | |
|---|---|
| rsType-r16 | NR-RS-Type, |

```
    ...,
    [[
```

| | |
|---|---|
| nesEvent-r18 | ENUMERATED {true} |

```
OPTIONAL -- Need R
    ]]
  }
```

| | |
|---|---|
| EventTriggerConfig ::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |

a3-Offset
MeasTriggerQuantityOffset,

| | |
|---|---|
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |

a6-Offset
MeasTriggerQuantityOffset,

| | |
|---|---|
| reportOnLeave | BOOLEAN, |
| hysteresis | Hysteresis, |
| timeToTrigger | TimeToTrigger, |
| useAllowedCellList | BOOLEAN |

```
      },
      ...,
      [[
```

| | |
|---|---|
| eventX1-r17 | SEQUENCE { |
| x1-Threshold1-Relay-r17 | SL- |

MeasTriggerQuantity-r16,

| | |
|---|---|
| x1-Threshold2-r17 | MeasTriggerQuantity, |
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

| | |
|---|---|
| eventX2-r17 | SEQUENCE { |
| x2-Threshold-Relay-r17 | SL- |

MeasTriggerQuantity-r16

| | |
|---|---|
| reportOnLeave-r17 | BOOLEAN, |
| hysteresis-r17 | Hysteresis, |
| timeToTrigger-r17 | TimeToTrigger |

},

| | |
|---|---|
| eventD1-r17 | SEQUENCE { |
| distanceThreshFromReference1-r17 | INTEGER(1.. 65525), |
| distanceThreshFromReference2-r17 | INTEGER(1.. 65525), |
| referenceLocation1-r17 | ReferenceLocation-r17, |
| referenceLocation2-r17 | ReferenceLocation-r17, |
| reportOnLeave-r17 | BOOLEAN, |
| hysteresisLocation-r17 | HysteresisLocation-r17, |
| timeToTrigger-r17 | TimeToTrigger |

```
      }
      ]],
      [[
```

| | |
|---|---|
| eventH1-r18 | SEQUENCE { |
| h1-Threshold-r18 | Altitude-r18, |
| h1-Hysteresis-r18 | HysteresisAltitude-r18, |
| reportOnLeave-r18 | BOOLEAN, |
| timeToTrigger-r18 | TimeToTrigger, |
| includeAltitudeUE-r18 | BOOLEAN, |
| simulMultiTriggerSingleMeasReport-r18 | BOOLEAN |

},

| | |
|---|---|
| eventH2-r18 | SEQUENCE { |
| h2-Threshold-r18 | Altitude-r18, |
| h2-Hysteresis-r18 | HysteresisAltitude-r18, |
| reportOnLeave-r18 | BOOLEAN, |
| timeToTrigger-r18 | TimeToTrigger, |
| includeAltitudeUE-r18 | BOOLEAN, |
| simulMultiTriggerSingleMeasReport-r18 | BOOLEAN |

},

| | |
|---|---|
| eventA3H1-r18 | SEQUENCE { |

a3-Offset-r18
MeasTriggerQuantityOffset,

| | |
|---|---|
| reportOnLeave-r18 | BOOLEAN, |
| a3-Hysteresis-r18 | Hysteresis, |
| timeToTrigger-r18 | TimeToTrigger, |
| useAllowedCellList-r18 | BOOLEAN, |
| h1-Threshold-r18 | Altitude-r18, |
| h1-Hysteresis-r18 | HysteresisAltitude-r18, |
| includeAltitudeUE-r18 | BOOLEAN, |
| simulMultiTriggerSingleMeasReport-r18 | BOOLEAN |

},

| | |
|---|---|
| eventA3H2-r18 | SEQUENCE { |

a3-Offset-r18
MeasTriggerQuantityOffset,

| | |
|---|---|
| reportOnLeave-r18 | BOOLEAN, |
| a3-Hysteresis-r18 | Hysteresis, |
| timeToTrigger-r18 | TimeToTrigger, |
| useAllowedCellList-r18 | BOOLEAN, |
| h2-Threshold-r18 | Altitude-r18, |
| h2-Hysteresis-r18 | HysteresisAltitude-r18, |
| includeAltitudeUE-r18 | BOOLEAN, |
| simulMultiTriggerSingleMeasReport-r18 | BOOLEAN |

},

| | |
|---|---|
| eventA4H1-r18 | SEQUENCE { |
| a4-Threshold-r18 | MeasTriggerQuantity, |
| reportOnLeave-r18 | BOOLEAN, |
| a4-Hysteresis-r18 | Hysteresis, |
| timeToTrigger-r18 | TimeToTrigger, |
| useAllowedCellList-r18 | BOOLEAN, |
| h1-Threshold-r18 | Altitude-r18, |
| h1-Hysteresis-r18 | HysteresisAltitude-r18, |
| includeAltitudeUE-r18 | BOOLEAN, |
| simulMultiTriggerSingleMeasReport-r18 | BOOLEAN |

},

| | |
|---|---|
| eventA4H2-r18 | SEQUENCE { |
| a4-Threshold-r18 | MeasTriggerQuantity, |
| reportOnLeave-r18 | BOOLEAN, |
| a4-Hysteresis-r18 | Hysteresis, |
| timeToTrigger-r18 | TimeToTrigger, |
| useAllowedCellList-r18 | BOOLEAN, |
| h2-Threshold-r18 | Altitude-r18 |
| h2-Hysteresis-r18 | HysteresisAltitude-r18, |
| includeAltitudeUE-r18 | BOOLEAN, |
| simulMultiTriggerSingleMeasReport-r18 | BOOLEAN |

},

| | |
|---|---|
| eventA5H1-r18 | SEQUENCE { |
| a5-Threshold1-r18 | MeasTriggerQuantity, |
| a5-Threshold2-r18 | MeasTriggerQuantity, |
| reportOnLeave-r18 | BOOLEAN, |
| a5-Hysteresis-r18 | Hysteresis, |
| timeToTrigger-r18 | TimeToTrigger, |
| useAllowedCellList-r18 | BOOLEAN, |
| h1-Threshold-r18 | Altitude-r18, |
| h1-Hysteresis-r18 | HysteresisAltitude-r18, |
| includeAltitudeUE-r18 | BOOLEAN, |
| simulMultiTriggerSingleMeasReport-r18 | BOOLEAN |

},

| | |
|---|---|
| eventA5H2-r18 | SEQUENCE { |
| a5-Threshold1-r18 | MeasTriggerQuantity, |
| a5-Threshold2-r18 | MeasTriggerQuantity, |
| reportOnLeave-r18 | BOOLEAN, |
| a5-Hysteresis-r18 | Hysteresis, |
| timeToTrigger-r18 | TimeToTrigger, |
| useAllowedCellList-r18 | BOOLEAN, |
| h2-Threshold-r18 | Altitude-r18, |
| h2-Hysteresis-r18 | HysteresisAltitude-r18, |
| includeAltitudeUE-r18 | BOOLEAN, |
| simulMultiTriggerSingleMeasReport-r18 | BOOLEAN |

},

| | |
|---|---|
| eventD2-r18 | SEQUENCE { |
| distanceThreshFromReference1-r18 | INTEGER(1.. 65535), |
| distanceThreshFromReference2-r18 | INTEGER(1.. 65535), |
| referenceLocation2-r18 | ReferenceLocation-r17, |
| reportOnLeave-r18 | BOOLEAN, |
| hysteresisLocation-r18 | HysteresisLocation-r17, |
| timeToTrigger-r18 | TimeToTrigger |

```
      }
      ]]
    },
```

| | |
|---|---|
| rsType | NR-RS-Type, |
| reportInterval | ReportInterval, |
| reportAmount | ENUMERATED {r1, r2, r4, r8, |

r16, r32, r64, infinity},

| | |
|---|---|
| reportQuantityCell | MeasReportQuantity, |
| maxReportCells | INTEGER (1..maxCellReport), |
| reportQuantityRS-Indexes | MeasReportQuantity |

OPTIONAL, -- Need R

| | |
|---|---|
| maxNrofRS-IndexesToReport | INTEGER |
| (1..maxNrofIndexesToReport) | OPTIONAL, -- Need R |
| includeBeamMeasurements | BOOLEAN, |
| reportAddNeighMeas | ENUMERATED {setup} |

```
OPTIONAL, -- Need R
    ...,
    [[
```

| | |
|---|---|
| measRSSI-ReportConfig-r16 | MeasRSSI-ReportConfig-r16 |

OPTIONAL, -- Need R

| | |
|---|---|
| useT312-r16 | BOOLEAN |

OPTIONAL, -- Need M

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList- |
| r16} | OPTIONAL, -- Need M |
| includeWLAN-Meas-r16 | SetupRelease {WLAN- |
| NameList-r16} | OPTIONAL, -- Need M |
| includeSensor-Meas-r16 | SetupRelease {Sensor- |
| NameList-r16} | OPTIONAL -- Need M |

```
    ]],
    [[
```

| | |
|---|---|
| coarseLocationRequest-r17 | ENUMERATED {true} |

OPTIONAL, -- Need R

| | |
|---|---|
| reportQuantityRelay-r17 | SL-MeasReportQuantity-r16 |

```
OPTIONAL -- Need R
    ]],
    [[
```

| | |
|---|---|
| numberOfTriggeringCells-r18 | INTEGER (2..maxCellReport) |

OPTIONAL, -- Need R

| | |
|---|---|
| cellIndividualOffsetList-r18 | SEQUENCE (SIZE |
| (1..maxNrofCellMeas)) OF CellIndividualOffsetList-r18 | OPTIONAL, -- Need R |
| eventX1-SD-Threshold1-r18 | SL-MeasTriggerQuantity-r16 |

OPTIONAL, -- Need S

| | |
|---|---|
| eventX2-SD-Threshold-r18 | SL-MeasTriggerQuantity-r16 |

```
OPTIONAL -- Need S
  -- Editor's Note: FFS if this is proper place for Event X1 thresholds.
    ]]
  }
```

| | |
|---|---|
| PeriodicalReportConfig ::= | SEQUENCE { |
| rsType | NR-RS-Type, |
| reportInterval | ReportInterval, |
| reportAmount | ENUMERATED {r1, r2, r4, r8, |

r16, r32, r64, infinity},

| | |
|---|---|
| reportQuantityCell | MeasReportQuantity, |
| maxReportCells | INTEGER (1..maxCellReport), |
| reportQuantityRS-Indexes | MeasReportQuantity |

OPTIONAL, -- Need R

| | |
|---|---|
| maxNrofRS-IndexesToReport | INTEGER |
| (1..maxNrofIndexesToReport) | OPTIONAL, -- Need R |
| includeBeamMeasurements | BOOLEAN, |
| useAllowedCellList | BOOLEAN, |

```
    ...,
    [[
```

| | |
|---|---|
| measRSSI-ReportConfig-r16 | MeasRSSI-ReportConfig-r16 |

OPTIONAL, -- Need R

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList- |
| r16} | OPTIONAL, -- Need M |
| includeWLAN-Meas-r16 | SetupRelease {WLAN- |
| NameList-r16} | OPTIONAL, -- Need M |
| includeSensor-Meas-r16 | SetupRelease {Sensor- |
| NameList-r16} | OPTIONAL, -- Need M |
| ul-DelayValueConfig-r16 | SetupRelease { UL- |
| DelayValueConfig-r16 } | OPTIONAL, -- Need M |
| reportAddNeighMeas-r16 | ENUMERATED {setup} |

```
OPTIONAL -- Need R
    ]],
    [[
```

| | |
|---|---|
| ul-ExcessDelayConfig-r17 | SetupRelease { UL- |
| ExcessDelayConfig-r17 } | OPTIONAL, -- Need M |
| coarseLocationRequest-r17 | ENUMERATED {true} |

OPTIONAL, -- Need R

| | |
|---|---|
| reportQuantityRelay-r17 | SL-MeasReportQuantity-r16 |

```
OPTIONAL -- Need R
    ]]
  }
```

| | |
|---|---|
| NR-RS-Type ::= | ENUMERATED {ssb, csi-rs} |
| MeasTriggerQuantity ::= | CHOICE { |
| rsrp | RSRP-Range, |
| rsrq | RSRQ-Range, |
| sinr | SINR-Range |

}

| | |
|---|---|
| MeasTriggerQuantityOffset ::= | CHOICE { |
| rsrp | INTEGER (−30..30), |
| rsrq | INTEGER (−30..30), |
| sinr | INTEGER (−30..30) |

}

| | |
|---|---|
| MeasReportQuantity ::= | SEQUENCE { |
| rsrp | BOOLEAN, |
| rsrq | BOOLEAN, |
| sinr | BOOLEAN |

}

| | |
|---|---|
| MeasRSSI-ReportConfig-r16 ::= | SEQUENCE { |
| channelOccupancyThreshold-r16 | RSSI-Range-r16 |

OPTIONAL -- Need R
}

| | |
|---|---|
| CLI-EventTriggerConfig-r16 ::= | SEQUENCE { |
| eventId-r16 | CHOICE { |
| eventI1-r16 | SEQUENCE { |

i1-Threshold-r16
MeasTriggerQuantityCLI-r16,

| | |
|---|---|
| reportOnLeave-r16 | BOOLEAN, |
| hysteresis-r16 | Hysteresis, |
| timeToTrigger-r16 | TimeToTrigger |

```
      },
    ...
    },
```

| | |
|---|---|
| reportInterval-r16 | ReportInterval, |
| reportAmount-r16 | ENUMERATED {r1, r2, r4, r8, |

r16, r32, r64, infinity},

| | |
|---|---|
| maxReportCLI-r16 | INTEGER (1..maxCLI-Report- |

```
r16),
    ...
  }
```

| | |
|---|---|
| CLI-PeriodicalReportConfig-r16 ::= | SEQUENCE { |
| reportInterval-r16 | ReportInterval, |
| reportAmount-r16 | ENUMERATED {r1, r2, r4, r8, |

r16, r32, r64, infinity},

| | |
|---|---|
| reportQuantityCLI-r16 | MeasReportQuantityCLI-r16, |
| maxReportCLI-r16 | INTEGER (1..maxCLI-Report- |

```
r16),
    ...
  }
```

| | |
|---|---|
| RxTxPeriodical-r17 ::= | SEQUENCE { |
| rxTxReportInterval-r17 | RxTxReportInterval-r17 |

OPTIONAL, -- Need R

| | |
|---|---|
| reportAmount-r17 | ENUMERATED {r1, infinity, |

```
spare6, spare5, spare4, spare3, spare2, spare1},
    ...
  }
  RxTxReportInterval-r17 ::= ENUMERATED
{ms80,ms120,ms160,ms240,ms320,ms480,ms640,ms1024,ms1280,ms2048,ms2560,ms51
20,spare4,spare3,spare2,spare1}
```

| | |
|---|---|
| MeasTriggerQuantityCLI-r16 ::= | CHOICE { |
| srs-RSRP-r16 | SRS-RSRP-Range-r16, |
| cli-RSSI-r16 | CLI-RSSI-Range-r16 |

}

| | |
|---|---|
| MeasReportQuantityCLI-r16 ::= | ENUMERATED {srs-rsrp, cli-rssi} |
| ReportOnScellActivation-r18 ::= | SEQUENCE { |
| rsType | NR-RS-Type, |
| reportQuantityRS-Indexes | MeasReportQuantity, |
| maxNrofRS-IndexesToReport | INTEGER |

(1..maxNrofIndexesToReport),

| | |
|---|---|
| includeBeamMeasurements | BOOLEAN |

}

| | |
|---|---|
| CellIndividualOffsetList-r18 ::= | SEQUENCE { |
| physCellId-r18 | PhysCellId, |
| cellIndividualOffset-r18 | Q-OffsetRangeList |

```
  }
  -- TAG-REPORTCONFIGNR-STOP
  -- ASN1STOP
```

reportType: Type of the configured measurement report. In MR-DC, network does not configure report of type reportCGI using SRB3. The condTriggerConfig is used for CHO, CPA or CPC configuration.

useAutonomousGaps: Indicates whether or not the UE is allowed to use autonomous gaps in acquiring system information from the NR neighbour cell. When the field is included, the UE applies the corresponding value for T321.

a3-Offset/a6-Offset: Offset value(s) to be used in NR measurement report triggering condition for event a3/a6. The actual value is field value*0.5 dB.

aN-ThresholdM: Threshold value associated to the selected trigger quantity (e.g. RSRP, RSRQ, SINR) per RS Type (e.g. SS/PBCH block, CSI-RS) to be used in NR measurement report triggering condition for event number aN. If multiple thresholds are defined for event number aN, the thresholds are differentiated by M. In the same eventA5, eventA5H1, eventA5H2, the network configures the same quantity for the MeasTriggerQuantity of the a5-Threshold1 and for the MeasTriggerQuantity of the a5-Threshold2.

coarseLocationRequest: This field is used to request UE to report coarse location information.

distanceThreshFromReference1, distanceThreshFromReference2: Threshold value associated to the distance from a reference location configured with referenceLocation1 or referenceLocation2. Each step represents 50 m.

eventId: Choice of NR event triggered reporting criteria.

eventXN-SD-Threshold: Indicates the SD-RSRP threshold value for the serving L2 U2N Relay UE in event XN (N equals 1 or 2). If this field is not included, the UE considers the SD-RSRP threshold value equals to the one indicated by x1-Threshold1-Relay/x2-Threshold-Relay.

includeAltitudeUE: This field is used to request UE to report altitude information.

maxNrofRS-IndexesToReport: Max number of RS indexes to include in the measurement report for A1-A6 events.

maxReportCells: Max number of non-serving cells to include in the measurement report.

numberOfTriggeringCells: Indicates the number of cells detected that are required to fulfill an event for a measurement report to be triggered. This field is applicable only for the events concerning neighbor cells, i.e. eventA3, eventA4, eventA5, eventA3H1, eventA3H2, eventA4H1, eventA4H2, eventA5H1, eventA5H2.

referenceLocation1, referenceLocation2: For eventD1, the referenceLocation1 is associated to serving cell and referenceLocation2 is associated to neighbour cell. For eventD2, the refereceLocation2 is associated to neighbour cell.

reportAddNeighMeas: Indicates that the UE shall include the best neighbour cells per serving frequency.

reportAmount: Number of measurement reports applicable for eventTriggered as well as for periodical report types.

reportOnLeave: Indicates whether or not the UE shall initiate the measurement reporting procedure when the leaving condition is met for a cell in cellsTriggeredList.

reportQuantityCell: The cell measurement quantities to be included in the measurement report.

reportQuantityRS-Indexes: Indicates which measurement information per RS index the UE shall include in the measurement report.

simulMultiTriggerSingleMeasReport: Indicates when multiple events with the same eventID satisfy the entering condition(s), whether to consider only the event with the smallest value between the altitude of the UE and the configured altitude threshold.

timeToTrigger: Time during which specific criteria for the event needs to be met in order to trigger a measurement report.

useAllowedCellList: Indicates whether only the cells included in the allow-list of the associated measObject are applicable.

use T312: If value TRUE is configured, the UE shall use the timer T312 with the value t312 as specified in the corresponding measObjectNR. If value FALSE is configured, the timer T312 is considered as disabled. Network configures value TRUE only if reportType is set to eventTriggered.

xN-ThresholdM: Threshold value associated to the selected trigger quantity (e.g. RSRP, RSRQ, SINR) per RS Type (e.g. SS/PBCH block, CSI-RS) to be used in NR measurement report triggering condition for event xN. If multiple thresholds are defined for event number xN, the thresholds are differentiated by M. x1-Threshold1 and x2-Threshold indicates the threshold value for the serving L2 U2N Relay UE, x1-Threshold2 indicates the threshold value for the NR Cells.

The IE ReportConfigToAddModList concerns a list of reporting configurations to add or modify.

| -- ASN1START | |
|---|---|
| -- TAG-REPORTCONFIGTOADDMODLIST-START | |
| ReportConfigToAddModList ::= | SEQUENCE (SIZE |
| (1..maxReportConfigId)) OF ReportConfigToAddMod | |
| ReportConfigToAddMod ::= | SEQUENCE { |
| reportConfigId | ReportConfigId, |
| reportConfig | CHOICE { |
| reportConfigNR | ReportConfigNR, |
| ..., | |
| reportConfigInterRAT | ReportConfigInterRAT, |
| reportConfigNR-SL-r16 | ReportConfigNR-SL-r16 |

```
    }
  }
  -- TAG-REPORTCONFIGTOADDMODLIST-STOP
  -- ASN1STOP
```

The IE RSRP-Range specifies the value range used in RSRP measurements and thresholds. For measurements, integer value for RSRP measurements is according to Table 10.1.6.1-1 in TS 38.133 [14]. For thresholds, the actual value is (IE value—156) dBm, except for the IE value 127, in which case the actual value is infinity.

| -- ASN1START | |
|---|---|
| -- TAG-RSRQ-RANGE-START | |
| RSRQ-Range ::= | INTEGER(0..127) |

-- TAG-RSRQ-RANGE-STOP
-- ASN1STOP

The IE RSRQ-Range specifies the value range used in RSRQ measurements and thresholds. For measurements, integer value for RSRQ measurements is according to Table 10.1.11.1-1 in TS 38.133 [14]. For thresholds, the actual value is (IE value—87)/2 dB.

| -- ASN1START | |
|---|---|
| -- TAG-RSRQ-RANGE-START | |
| RSRQ-Range ::= | INTEGER(0..127) |

-- TAG-RSRQ-RANGE-STOP
-- ASN1STOP

The IE RSSI-Range specifies the value range used in RSSI measurements and thresholds for NR operation with shared spectrum channel access. The integer value for RSSI measurements is according to Table 10.1.34.3-1 in TS 38.133 [14].

| -- ASN1START | |
|---|---|
| -- TAG-RSSI-RANGE-START | |
| RSSI-Range-r16 ::= | INTEGER(0..76) |

-- TAG-RSSI-RANGE-STOP
-- ASN1STOP

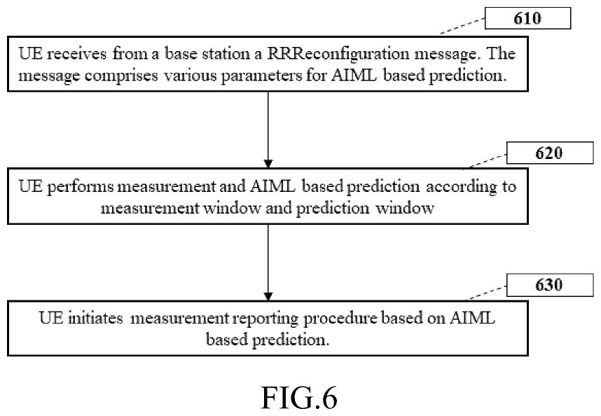

FIG. 6 illustrates UE operations.

At 610, UE receives from a base station a RRReconfiguration message. The message comprises various parameters for AIML based prediction.

At 620, UE performs measurement and AIML based prediction according to measurement window and prediction window.

During an activated measurement gap:
>: UE performs inter-frequency measurement; and
>: UE performs AIML based prediction based on inter-frequency measurement results that are derived from measurements during the previous measurement gaps.

Outside the activated measurement gap:
>: UE does not perform inter-frequency measurement; and
>: UE performs AIML based prediction based on inter-frequency measurement results that are derived from measurements during the measurement gap.

In case that L3 filtered measurement results of PCell is higher than s-Measure:
>: UE performs neither intra-frequency measurement nor inter-frequency measurement;
>: UE performs serving cell measurement; and
>: UE performs neither AIML based prediction based on intra-frequency measurement result, AIML based prediction based on inter-frequency measurement result nor AIML based prediction based on serving cell measurement result.

At 630, UE initiates measurement reporting procedure based on AIML based prediction.

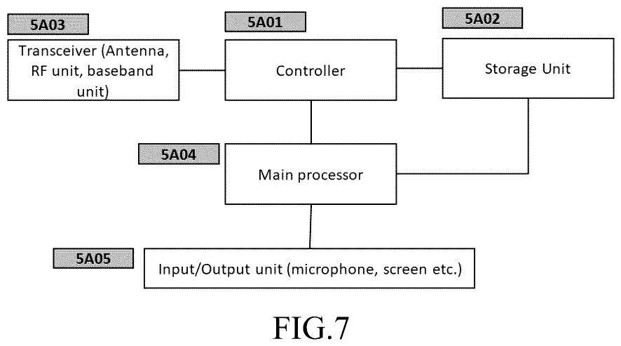

FIG. 7 is a block diagram illustrating the internal structure of a UE to which the disclosure is applied.

Referring to the diagram, the UE includes a controller 5A01, a storage unit 5A02, a transceiver 5A03, a main processor 5A04 and I/O unit 5A05.

The controller 5A01 controls the overall operations of the UE in terms of mobile communication. For example, the controller 5A01 receives/transmits signals through the transceiver 5A03. In addition, the controller 5A01 records and reads data in the storage unit 5A02. To this end, the controller 5A01 includes at least one processor. For example, the controller 5A01 may include a communication processor (CP) that performs control for communication and an application processor (AP) that controls the upper layer, such as an application program. The controller controls storage unit and transceiver such that UE operations in the present disclosure are performed.

The storage unit 5A02 stores data for operation of the UE, such as a basic program, an application program, and configuration information. The storage unit 5A02 provides stored data at a request of the controller 5A01.

The transceiver 5A03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 5A04 controls the overall operations other than mobile operation. The main processor 5A04 process user input received from I/O unit 5A05, stores data in the storage unit 5A02, controls the controller 5A01 for required mobile communication operations and forward user data to I/O unit 5A05.

I/O unit 5A05 consists of equipment for inputting user data and for outputting user data such as a microphone and a screen. I/O unit 5A05 performs inputting and outputting user data based on the main processor's instruction.

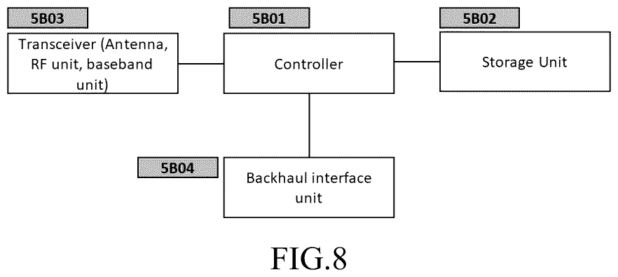

FIG. 8 is a block diagram illustrating the configuration of a base station according to the disclosure.

As illustrated in the diagram, the base station includes a controller 5B01, a storage unit 5B02, a transceiver 5B03 and a backhaul interface unit 5B04.

The controller 5B01 controls the overall operations of the main base station. For example, the controller 5B01 receives/transmits signals through the transceiver 5B03, or through the backhaul interface unit 5B04. In addition, the controller 5B01 records and reads data in the storage unit 5B02. To this end, the controller 5B01 may include at least one processor. The controller controls transceiver, storage unit and backhaul interface such that base station operation in the present disclosure.

The storage unit 5B02 stores data for operation of the main base station, such as a basic program, an application program, and configuration information. Particularly, the storage unit 5B02 may store information regarding a bearer allocated to an accessed UE, a measurement result reported from the accessed UE, and the like. In addition, the storage unit 5B02 may store information serving as a criterion to determine whether to provide the UE with multi-connection or to discontinue the same. In addition, the storage unit 5B02 provides stored data at a request of the controller 5B01.

The transceiver 5B03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 5B04 provides an interface for communicating with other nodes inside the network. The backhaul interface unit 5B04 converts a bit string transmitted from the base station to another node, for example, another base station or a core network, into a physical signal, and converts a physical signal received from the other node into a bit string.

What is claimed is:

1. A method performed by a terminal, the method comprising:
receiving from a base station a Radio Resource Control (RRC) message that comprises a parameter related to first Reference Signal Received Power (RSRP) threshold and a parameter related to a second RSRP threshold;
deriving a measured cell quantity of a special cell based on an average of beam measurement quantity values that are above the second RSRP threshold; and
in case that the measured cell quantity of the special cell is lower than the first RSRP threshold:
predicting a predicted cell quantity of the special cell; and
triggering measurement report procedure based on the predicted cell quantity of the special cell.

2. The method of claim 1, further comprising:
deriving a second measured cell quantity of the special cell based on highest beam measurement quantity value in case that the highest beam measurement quantity value is below the second RSRP threshold; and
in case that the second measured cell quantity of the special cell is higher than the first RSRP threshold, stopping prediction of the predicted cell quantity of the special cell.

3. The method of claim 2, wherein:
a beam measurement quantity value of a Synchronization Signal/Physical Broadcast Channel (SS/PBCH) block is derived based on weighted moving average value of measurement results on the SS/PBCH block over a specific past time; and
a length of the specific past time is determined based on a parameter comprised in the RRC message.

4. The method of claim 3, wherein
the predicted cell quantity of the special cell is predicted for a specific future time; and
the length of the specific future time is determined based on a second parameter comprised in the RRC message.

5. The method of claim 2, further comprising:
in case that the measured cell quantity of the special cell is lower than the first RSRP threshold, predicting a predicted cell quantity of a neighboring cell.

6. The method of claim 5, further comprising:
in case that the second measured cell quantity of the special cell is higher than the first RSRP threshold, stopping prediction of the predicted cell quantity of the neighboring cell.

7. A terminal in a wireless communication system, the terminal comprising:
a transceiver configured to transmit and receive a signal; and
a controller configured to control the transceiver to:
receive from a base station a Radio Resource Control (RRC) message that comprises a parameter related to first Reference Signal Received Power (RSRP) threshold and a parameter related to a second RSRP threshold,
derive a measured cell quantity of a special cell based on an average of beam measurement quantity values that are above the second RSRP threshold, and
in case that the measured cell quantity of the special cell is lower than the first RSRP threshold:
predict a predicted cell quantity of the special cell; and
trigger measurement report procedure based on the predicted cell quantity of the special cell.
